(19) United States
(12) Patent Application Publication
(10) Pub. No.: US 2026/0070730 A1
(43) Pub. Date: Mar. 12, 2026

(54) INSULATED PRODUCTS AND DEVICES AND METHODS FOR MAKING THE SAME

(71) Applicant: TEMPERPACK TECHNOLOGIES, INC., Richmond, VA (US)

(72) Inventors: Charles-Alexandre Archambault VINCENT, Richmond, VA (US); Scott Donald KARPEN, Mechanicsville, VA (US); Stefan Michael MARCHETTI, Ashland, VA (US); John SCHUHLE, Powhatan, VA (US); Alexander Norman DIMEN, North Chesterfield, VA (US); Wesley Stephen ROGERS, Richmond, VA (US); Joseph Vernon RAKE, Richmond, VA (US)

(21) Appl. No.: 19/320,642

(22) Filed: Sep. 5, 2025

Related U.S. Application Data
(60) Provisional application No. 63/691,894, filed on Sep. 6, 2024.

(51) Int. Cl. B65D 81/38; B32B 1/00; B32B 3/02; B32B 3/28; B32B 29/00; B32B 29/08

(52) U.S. Cl. CPC B65D 81/3897; B32B 1/00; B32B 3/02; B32B 3/28; B32B 29/005; B32B 29/08; B32B 2250/26; B32B 2250/40; B32B 2255/12; B32B 2255/26; B32B 2307/304; B32B 2439/06

(57) ABSTRACT

An insulating substrate may include one or more sections, one or more portions in each of the one or more sections, and one or more crease lines separating one or more of the section(s) and/or portion(s). The insulating substrate may be formed into an insulated bag through folding and/or creasing the crease line(s). The insulating substrate may include one or more paper barriers with a core layer disposed between the one or more paper barriers.

### CROSS-REFERENCE TO RELATED APPLICATION

This application claims priority under 35 U.S.C. § 119 to U.S. Provisional Patent Application No. 63/691,894, filed Sep. 6, 2024, entitled “INSULATED PRODUCTS AND DEVICES AND METHODS FOR MAKING THE SAME,” the entire contents of which are fully incorporated herein by reference as if fully set forth below.

### FIELD

The presently disclosed subject matter generally relates to insulation products for packaging and shipping, machines for making insulation products, and methods for making insulation products.

### BACKGROUND

Insulation materials have long been used in a variety of applications and are being increasingly used in insulated shipping containers to provide desired or required thermal environments when shipping goods. For example, an insulated shipping container transporting perishable goods (e.g., refrigerated meals) may increase the longevity of the goods and, in turn, expand the shipping area of the customer base. While some insulated shipping containers are designed for long-term use, others are designed for a more limited lifespan in favor of lower materials and manufacturing costs. The ever-increasing volume of non-reusable shipping containers results in higher levels of waste, most of which is non-recyclable or non-compostable at least in part because the insulation materials are often non-recyclable or non-compostable. Environmentally conscious retailers and consumers are faced with limited environmentally friendly and responsible options, for disposing insulation materials following use.

Accordingly, there is a need for an insulation production for shipping and/or packaging that is recyclable or compostable, provides insulation and cushioning properties, and is lightweight and effective. There is also a need for machines for making such insulation products, and methods for making the recyclable or compostable insulation and cushioning material, including machines and methods that allow customers to make such insulation products on demand. Embodiments of the present disclosure are directed to these and other considerations.

### SUMMARY

Briefly described, embodiments of the presently disclosed subject matter relate to insulation products (including insulated bags and insulated pouches), one or more machines for making insulation products, and one or more methods for making an insulation product configured to insulate and/or cushion items for transport, whether such transport needs involve shipping long distances, local delivery, or self-transport in a vehicle.

In some aspects, an insulated bag may include an insulating substrate having a plurality of sections and a plurality of crease lines (e.g., horizontal, vertical, or at an oblique angle) that may separate the sections or portions thereof.

In other aspects, an apparatus may be provided to form an insulated product. The apparatus may include assembly stations for pressing, folding, and sealing one or more substrates to form the insulated product.

In other aspects, a method of forming an insulated product may be provided. The method may include receiving substrate(s), and transporting the substrate(s) to one or more stations for indexing, creasing, folding, and/or sealing the substrate(s) to form the insulated product.

The foregoing exemplifies certain aspects of the presently disclosed subject matter and is not intended to be reflective of the full scope of the presently disclosed subject matter. Additional features and advantages of the presently disclosed subject matter are set forth in the following exemplary description, may be apparent from the description, or may be learned by practicing the presently disclosed subject matter.

### BRIEF DESCRIPTION OF THE DRAWINGS

FIG. 1 is a perspective view of an insulation product, according to exemplary embodiments.

FIG. 2 is a sides view of an insulation product, according to exemplary embodiments.

FIG. 3A is an inside view of an unassembled insulated bag, according to an exemplary embodiment.

FIG. 3B is a perspective view of the insulated bag of FIG. 3A in assembled and expanded form, according to an exemplary embodiment.

FIG. 3C is an inside perspective view of the insulated bag of FIG. 3A in assembled and expanded form, according to an exemplary embodiment.

FIG. 3D is a bottom perspective view of the insulated bag of FIG. 3A in assembled and expanded form, according to an exemplary embodiment.

FIG. 3E is a top perspective view of the insulated bag of FIG. 3A in assembled and expanded form, according to an exemplary embodiment.

FIG. 3F is a top perspective view of the insulated bag of FIG. 3A in assembled and expanded form, according to an exemplary embodiment.

FIG. 4A is an inside view of an unassembled insulated bag, according to an exemplary embodiment.

FIG. 4B is a perspective view of the insulated bag of FIG. 4A in assembled and expanded form, according to an exemplary embodiment.

FIG. 5A is an inside view of an unassembled insulated bag, according to an exemplary embodiment.

FIG. 5B is a perspective view of the insulated bag of FIG. 5A in assembled and expanded form, according to an exemplary embodiment.

FIG. 6A is an inside view of an unassembled insulated pouch, according to an exemplary embodiment.

FIG. 6B is a perspective view of the insulated pouch of FIG. 6A in assembled and expanded form, according to an exemplary embodiment.

FIG. 6C is an inside perspective view of the insulated pouch of FIG. 6A in assembled and expanded form, according to an exemplary embodiment.

FIG. 7A is an inside view of an unassembled insulated pouch, according to an exemplary embodiment.

FIG. 7B is a perspective view of the insulated pouch of FIG. 7A in assembled and expanded form, according to an exemplary embodiment.

FIG. 7C is a perspective view of the insulated pouch of FIG. 7A in assembled and expanded form, according to an exemplary embodiment.

FIG. 7D is a bottom perspective view of the insulated pouch of FIG. 7A in assembled and expanded form, according to an exemplary embodiment.

FIG. 7E is an inside perspective view of the insulated pouch of FIG. 7A in assembled and expanded form, according to an exemplary embodiment.

FIG. 7F is a perspective view of the insulated pouch of FIG. 7A in assembled and collapsed form, according to an exemplary embodiment.

FIG. 8A is an inside view of an unassembled insulated bag, according to an exemplary embodiment.

FIG. 8B is a perspective view of the insulated bag of FIG. 8A in assembled and expanded form, according to an exemplary embodiment.

FIG. 8C is an inside perspective view of the insulated bag of FIG. 8A in assembled and expanded form, according to an exemplary embodiment.

FIG. 8D is a bottom perspective view of the insulated bag of FIG. 8A in assembled and expanded form, according to an exemplary embodiment.

FIG. 8E is a bottom perspective view of the insulated bag of FIG. 8A in assembled and expanded form, according to an exemplary embodiment.

FIG. 8F is a perspective view of the insulated bag of FIG. 8A in assembled and collapsed form, according to an exemplary embodiment.

FIG. 9A is an inside view of an unassembled insulated bag, according to an exemplary embodiment.

FIG. 9B is a perspective view of the insulated bag of FIG. 9A in assembled and expanded form, according to an exemplary embodiment.

FIG. 9C is a bottom perspective view of the insulated bag of FIG. 9A in assembled and expanded form, according to an exemplary embodiment.

FIG. 9D is an inside perspective view of the insulated bag of FIG. 9A in assembled and expanded form, according to an exemplary embodiment.

FIG. 9E is a bottom perspective view of the insulated bag of FIG. 9A in assembled and collapsed form, according to an exemplary embodiment.

FIG. 9F is a bottom perspective view of the insulated bag of FIG. 9A in assembled and collapsed form, according to an exemplary embodiment.

FIG. 10A is an inside view of an unassembled insulated bag, according to an exemplary embodiment.

FIG. 10B is a top perspective view of the insulated bag of FIG. 10A in assembled and expanded form, according to an exemplary embodiment.

FIG. 10C is a perspective view of the insulated bag of FIG. 10A in assembled and expanded form, according to an exemplary embodiment.

FIG. 10D is a side perspective view of the insulated bag of FIG. 10A in assembled and expanded form, according to an exemplary embodiment.

FIG. 10E is a bottom perspective view of the insulated bag of FIG. 10A in assembled and expanded form, according to an exemplary embodiment.

FIG. 10F is a perspective view of the insulated bag of FIG. 10A in assembled and expanded form, according to an exemplary embodiment.

FIG. 10G is a perspective view of the insulated bag of FIG. 10A in assembled and expanded form, according to an exemplary embodiment.

FIG. 11A is an inside view of an unassembled insulated bag, according to an exemplary embodiment.

FIG. 11B is a perspective view of the insulated bag of FIG. 11A in assembled and expanded form, according to an exemplary embodiment.

FIG. 11C is a top perspective view of the insulated bag of FIG. 11A in assembled and expanded form, according to an exemplary embodiment.

FIG. 11D is an inside perspective view of the insulated bag of FIG. 11A in assembled and expanded form, according to an exemplary embodiment.

FIG. 11E is a perspective view of the insulated bag of FIG. 11A in assembled and expanded form, according to an exemplary embodiment.

FIG. 12A is an inside view of an unassembled insulated bag, according to an exemplary embodiment.

FIG. 12B is a perspective view of the insulated bag of FIG. 12A in assembled and expanded form, according to an exemplary embodiment.

FIG. 13A is an inside view of an unassembled insulated bag, according to an exemplary embodiment.

FIG. 13B is a perspective view of the insulated bag of FIG. 13A in assembled and expanded form, according to an exemplary embodiment.

FIG. 13C is a perspective view of the insulated bag of FIG. 13A in assembled and expanded form, according to an exemplary embodiment.

FIG. 13D is an inside perspective view of the insulated bag of FIG. 13A in assembled and expanded form, according to an exemplary embodiment.

FIG. 13E is a perspective view of the insulated bag of FIG. 13A in assembled and expanded form, according to an exemplary embodiment.

FIG. 13F is a perspective view of the insulated bag of FIG. 13A in assembled and expanded form, according to an exemplary embodiment.

FIG. 14A is a perspective view of a machine for making one or more insulated bags.

FIG. 14B is a cutaway view of a portion A of the machine of FIG. 14A.

FIG. 14C is a cutaway view of a portion B of the machine of FIG. 14A.

FIG. 15A is a flowchart of a method for forming an insulated bag, according to an exemplary embodiment.

FIG. 15B is a flowchart of a method for forming an insulated bag, according to an exemplary embodiment.

FIG. 16A is an inside view of an unassembled insulated pouch, according to an exemplary embodiment.

FIG. 16B is a perspective view of the insulated pouch of FIG. 16A in assembled and collapsed form, according to an exemplary embodiment.

FIG. 16C is a perspective view of the insulated pouch of FIG. 16A in assembled and collapsed form, according to an exemplary embodiment.

FIG. 16D is an inside perspective view of the insulated pouch of FIG. 16A in assembled and expanded form, according to an exemplary embodiment.

FIG. 16E is a side perspective view of the insulated pouch of FIG. 16A in assembled and expanded form, according to an exemplary embodiment.

FIG. 16F is a top perspective view of the insulated pouch of FIG. 16A in assembled and expanded form, according to an exemplary embodiment.

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive.

Embodiments of the disclosed technology include insulation products capable of being recycled curbside or compostable, flexible for providing insulation and cushioning to items in a shipping container (such as grocery items), lightweight, and constructed in a manner that allows for on-demand manufacture (such as on location at retailer shipping locations). Such insulation products not only offer advantageous insulation and cushioning properties, but also may avoid certain shipping costs and constraints associated with shipping pre-manufactured insulation products with larger volumes (due to the manufactured state) and needs to ensure that such products maintain insulation properties while in transit to retailer shipping locations. Additionally, the disclosed machines and methods for manufacturing insulation products provide users with flexibility in the sizing, dimensions, and insulation property qualities needed for individual retailer needs (such as individual product shipping requirements), such that insulation products can be customized at a retailer shipping location, leading to less waste, higher cost efficiency and time savings. Referring now to the figures, in which like reference numerals represent like parts, various embodiments of the disclosure will be disclosed in detail.

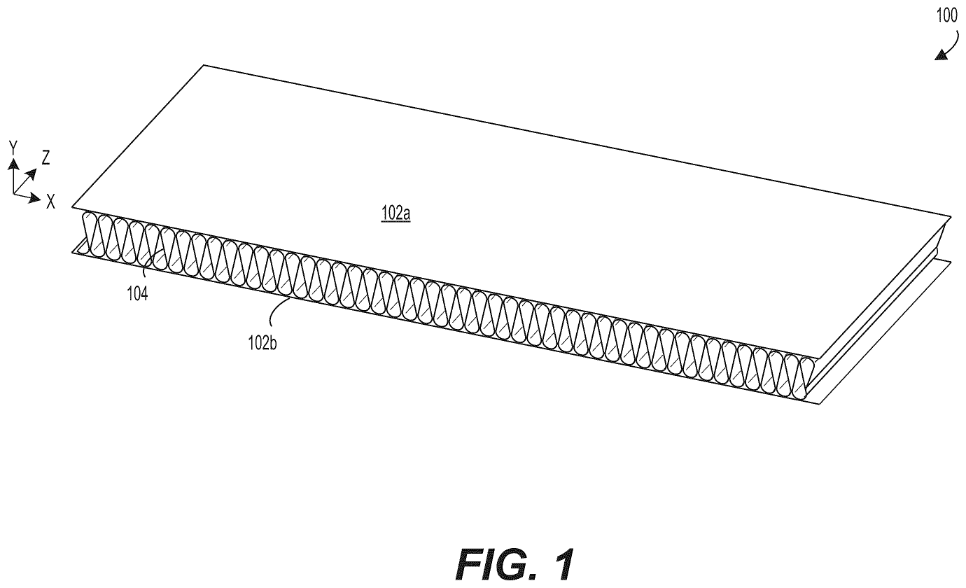

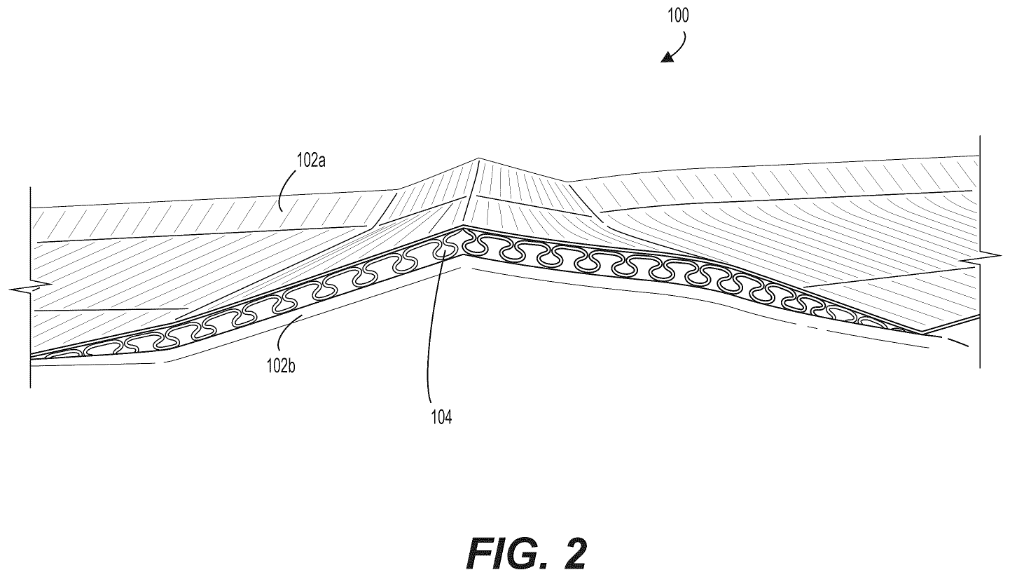

FIGS. 1 and 2 are perspective views of an insulating substrate 100 according to an exemplary embodiment. Insulating substrate 100 may include a first layer 102a and a second layer 102b (also referred to as outer layers) with a core 104 that may be a continuous sheet of paper. In some embodiments, the core 104 may be formed into a wave pattern (or a waved core 104) over its entire length and have a plurality of flexible loops. The flexible loops may be formed in various shapes and/or patterns, such as S-shaped loops (FIG. 1) or U-shaped loops (FIG. 2). In some embodiments, the first and second layers 102a, 102b may be directly sealed (e.g., via an adhesive) to the core 104. In some embodiments, the first and/or second layer 102a, 102b may be wider than the core layer 104 (e.g., in the X-direction and/or Z-direction, as discussed below) such that the first and/second layer 102a, 102b have one or more extensions, e.g., portions that extend past the width of the core layer 104. As such, the first and/or second layer 102a, 102b can be directly sealed to one another via these extensions thereby concealing the core layer 104. For example, the first layer 102a may have extensions in the X-direction such that they can be folded down, concealing the core 104, and adhered to the second layer 102b. In some embodiments, insulating substrate 100 may include only a single layer, e.g., either first layer 102a or second layer 102b, attached to and/or covering core 104. In such embodiments, the insulated products discussed herein may include only an external layer (e.g., first layer 102a) with core 104 being internal to the external layer. It should be understood that alternative structures of the core 104 may be formed and utilized in the insulation products disclosed herein.

Specifically shown in FIG. 1 are X, Y, Z axes or directions. The X-direction is referred to as the machine direction and travels a length of the insulation product in the direction that various insulation products disclosed herein are formed. The Y-direction is perpendicular to the X-direction and the Z-direction, and is sometimes referred to as the thickness direction. The Z-direction, or width direction, is perpendicular to the X-direction and the Y-direction, and is sometimes referred to as the transverse direction. As can be seen from FIG. 1, core 104 substantially traverses in the machine direction (X-direction) while also forming flexible loops in the Y-direction in between the two planes formed by first layer 102a and second layer 102b. Such flexible loops may, in some embodiments, contact adjacent loops as the wavelike pattern of core 104 is formed. In some embodiments, the flexible loops of core 104 are formed over the length of core 104 in the X-direction.

In some cases, a coating (e.g., a polymer coating such as polyethylene) may be disposed on the first and/or second layer 102a, 102b. In some cases, the coating may be disposed on core layer 104. First layer 102a, second layer 102b, or core 104 may include, but not limited to, kraft paper, machine glazed (MG) paper, smooth finished (SF) paper, machined finished (MF) paper, glassines, one or more polymeric films (e.g., polyethylene), paper-based product, supercalendered kraft (SCK) paper, and/or poly-coated paper (polyethylene coated paper such as polyethylene coated kraft paper).

In some cases, a metalized and/or reflective material may be disposed on (e.g., laminated on) one or more surfaces (e.g., interior, exterior) of the first and/or second layer 102a, 102b. Such material may be selected to provide a radiant component of heat transfer, improve thermal performance, and/or improve water-resistance in the formation of one or more of the insulated products disclosed herein.

Insulating substrate 100 as shown in FIGS. 1-2 is merely exemplary. Any substrate (e.g. one or more paper layers) or insulating structure may be used with the following embodiments.

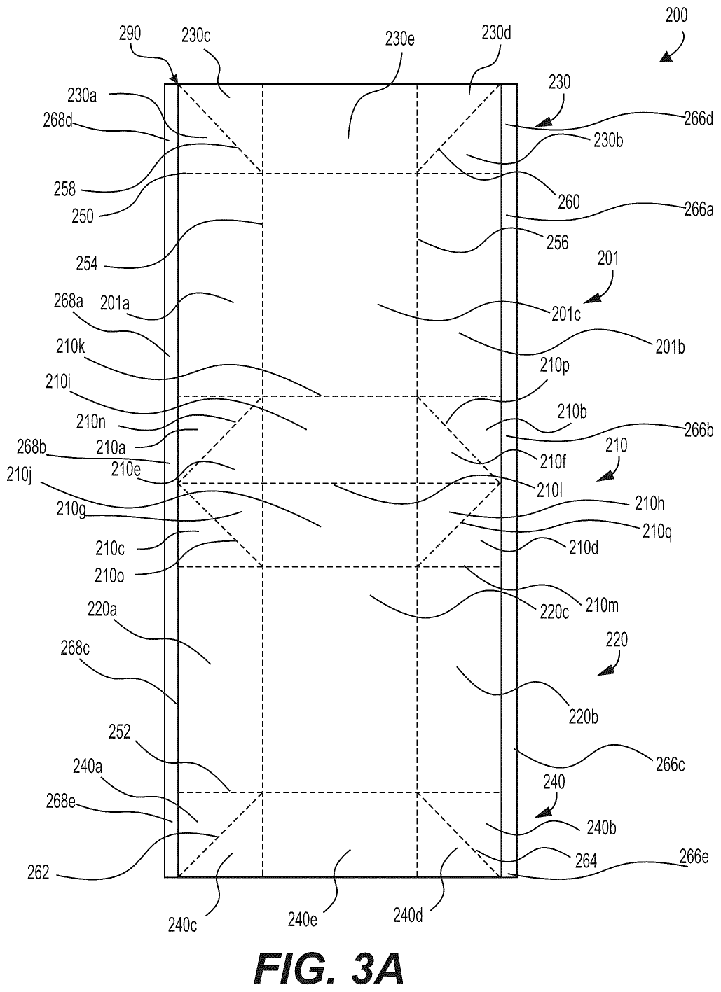

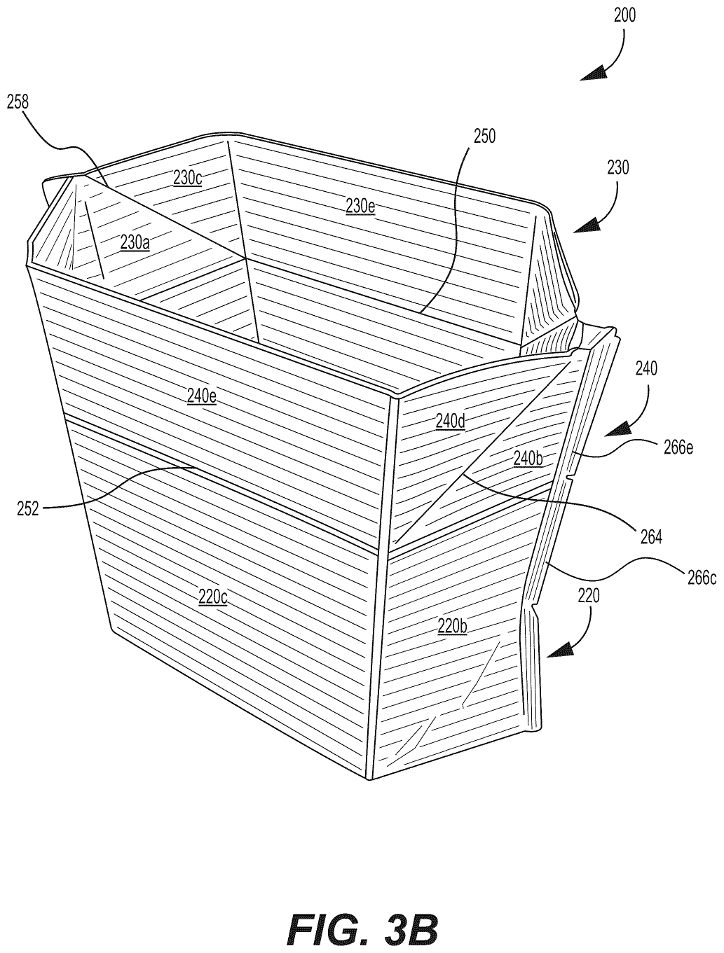

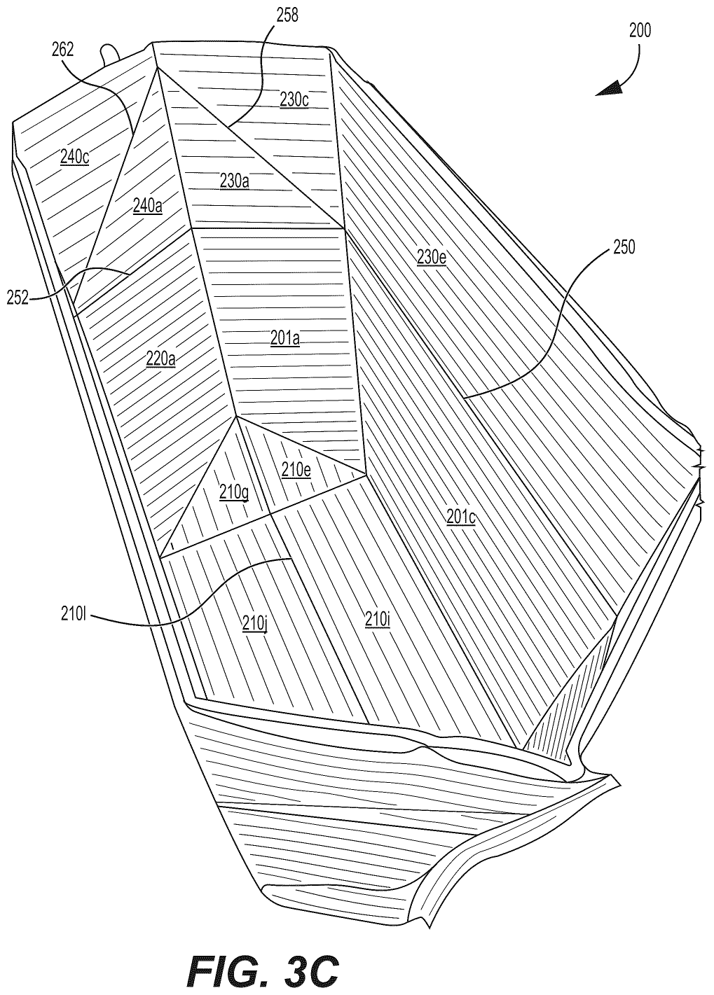

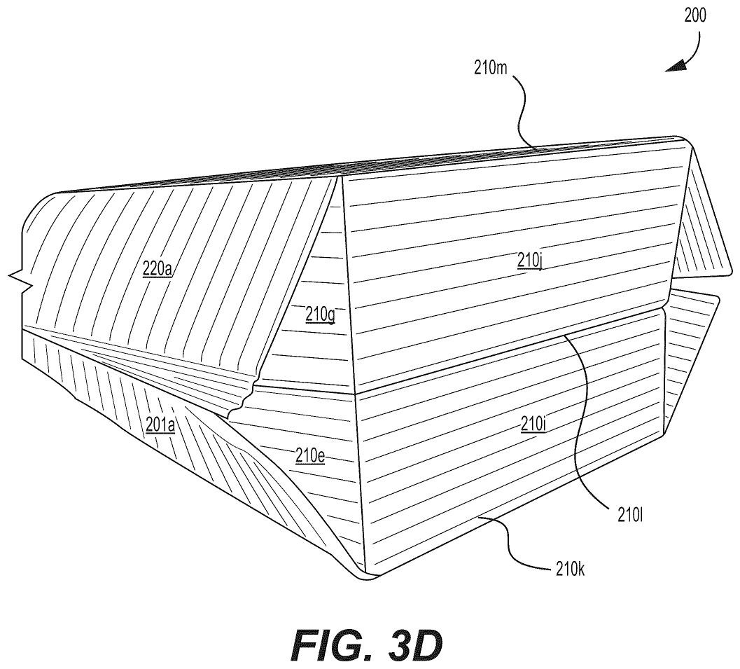

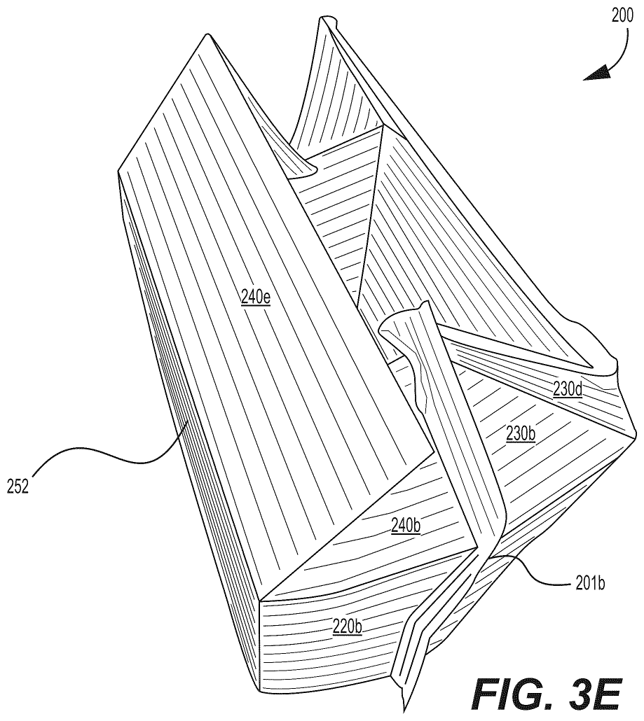

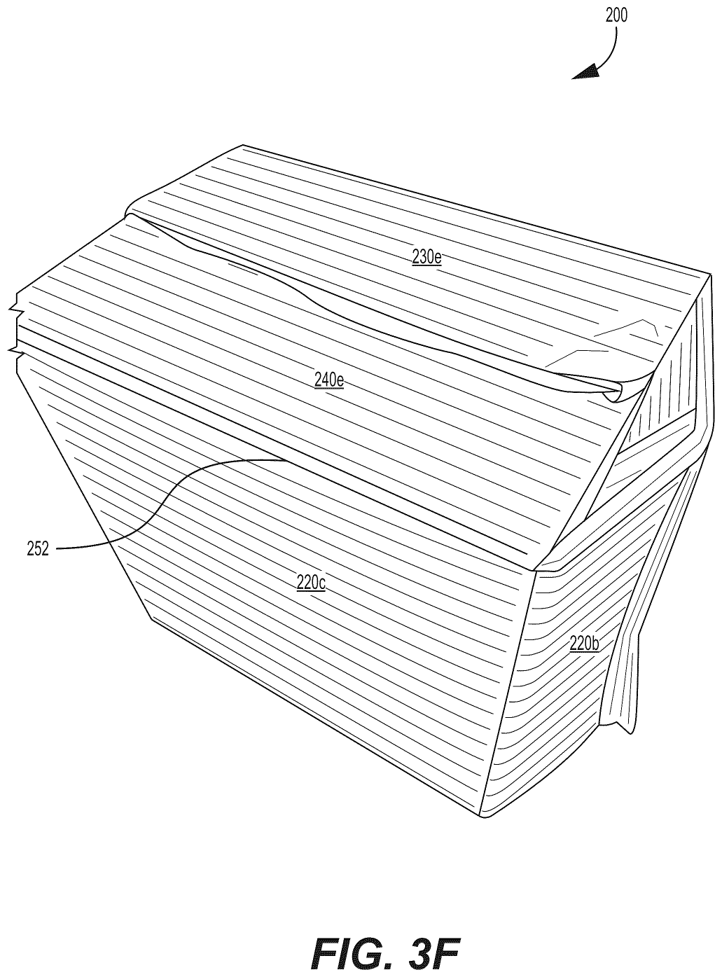

FIGS. 3A-3F show various perspectives and aspects of an insulated bag 200 that may include insulating substrate 100 and is configured to expand and collapse flat. When pressure is applied to sides of a collapsed insulated bag 200, it pops or springs into an expanded insulated bag 200 that is stable due to its one or more crease lines. The one or more crease lines are compressed portions of the insulated bag 200, heat bonded portions of the insulated bag 200, or compressed and heat bonded portions of the insulated bag 200. The structure and the one or more crease lines of the insulated bag 200 are described below.

Insulated bag 200 may include or be formed from an insulating substrate, such as insulating substrate 100. The insulating substrate 100 may include a first section 201 including a first outer portion 201a, a second outer portion 201b, and a first middle portion 201c. The insulated bag 200 may include a second section 210 including a first outer angular portion 210a, a second outer angular portion 210b, a third outer angular portion 210c, a fourth outer angular portion 210d, a first inner angular portion 210e, a second inner angular portion 210f, a third inner angular portion 210g, a fourth inner angular portion 210h, a second middle portion 210i, and a third middle portion 210j. The insulating substrate 100 may include a third section 220 that may include a third outer portion 220a, a fourth outer portion 220b, and a fourth middle portion 220c. The first section 201 may include a first edge 268a and a second edge 266a, the second section 210 may include a third edge 268b and a fourth edge 266b, and the third section 220 may include a fifth edge 268c and a sixth edge 266c. The insulating substrate 100 may further include a fourth section 230 that may include a fifth outer angular portion 230a, a sixth outer angular portion 230b, a fifth middle section 230e, a seventh edge 268d, and an eighth edge 266d. The insulating substrate 100 may further include a fifth section 240 that may include a seventh outer angular portion 240a, an eighth outer angular portion 240b, a sixth middle portion 240e, a ninth edge 268e, and a tenth edge 266e.

The insulating substrate 100 formed into insulated bag 200 may include a first crease pattern 290 corresponding to one or more crease lines 250, 210k, 210l, 210m, 210n, 210o, 210p, 210q, 252, 254, 256, 258, 260, 262, 264, that may be formed via heat, pressure, or both as described below. In some cases, a coating (e.g., polymer coating) disposed on the first and/or second layer 102a, 102b may be heated according to the first creasing pattern 290, which may (i) melt and reform when cooled to maintain the first creasing pattern or (ii) thermoset along the first creasing pattern to maintain the creasing pattern. The one or more crease lines may include a first crease line 210k that horizontally separates the first section 201 from the second section 210. The one or more crease lines may also include a second crease line 210m that horizontally separates the second section 210 from the third section 220. The one or more crease lines may include a third crease line 250 that horizontally separates the first section 201 from the fourth section 230. The one or more crease lines may include a fourth crease line 252 that horizontally separates the third section 220 from the fifth section 240. The one or more crease lines may include a fifth crease line 254 that vertically separates (i) the first middle portion 201c of the first section 201 from the first outer portion 201a of the first section 201, (ii) the second middle portion 210i of the second section 210 from the first inner angular portion 210e of the second section 210, (iii) the third inner angular portion 210g of the second section 210 from the third middle portion 210j of the second section 210, (iv) the fourth middle portion 220c of the third section 220 from the third outer portion 220a of the third section 220, (v) the fifth middle portion 230e of the fourth section 230 from the fifth inner angular portion 230c of the fourth section 230, and (vi) the sixth middle portion 240e of the fifth section 240 from the seventh inner angular portion 240c of the fifth section 240. The one or more crease lines may include a sixth crease line 256 that vertically separates (i) the first middle portion 201c of the first section 201 from the second outer portion 201b of the first section 201, (ii) the second middle portion 210i of the second section 210 from the second inner angular portion 210f of the second section 210, (iii) the fourth inner angular portion 210h of the second section 210 from the third middle portion 210j of the second section 210, (iv) the fourth middle portion 220c of the third section 220 from the fourth outer portion 220b of the third section 220, (v) the fifth middle portion 230e of the fourth section 230 from the sixth inner angular portion 230d of the fourth section 230, and (vi) the sixth middle portion 240e of the fifth section 240 from the eighth inner angular portion 240d of the fifth section 240.

The one or more crease lines may include a seventh crease line 258 that separates the fifth outer angular portion 230a from the fifth inner angular portion 230c of the fourth section 230 at a first oblique angle. The one or more crease lines may include an eighth crease line 260 that separates the sixth outer angular portion 230b from the sixth inner angular portion 230d of the fourth section 230 at a second oblique angle. The one or more crease lines may include a ninth crease line 262 that separates the seventh outer angular portion 240a from the seventh inner angular portion 240c of the fifth section 240 at a third oblique angle. The one or more crease lines may include a tenth crease line 264 that separates the eighth outer angular portion 240b from the eighth inner angular portion 240d of the fifth section 240 at a fourth oblique angle.

Specifically within the second section 210, the one or more crease lines may include a eleventh crease line 210n that separates the first outer angular portion 210a from the first inner angular portion 210e at a fifth oblique angle; a twelfth crease line 2100 that separates the third outer angular portion 210c from the third inner angular portion 210g at a sixth oblique angle; a thirteenth crease line 210p that separates the second outer angular portion 210b from the second inner angular portion 210f at a seventh oblique angle; and a fourteenth crease line 210q that separates the fourth outer angular portion 210d from the fourth inner angular portion 210h at an eighth oblique angle.

FIGS. 3B-3F specifically show how the insulating substrate 100 can be folded, creased, and expanded to form the insulated bag 200. As particularly shown in FIGS. 3C and 3D, second and third middle portions 210i and 210j of the second section 210 can form the bottom of the insulated bag 200 when the insulating substrate 100 is folded along crease lines 210k and 210m. Portions (e.g., upper portions) of the first edge 268a and the second edge 266a of the first section 201 may be respectively attached to portions (e.g., upper portions) of the fifth edge 268c and the sixth edge 266c of the third section 220. In addition, portions (e.g., lower portions) of the first edge 268a and the second edge 266a may be respectively attached to portions of the third edge 268b and the fourth edge 266b of the second section 210. Additionally, portions (e.g., lower portions) of the fifth edge 268c and the sixth edge 266c may be respectively attached to portions of the third edge 268b and fourth edge 266b of the second section 210. Further, portions of the seventh edge 268d and eighth edge 266d may be respectively attached to portions of the ninth edge 268e and tenth edge 266e. The aforementioned edges may be heat-sealed to one another by activating a polymer coating on the first and/or second layer 102a, 102b.

As particularly shown in FIG. 3D, inner angular portions 210e, 210f, 210g, and 210d can be tucked upward. The outer edges 268 and 266 can be brought together and sealed to form the closed sides of the insulated bag 200. As particularly shown in FIGS. 3E and 3F, the outer angular portions 230a, 230b, 240a, and 240b can then be tucked inward and down (FIG. 3E) such that the top of the insulated bag 200 can be formed from middle portions 230e and 240e.

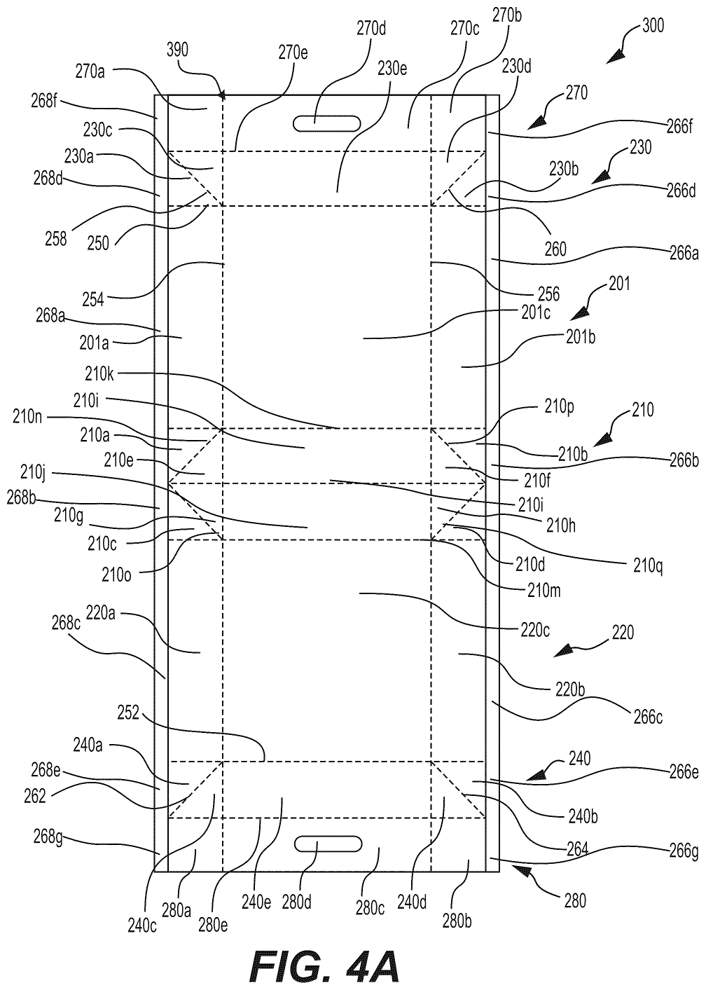

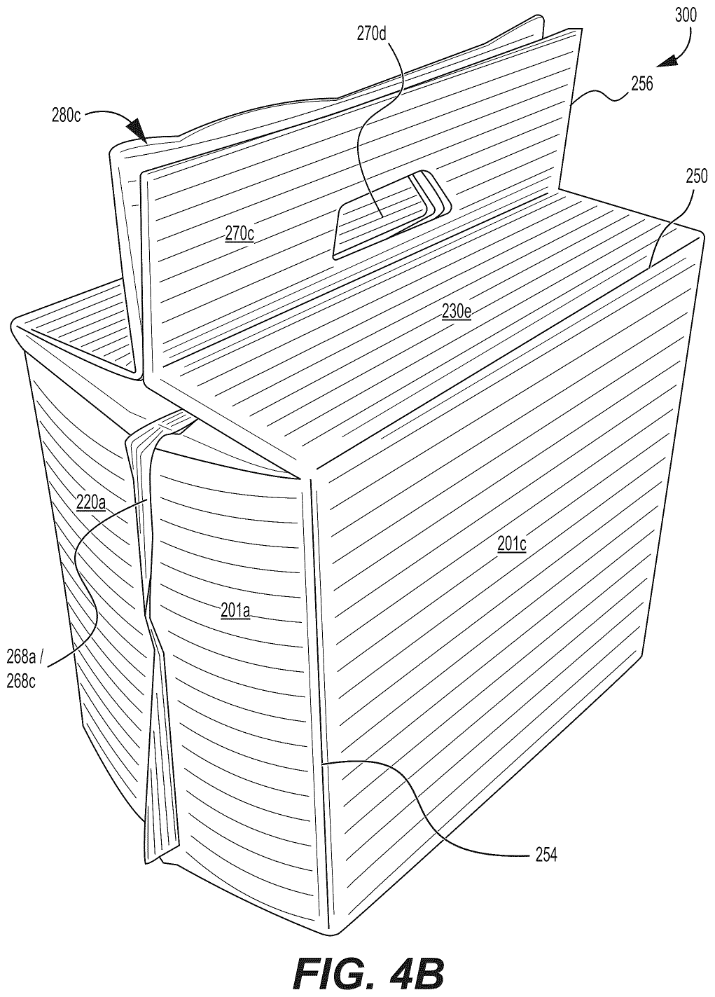

FIGS. 4A-4B show various perspectives and aspects of another insulated bag 300 that may include insulating substrate 100 and is configured to expand and collapse flat. As shown in FIG. 4A, the insulating substrate 100 may include one or more of the sections, portions, and crease lines as discussed above with respect to FIG. 3A. In addition, insulating substrate 100 may include a sixth section 270 and a seventh section 280. Sixth section 270 may include a fifth outer portion 270a, a sixth outer portion 270b, a seventh middle portion 270c, and a first opening 270d that may be used as part of a handle, as further discussed below. Seventh section 280 may include a seventh outer portion 280a, an eighth outer portion 280b, an eighth middle portion 280c, and a second opening 280d that may be used as part of the handle, as further discussed below. Insulating substrate 100 may further include a crease line 270e that horizontally separates the fourth section 230 from the sixth section 270, and a crease line 280e that horizontally separates the fifth section 240 from the seventh section 280. As shown, crease line 254 may further vertically separate (i) fifth outer portion 270a from seventh middle portion 270c, and (ii) seventh outer portion 280a from eighth middle portion 280c. As such, insulating substrate 100 of FIG. 3A includes a second crease pattern 390 corresponding to crease lines 210k, 210l, 210m, 210n, 210o, 210p, 210q, 250, 252, 254, 256, 258, 260, 262, 264, 270e, 280e that may be formed via heat, pressure, or both as described below.

As shown in FIG. 4A, the first section 201 may include a first edge 268a and a second edge 266a, the second section 210 may include a third edge 268b and a fourth edge 266b, the third section 220 may include a fifth edge 268c and a sixth edge 266c, the fourth section 230 may include a seventh edge 268d and an eighth edge 266d, the fifth section 240 may include a ninth edge 268e and a tenth edge 266e, the sixth section 270 may include an eleventh edge 268f and a twelfth edge 266f, and the seventh section 280 may include a thirteenth edge 268g and a fourteenth edge 266g.

As shown in FIG. 4B, insulated bag 300 can be folded and expanded in a similar fashion as discussed above with respect to insulated bag 200, except that outer portions 270a, 270b, 280a, 280b may be tucked inward and hidden behind middle portions 270c and 280c, such that middle portions 270c and 280c can extend upward such that openings 270d, 280d can be aligned to form a handle of the insulated bag 300. In some embodiments, insulated bag 300 may include one or more reinforcement layers to increase the strength of the handle or any other portion of the insulated bag 300. Such reinforcement layer(s) may allow for variation in strength of the bag and/or handle to aid in carrying heavier payloads. It should be understood that any of the insulated bags and products disclosed herein could incorporate similar reinforcement layers(s), and such reinforcement layer(s) could be made of any material whether the same or different from the material(s) incorporated into other portions of the bag/product.

Portions (e.g., upper portions) of the first edge 268a and the second edge 266a of the first section 201 may be respectively attached to portions (e.g., upper portions) of the fifth edge 268c and the sixth edge 266c of the third section 220. In addition, portions (e.g., lower portions) of the first edge 268a and the second edge 266a may be respectively attached to portions of the third edge 268b and the fourth edge 266b of the second section 210. Additionally, portions (e.g., lower portions) of the fifth edge 268c and the sixth edge 266c may be respectively attached to portions of the third edge 268b and fourth edge 266b of the second section 210. Further, portions of the seventh edge 268d and eighth edge 266d may be respectively attached to portions of the ninth edge 268e and tenth edge 266e, and portions of the eleventh edge 268f and twelfth edge 266f may be respectively attached to portions of the thirteenth edge 268g and the fourteenth edge 266g. The aforementioned edges may be heat-sealed to one another by activating a polymer coating on the first and/or second layer 102a, 102b.

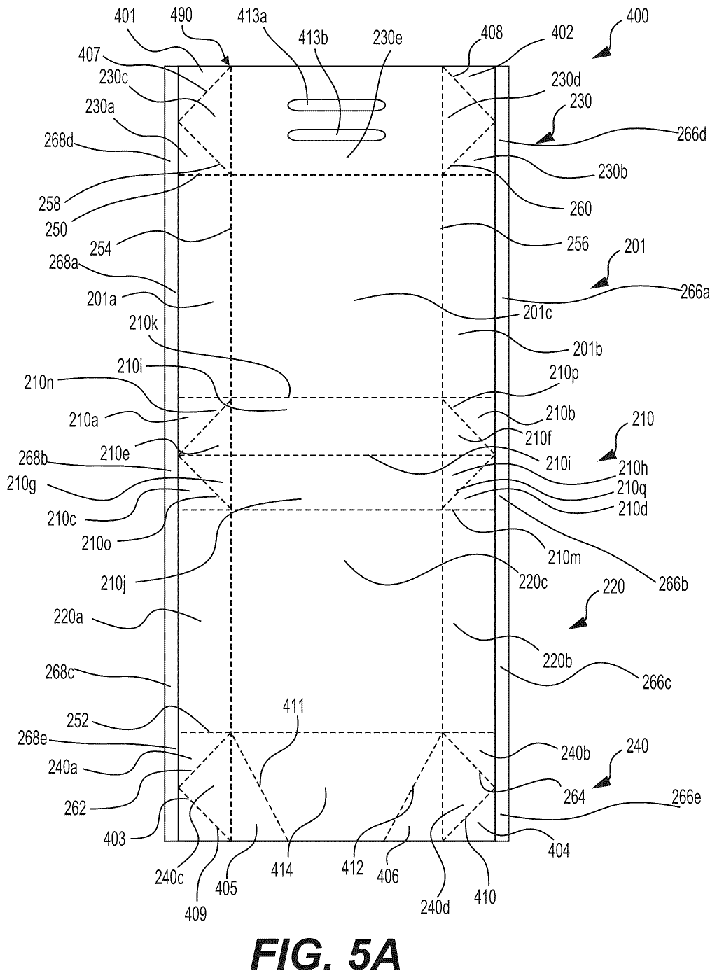

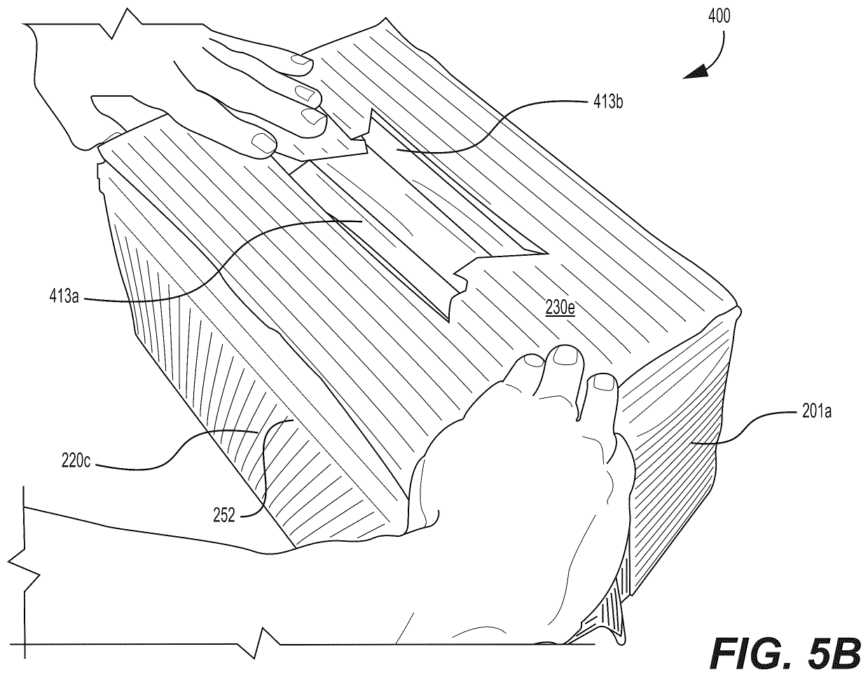

FIGS. 5A-5B show various perspectives and aspects of another insulated bag 400 that may include insulating substrate 100 and is configured to expand and collapse flat. As shown in FIG. 5A, the insulating substrate 100 may include one or more of the sections, portions, and crease lines as discussed above with respect to FIG. 3A. In addition, the fourth section 230 may include a ninth outer angular portion 401, a tenth outer angular portion 402, and two openings 413a, 413b that may be used as part of a handle, as further discussed below. Fourth section 230 may also include a crease line 407 that separates the ninth outer angular portion 401 from the fifth inner angular portion 230c at an oblique angle, and a crease line 408 that separates the tenth outer angular portion 402 from the sixth inner angular portion 230d at an oblique angle. The fifth section 240 may include an eleventh outer angular portion 403 and a twelfth outer angular portion 404. Fifth section 240 may include a crease line 409 that separates the eleventh outer angular portion 403 from the seventh inner angular portion 240c at an oblique angle, and a crease line 410 that separates the twelfth outer angular portion 404 from the eighth inner angular portion 240d at an oblique angle. The sixth middle portion 240e of fifth section 240 may further include a crease line 411 that separates a thirteenth outer angular portion 405 from a middle angular portion 414 at an oblique angle, and a crease line 412 that separates a fourteenth outer angular portion 406 from the middle angular portion 414 at an oblique angle. As such, insulating bag 400 may include an insulating substrate 100 with a third crease pattern 490 corresponding to crease lines 210k, 210l, 210m, 210n, 210o, 210p, 210q, 250, 252, 254, 256, 258, 260, 262, 264, 403, 407, 408, 410, 411, 412 that may be formed via heat, pressure, or both as described below.

The first section 201 may include a first edge 268a and a second edge 266a, the second section 210 may include a third edge 268b and a fourth edge 266b, the third section 220 may include a fifth edge 268c and a sixth edge 266c, and fourth section 230 may include a seventh edge 268d and an eighth edge 266d, and the fifth section 240 may include a ninth edge 268e and a tenth edge 266e.

As shown in FIG. 5B, insulated bag 400 can be folded and expanded in a similar fashion as discussed above with respect to insulated bags 200 and 300, except that the additional crease lines of fifth section 240 enable the middle angular portion 414 to form an angled panel that may be tucked underneath middle portion 230e of fourth section 230 such that middle portion 230e can be formed as the upper or top-most flat panel of the insulated bag 400, and openings 413a, 413b may act as a handle of insulated bag 400. Portions (e.g., upper portions) of the first edge 268a and the second edge 266a of the first section 201 may be respectively attached to portions (e.g., upper portions) of the fifth edge 268c and the sixth edge 266c of the third section 220. In addition, portions (e.g., lower portions) of the first edge 268a and the second edge 266a may be respectively attached to portions of the third edge 268b and the fourth edge 266b of the second section 210. Additionally, portions (e.g., lower portions) of the fifth edge 268c and the sixth edge 266c may be respectively attached to portions of the third edge 268b and fourth edge 266b of the second section 210. Further, portions of the seventh edge 268d and eighth edge 266d may be respectively attached to portions of the ninth edge 268e and tenth edge 266e. The aforementioned edges may be heat-sealed to one another by activating a polymer coating on the first and/or second layer 102a, 102b.

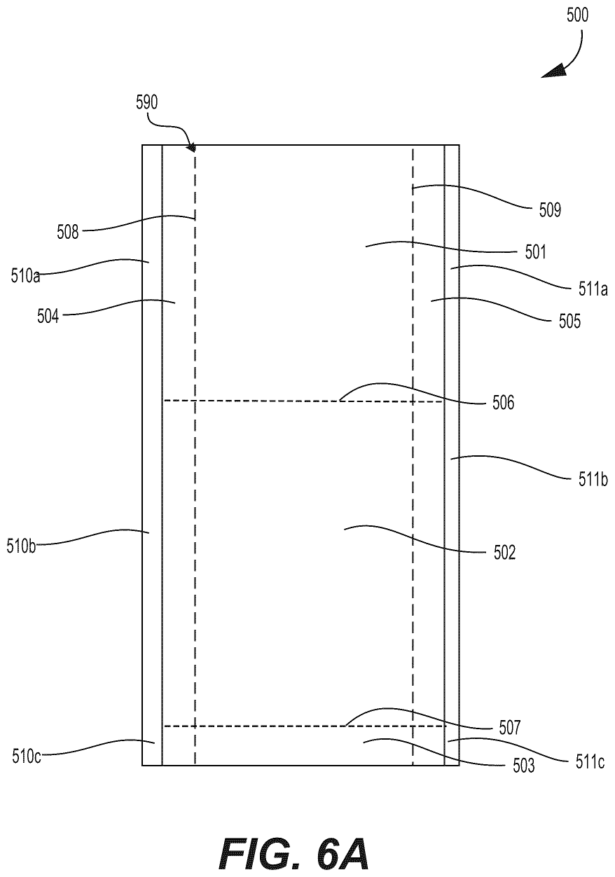

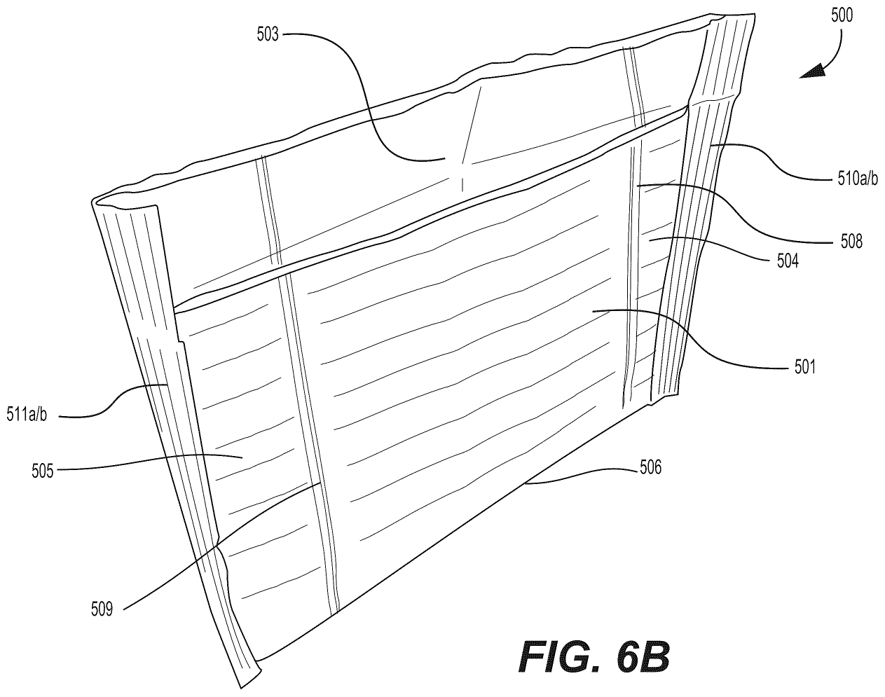

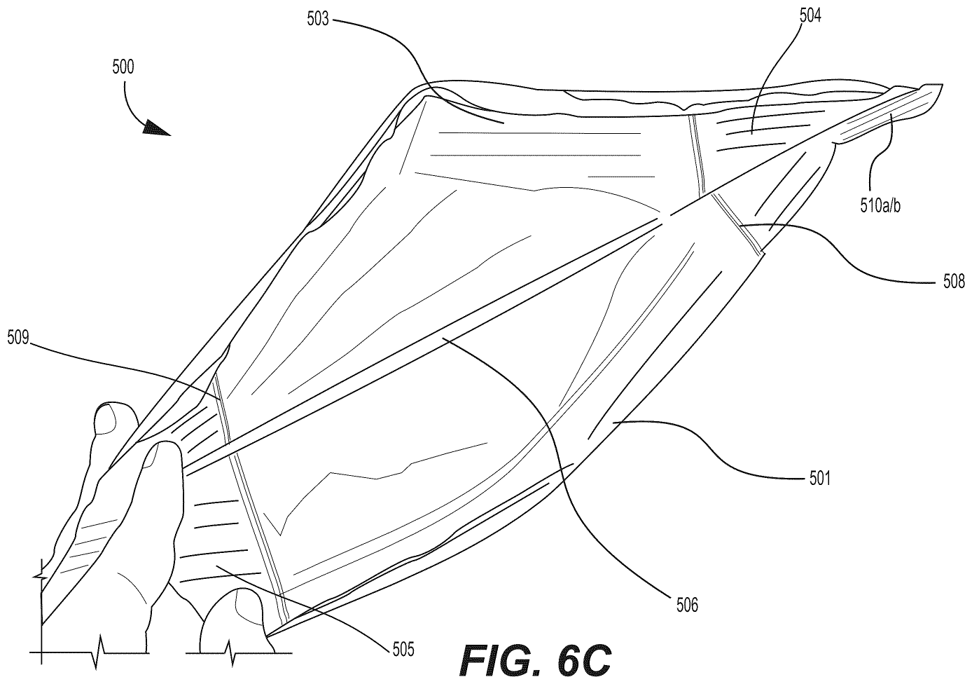

FIGS. 6A-6C show various perspectives and aspects of an insulated pouch 500 that may include insulating substrate 100 and is configured to expand and collapse flat. In such embodiment, insulating substrate 100 may include a first section 501, a second section 502, a third section 503, a fourth section 504, and a fifth section 505. Insulating substrate 100 may include a crease line 506 that horizontally separates the first and section sections 501, 502, and a crease line 607 that horizontally separatees the second and third sections 502, 503. Insulating substrate 100 may include a crease line 508 that vertically separates the first, second, and third sections 501, 502, 503 from the fourth section 504, and a crease line 509 that vertically separates the first, second, and third sections 501, 502, 503 from the fifth section 505. The first section 501 may include first edge 510a and second edge 511a; the second section 502 may include third edge 510b and fourth edge 511b; and the third section 503 may include fifth edge 510c and sixth edge 511c.

As particularly shown in FIGS. 6B-6C, insulating substrate 100 may be folded along crease line 506, such that sections 501 and 502 may form the sides of the insulated pouch 500. The first edge 510a and the second edge 511a of the first section 501 may be respectively attached to the third edge 510b and the fourth edge 511b of the second section 502. The vertical crease lines 508 and 509 allow the insulated pouch 500 to form a pouch that is a hybrid between a two- and three-dimensional form. As opposed to traditional flat-style pouches, this configuration allows easier and more efficient access into the insulated pouch 500 for placing and/or removing items. As particularly shown in FIG. 6B, third section 503 may extend beyond first and second sections 501, 502 when the insulating substrate 100 is folded along crease line 506. This extension may then be used as a closure mechanism for insulated pouch 500. For example, an adhesive strip may be placed on third section 503 such that it may then be folded down and adhered to the outer surface of the first section 501 to close insulated pouch 500. As such, pouch 500 may include an insulating substrate 100 with a fourth crease pattern 590 corresponding to crease lines 506, 507, 508, 509 that may be formed via heat, pressure, or both as described below.

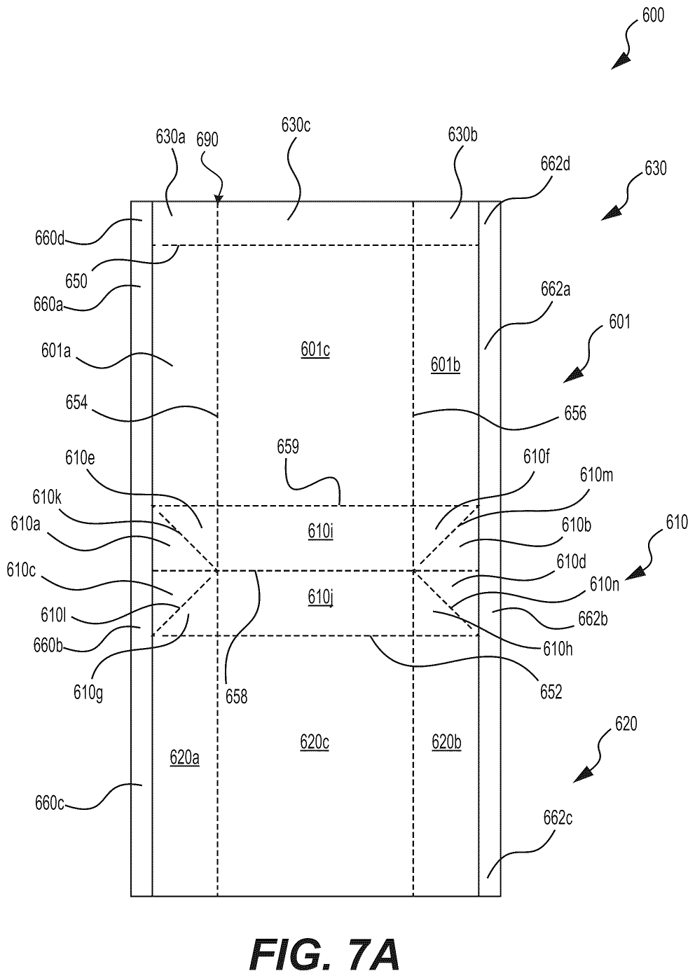

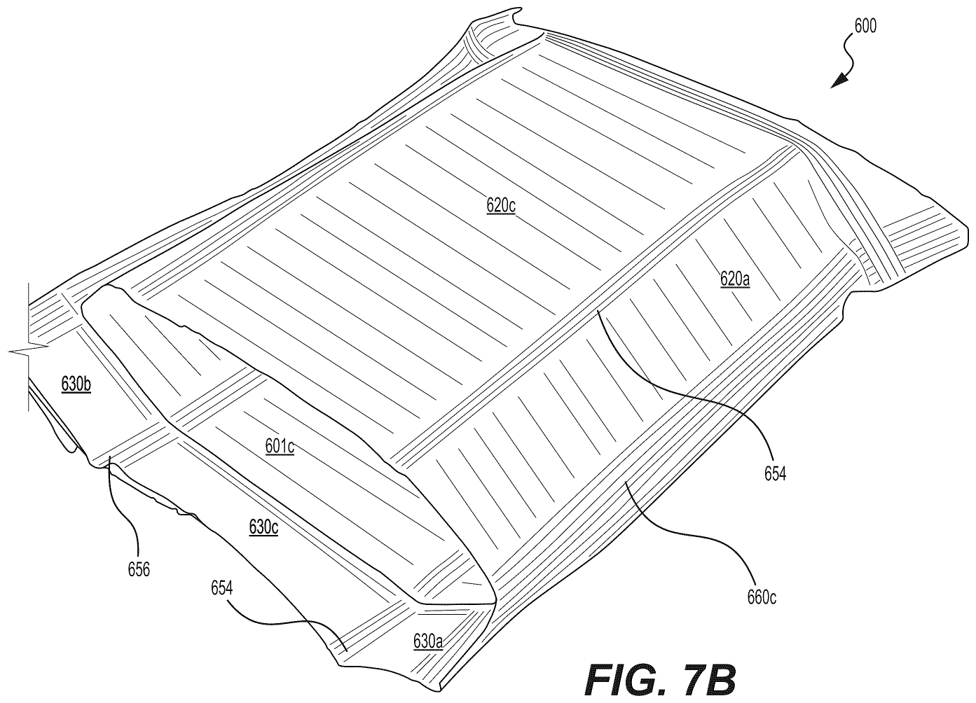

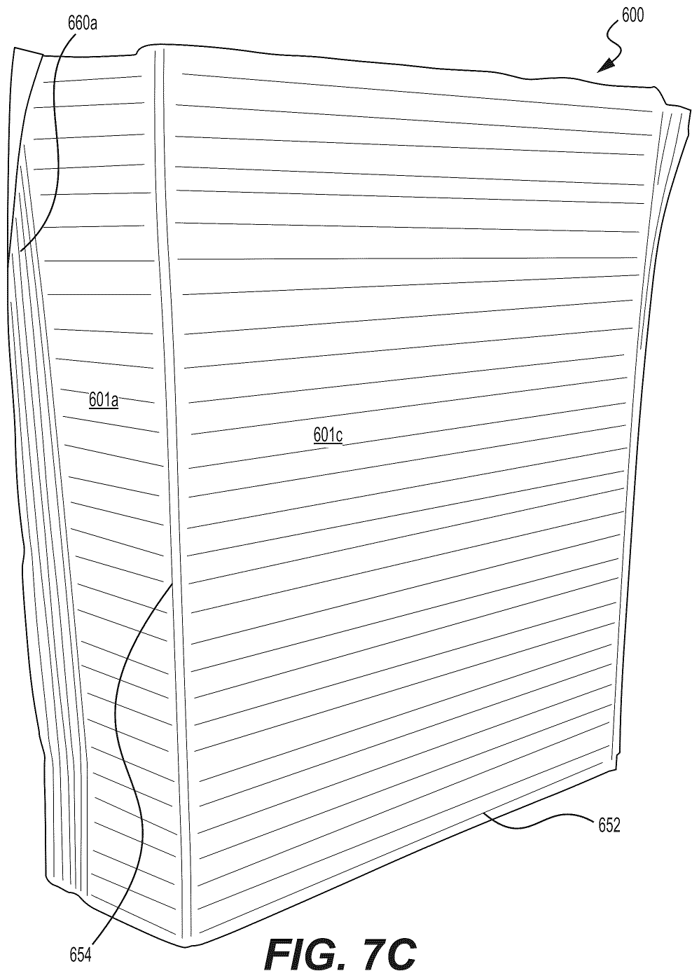

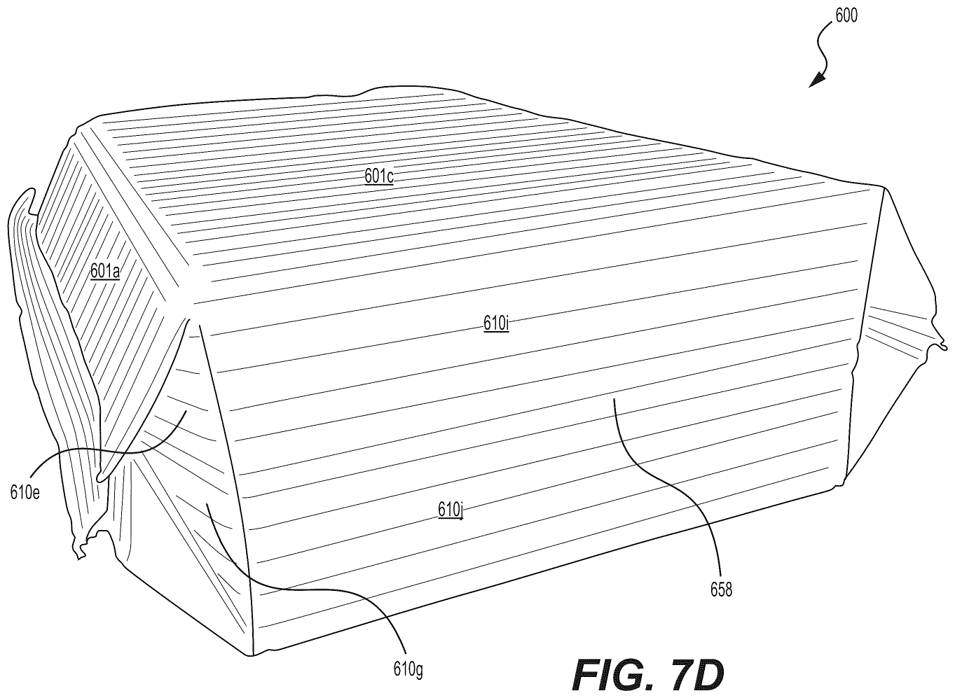

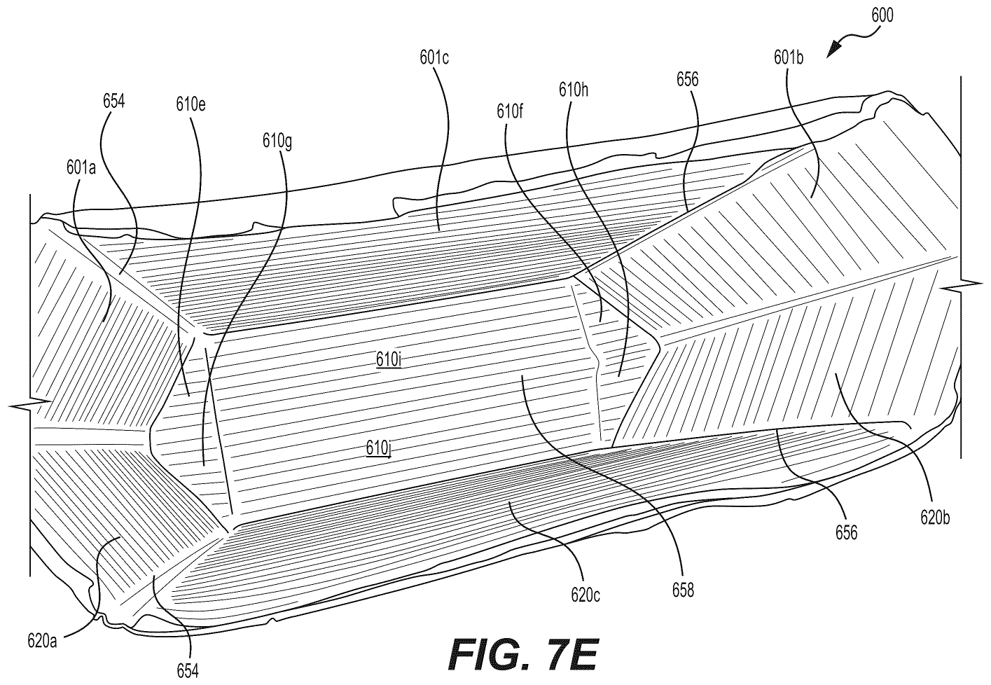

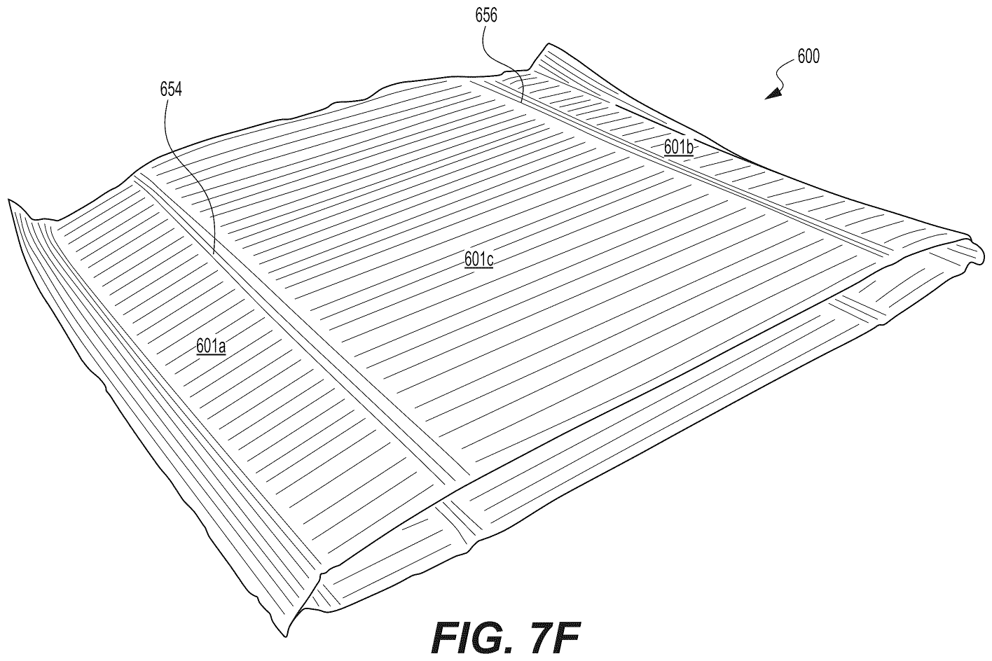

FIGS. 7A-7F show various perspectives and aspects of another insulated pouch 600 that may include insulating substrate 100 and is configured to expand and collapse flat. In such embodiment, insulating substrate 100 may include a first section 601, a second section 610, a third section 620, and a fourth section 630. First section 601 may include a first outer portion 601a, a second outer portion 601b, and a first middle portion 601c. Second section 610 may include a first outer angular portion 610a, a second outer angular portion 610b, a third outer angular portion 610c, a fourth outer angular portion 610d, a first inner angular portion 610e, a second inner angular portion 610f, a third inner angular portion 610g, a fourth inner angular portion 610h, a second middle portion 610i, and a third middle portion 610j. Third section 620 may include a third outer portion 620a, a fourth outer portion 620b, and a fourth middle portion 620c. Fourth section 630 may include a fifth outer portion 630a, a sixth outer portion 630b, and a fifth middle portion 630c. Insulated pouch 600 may further include outer side edges 660 and 662. The first section 601 may include first edge 660a and second edge 662a; the second section 610 may include third edge 660b and fourth edge 662b; the third section 620 may include fifth edge 660c and sixth edge 662c; and fourth section 630 may include seventh edge 660d and eighth edge 662d.

Similar to other insulated products discussed herein, insulated pouch 600 may include a variety of crease lines between and among the above-described portions and sections. For example, insulated pouch 600 may include a crease line 650 that horizontally separates the first section 601 from the fourth section 630, a crease line 659 that horizontally separates the first section 601 from the second section 610, and a crease line 652 that horizontally separates the second section 610 from the third section 620. Insulated pouch 600 may include a crease line 658 in second section 610 that separates (i) the second middle portion 610i from the third middle portion 610j, (ii) the first outer angular portion 610a from the third outer angular portion 610c, and (iii) the second outer angular portion 610b from the fourth outer angular portion 610d. Insulated pouch 600 may include a crease line 654 that vertically separates (i) first middle portion 601c from first outer portion 601a, (ii) second middle portion 610i from first inner angular portion 610e, (iii) third middle portion 610j from third inner angular portion 610g, (iv) fourth middle portion 620c from third outer portion 620a, and (v) fifth middle portion 630c from fifth outer portion 630a. Insulated pouch 600 may include a crease line 656 that vertically separates (i) first middle portion 601c from second outer portion 601b, (ii) second middle portion 610i from second inner angular portion 610f, (iii) third middle portion 610j from fourth inner angular portion 610h, (iv) fourth middle portion 620c from fourth outer portion 620b, and (v) fifth middle portion 630c from sixth outer portion 630b. Within second section 610, the insulated pouch 600 may include a crease line 610k that separates the first inner angular portion 610e from the first outer angular portion 610a at an oblique angle, a crease line 610l that separates the third outer angular portion 610c from the third inner angular portion 610g at an oblique angle, a crease line 610m that separates the second outer angular portion 610b from the second inner angular portion 610f at an oblique angle, and a crease line 610n that separates the fourth outer angular portion 610d from the fourth inner angular portion 610h at an oblique angle. As such, pouch 600 may include an insulating substrate 100 with a fifth crease pattern 690 corresponding to crease lines 650, 652, 654, 656, 658, 610k, 610l, 610m, 610n that may be formed via heat, pressure, or both as described below.

As particularly shown in FIGS. 7D and 7E, insulating substrate 100 may be folded along crease lines 659 and 652 such that middle portions 610i and 610j form the bottom of the insulated pouch 600. As particularly shown in FIGS. 7D and 7F, when the crease line 658 is folded upward, insulated pouch 600 may be collapsed as middle portions 610i and 610j collapse to meet one another. The first edge 660a and the second edge 662a of the first section 601 may be respectively attached to the fifth edge 660c and the sixth edge 662c of the third section 620. In addition, portions (e.g., lower portions) of the first edge 660a and the second edge 662a may be respectively attached to portions of the third edge 660b and the fourth edge 662b of the second section 610. Additionally, portions (e.g., lower portions) of the fifth edge 660c and the sixth edge 662c may be respectively attached to portions of the third edge 660b and the fourth edge 662b of the second section 610. The aforementioned edges may be heat-sealed to one another by activating a polymer coating on the first and/or second layer 102a, 102b.

As particularly shown in FIG. 7B, fourth section 630 may extend beyond sections 601 and 620 once the insulated bag 600 is expanded and formed such that fourth section 630 may aid in closing insulated bag 600. For example, as discussed above with respect to insulated pouch 500, an adhesive strip or some other type of closure mechanism may be disposed along the inner surface of the fourth section 630 such that fourth section 630 may then be folded downward along crease line 650 and attached to the outer surface of the third section 620.

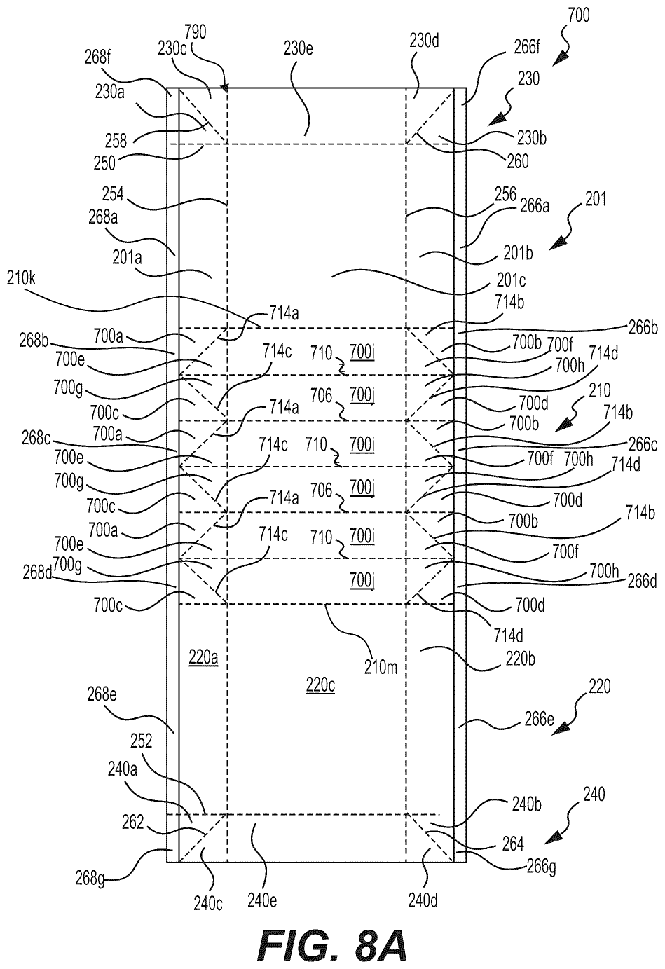

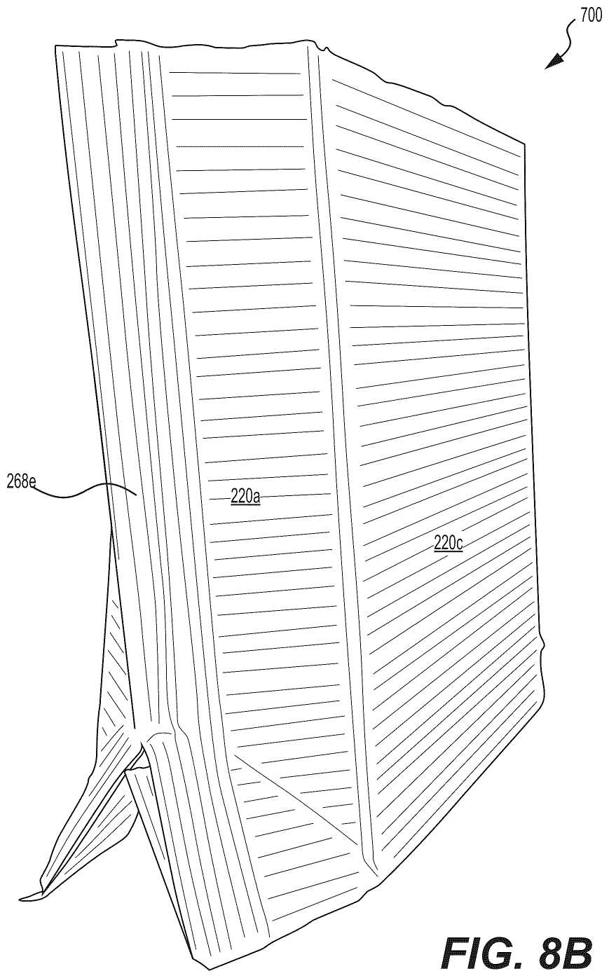

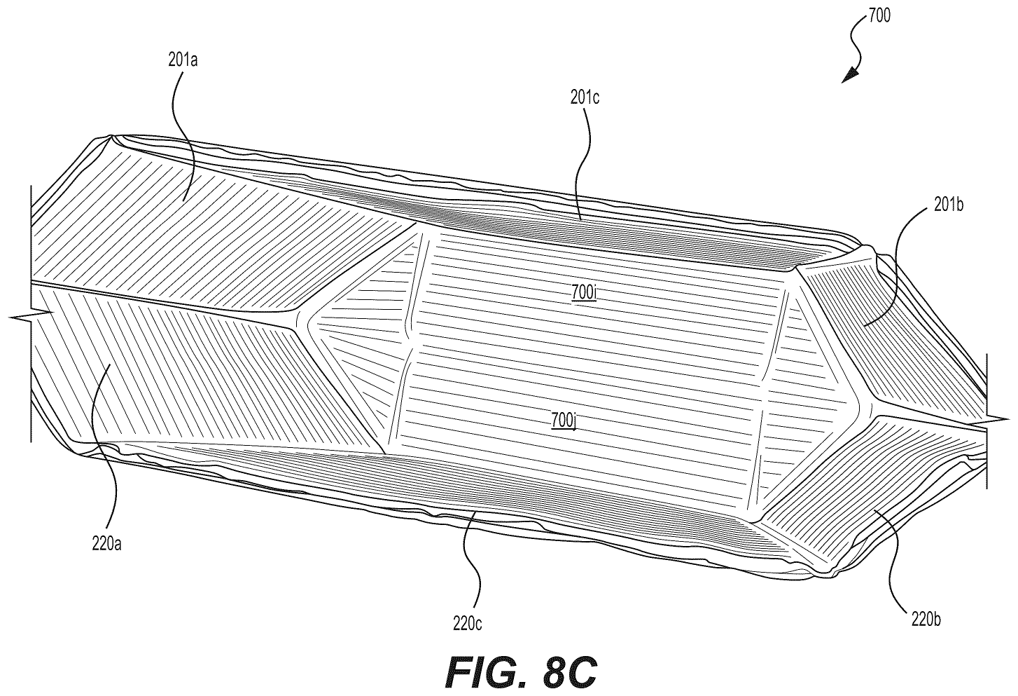

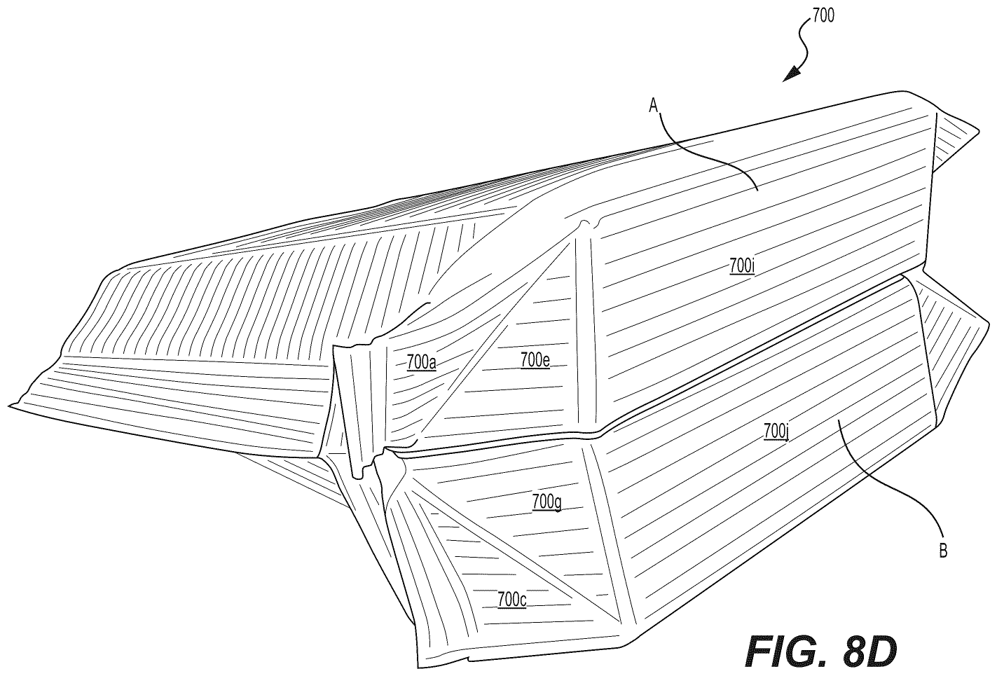

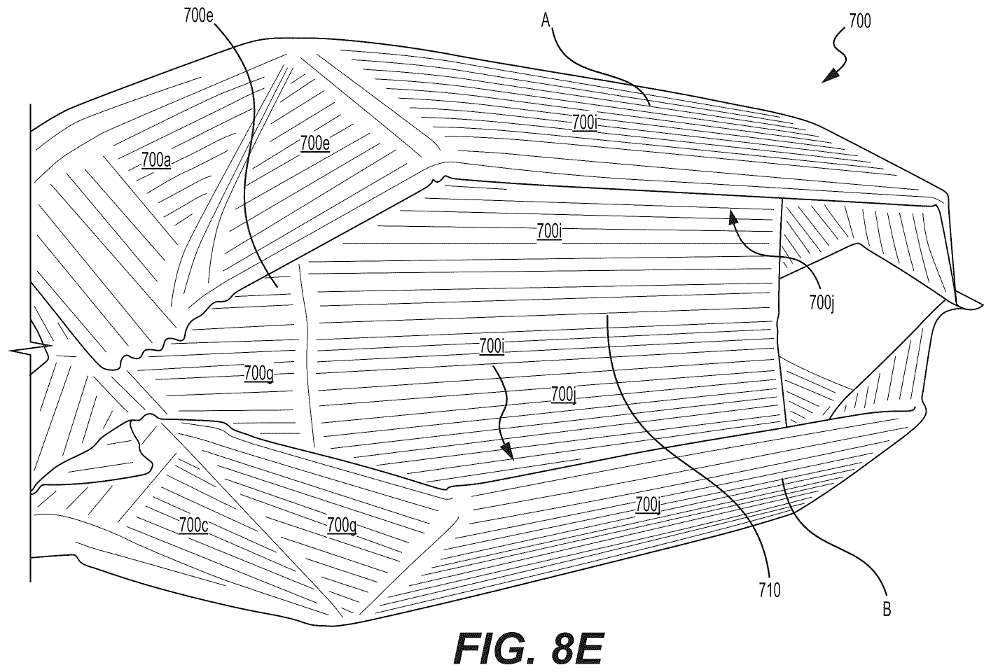

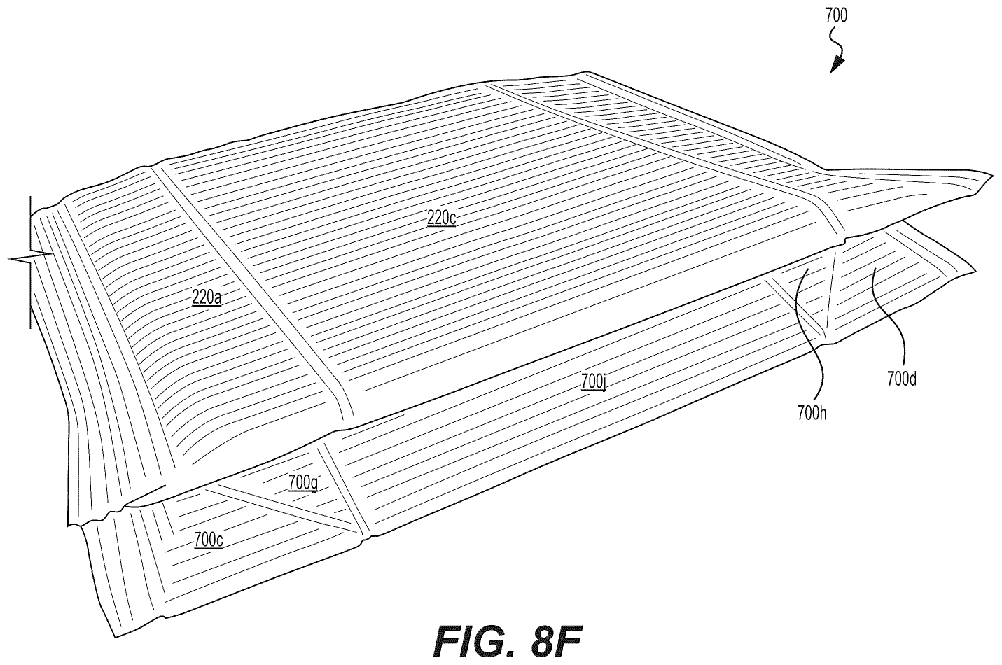

FIGS. 8A-8F show various perspectives and aspects of another insulated bag 700 that may include insulating substrate 100 and is configured to expand and collapse flat. As shown in FIG. 8A, the insulating substrate 100 may include one or more of the sections, portions, and crease lines as discussed above with respect to FIGS. 3A, 4A, and 5A, except that insulating substrate 100 may include additional portions and crease lines within second section 210. That is, insulated bag 700 may provide a “triple-bottomed” bag in that the second section 210 includes three sections that are each configured the same or similarly to second section 210 of, for example, FIG. 3A. In each of these three sections, insulating substrate 100 may include four outer angular portions 700a, 700b, 700c, 700d; four inner angular portions 700e, 700f, 700g, 700h; and two middle portions 700i and 700j. In each of these three sections, insulating substrate 100 may include a crease line 714a that separates outer angular portion 700a from inner angular portion 700e at an oblique angle; a crease line 714b that separates outer angular portion 700b from inner angular portion 700f at an oblique angle; a crease line 714c that separates outer angular portion 700c from inner angular portion 700g at an oblique angle; and a crease line 714d that separates outer angular portion 700d from inner angular portion 700h at an oblique angle. In each of these three sections, insulating substrate 100 may include a crease line 710 that horizontally separates (i) middle portion 700i from 700j, (ii) inner angular portion 700e from inner angular portion 700g, and (iii) inner angular portion 700f from inner angular portion 700h. Second section 210 may also include crease lines 706 that horizontally separate each of the three sections from one another. In some embodiments, the three sections may be of equivalent or approximately equivalent size, as illustrated in FIG. 8A. Insulated bag 700 may include an insulating substrate 100 with a sixth crease pattern 790 corresponding to crease lines 210k, 210m, 250, 252, 254, 256, 258, 260, 262, 264, 706, 710, 714a-d. The one or more crease lines may be formed via heat, pressure, or both as described below.

The first section 201 may include a first edge 268a and a second edge 266a, the second section 210 may include a third edge 268b and a fourth edge 266b in its first or upper section, a fifth edge 268c and a sixth edge 266c in its second or middle section, and a seventh edge 268d and an eighth edge 266d in its third or lower section. The third section 220 may include a ninth edge 268e and a tenth edge 266e, the fourth section 230 may include an eleventh edge 268f and a twelfth edge 266f, and the fifth section 240 may include a thirteenth edge 268g and a fourteenth edge 266g.

As particularly shown in FIG. 8E, insulated bag 700 can be formed and expanded by first folding the insulating substrate along inner-most crease line 710, e.g., the crease line 710 closest to the middle of insulating substrate 100 in the X-direction. This allows the middle of the three sections of second section 210 to create an inner bottom layer of the insulated bag 700 (FIG. 8C). The other two sections of the three sections (e.g., the top and bottom sections) can then be folded along their respective crease lines 710 to create bottom flaps A and B (FIG. 8E) that can then be folded inward to create an outer bottom layer of the insulated bag 700 (FIG. 8D).

Portions (e.g., upper portions) of the first edge 268a and the second edge 266a of the first section 201 may be respectively attached to portions (e.g., upper portions) of the ninth edge 268e and the tenth edge 266e of the third section 220. In addition, portions (e.g., lower portions) of the first edge 268a and the second edge 266a may be respectively attached to portions of the fifth edge 268c and the sixth edge 266c of the middle section within second section 210. Additionally, portions (e.g., lower portions) of the ninth edge 268e and the tenth edge 266e may be respectively attached to portions of the fifth edge 268c and the sixth edge 266c of the middle section within second section 210. As particularly shown in FIG. 8E, to create the extra bottom layer of the insulated bag 700, as discussed above, third edge 268b, fourth edge 266b, seventh edge 268d, and eighth edge 266d may be respectively attached to themselves. Further, eleventh edge 268f and twelfth edge 266f may be respectively attached to thirteenth edge 268g and fourteenth edge 266g. The aforementioned edges may be heat-sealed to one another by activating a polymer coating on the first and/or second layer 102a, 102b.

As particularly shown in FIG. 8F, insulated bag 700 may be collapsed by pushing upward on both the inner and outer bottom layers such that they fold upward and internal to the insulated bag 700 along inner- or middle-most crease line 710. It should be understood that insulated bag 700 may be closed in the same or similar a fashion as the other insulated bags disclosed herein, such as insulated bag 200, 300, or 400. For example, the insulating substrate used to form insulated bag 700 could be modified to incorporate one or more different and/or additional sections, portions, and/or crease lines such that the insulated bag 700 can be closed in one or more different ways while maintaining the “triple-bottomed” features discussed above.

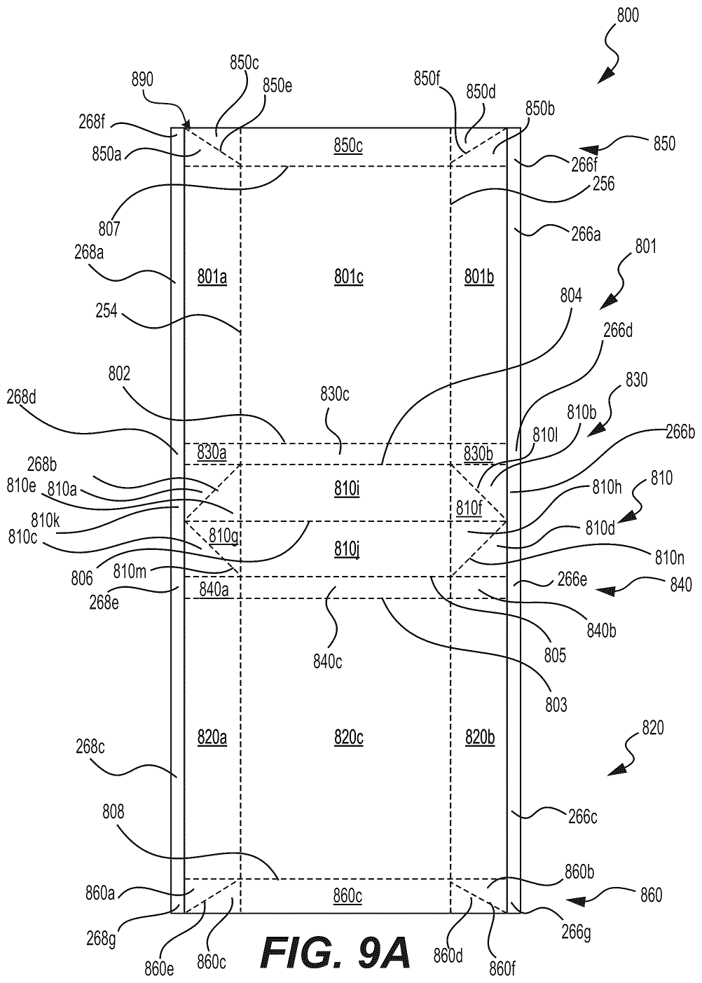

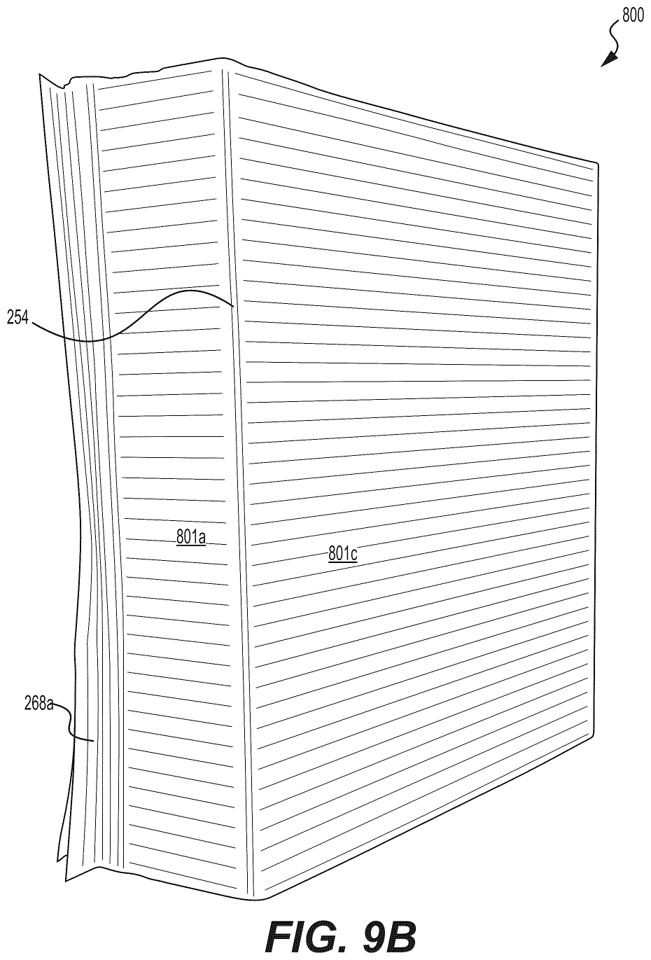

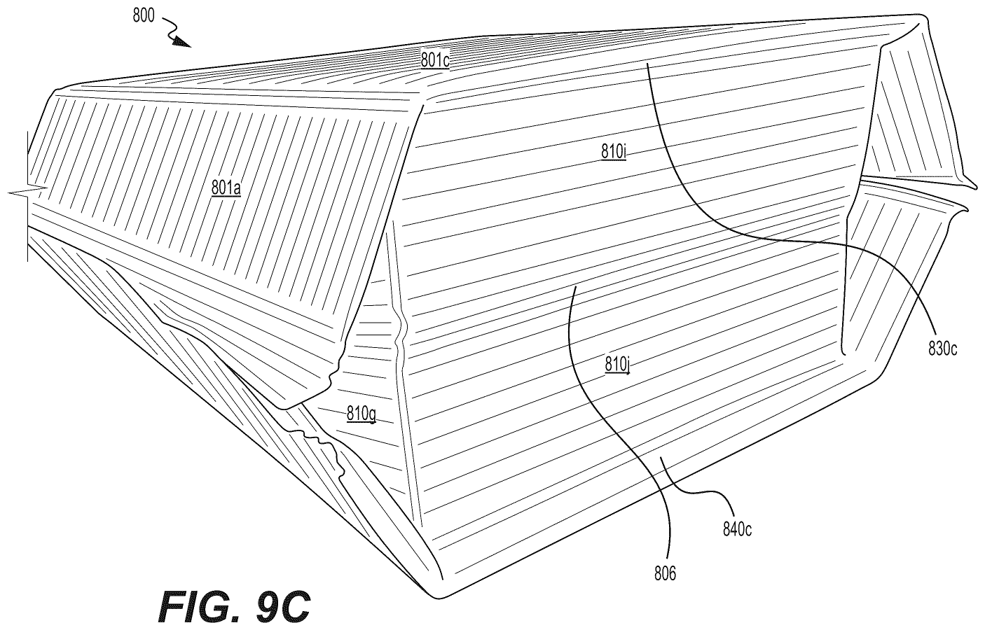

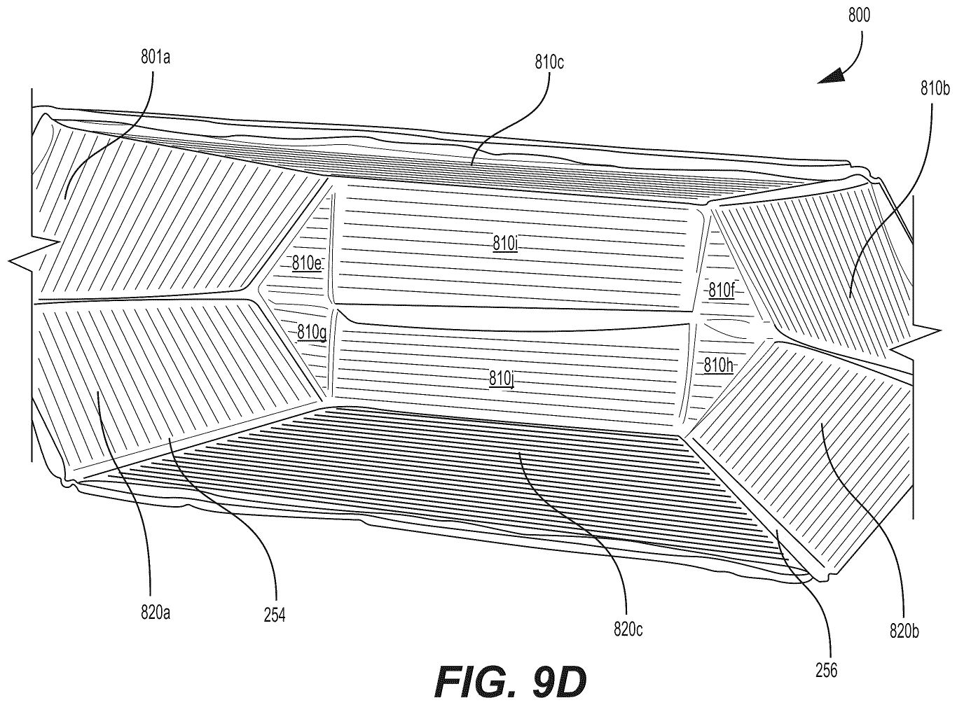

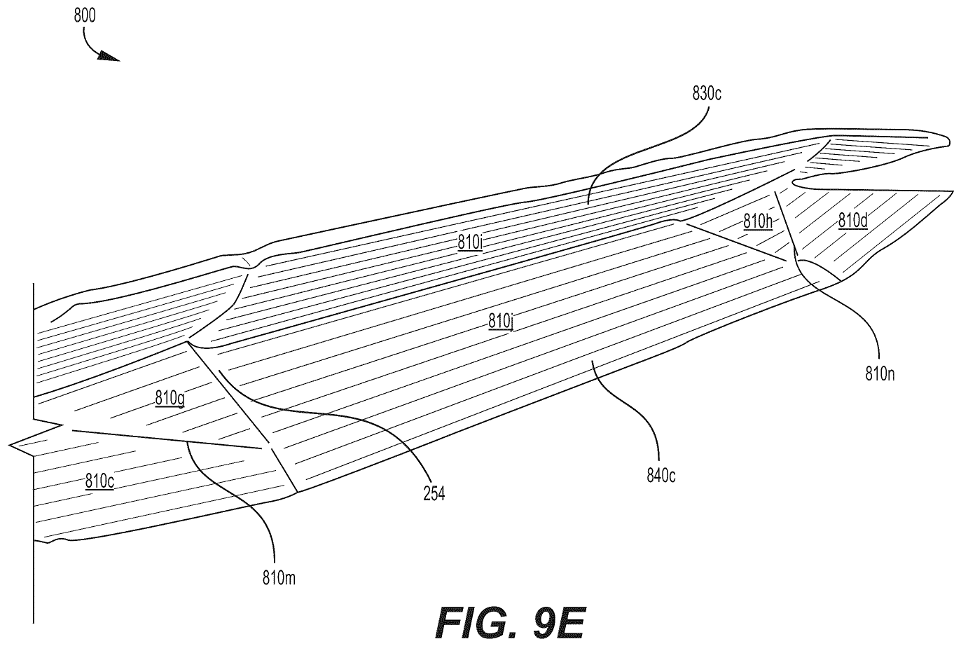

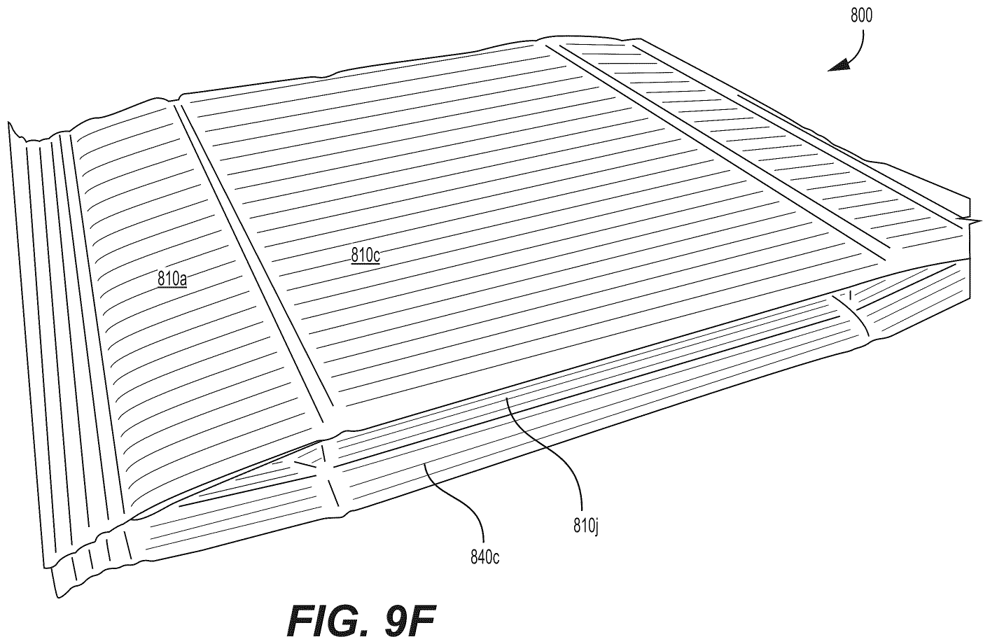

FIGS. 9A-9F show various perspectives and aspects of another insulated bag 800 that may include insulating substrate 100 and is configured to expand and collapse flat. In such embodiment, insulating substrate 100 may include a first section 801, second section 810, third section 820, fourth section 830, and fourth section 840. First section 801 may include outer portions 801a, 801b, and a middle portion 801c. Second section 810 may include outer angular portions 810a, 810b, 810c, and 810d; inner angular portions 810e, 810f, 810g, and 810h; and middle portions 810i and 810j. Third section 820 may include outer portions 820a, 820b, and middle portion 820c. Fourth section 830 may include outer portions 830a, 830b, and middle portion 830c. Fifth section 840 may include outer portions 840a, 840b, and middle portion 820c. In some embodiments, as particularly shown in FIG. 9A, first and third sections 801, 820 may be of a height (in the X-direction) that is longer than the respective heights of fourth and fifth sections 830, 840. In some embodiments, insulating substrate 100 may further include a sixth section 850, including outer angular portions 850a, 850b, inner angular portions 850c, 850d, and middle portion 850c. In some embodiments, insulating substrate 100 may further include a seventh section 860, including outer angular portions 860a, 860b, inner angular portions 860c, 860d, and middle portion 860c.

The first section 801 may include a first edge 268a and a second edge 266a, the second section 810 may include a third edge 268b and a fourth edge 266b, the third section 820 may include a fifth edge 268c and a sixth edge 266c, the fourth section 830 may include a seventh edge 268d and an eighth edge 266d, the fifth section 840 may include a ninth edge 268e and a tenth edge 266e, the sixth section 850 may include an eleventh edge 268f and a twelfth edge 266f, and the seventh section 860 may include a thirteenth edge 268g and a fourteenth edge 266g.

Insulating substrate 100 may include a crease line 802 that horizontally separates the first section 801 from the fourth section 830, a crease line 803 that horizontally separates the third section 820 from the fifth section 840, a crease line 804 that horizontally separates the second section 810 from the fourth section 830, and a crease line 805 that horizontally separates the second section 810 from the fifth section 840. Insulating substrate 100 may include a crease line 254 that vertically separates (i) middle portion 801c from outer portion 801a of first section 801, (ii) middle portion 810i from inner angular portion 810e of second section 810, (iii) middle portion 810j from inner angular portion 810g of second section 810, (iv) middle portion 820c from outer portion 820a of third section 820, (v) middle portion 830c from outer portion 830a of fourth section 830, and (vi) middle portion 840c from outer portion 840a of fifth section 840. Crease line 254 may further vertically separate outer portion 850a from middle portion 850c of sixth section 850, and outer portion 860a from middle portion 860c of seventh section 860. Insulating substrate 100 may include a crease line 256 that vertically separates (i) middle portion 801c from outer portion 801b of first section 801, (ii) middle portion 810i from inner angular portion 810f of second section 810, (iii) middle portion 810j from inner angular portion 810h of second section 810, (iv) middle portion 820c from outer portion 820b of third section 820, (v) middle portion 830c from outer portion 830b of fourth section 830, and (vi) middle portion 840c from outer portion 840b of fifth section 840. Crease line 256 may further vertically separate outer portion 850b from middle portion 850c of sixth section 850, and outer portion 860b from middle portion 860c of seventh section 860. Insulating substrate 100 may include a crease line 806 that horizontally separates (i) middle portion 810i from middle portion 810j of second section 810, (ii) inner angular portion 810e from inner angular portion 810g, and (iii) inner angular portion 810f from inner angular portion 810h. In some embodiments, insulating substrate 100 may include a crease line 807 that horizontally separates the first section 801 from the sixth section 850, and a crease line 808 that horizontally separates the third section 820 from the seventh section 860. In some embodiments, sixth section 850 may include a crease line 850e that separates outer angular portion 850a from inner angular portion 850c at an oblique angle, and a crease line 850f that separates outer angular portion 850b from inner angular portion 850d at an oblique angle. In some embodiments, seventh section 860 may include a crease line 860e that separates outer angular portion 860a from inner angular portion 860c at an oblique angle, and a crease line 860f that separates outer angular portion 860b from inner angular portion 860d at an oblique angle. Insulated bag 800 may include an insulating substrate 100 with a seventh crease pattern 890 corresponding to crease lines 254, 256, 802, 803, 804, 805, 806, 807, 810k, 810l, 810m, 810n, 850e, 850f. The one or more crease lines may be formed via heat, pressure, or both as described below.

As particularly shown in FIG. 9C, insulated bag 800 may be formed and expanded by folding insulating substrate 100 along crease lines 802, 804, 805, and 803 such that middle portions 810i and 810j can become the bottom flat panel of insulated bag 800, and fourth and fifth sections 830, 840 can slightly extend beyond this bottom flat panel to create a lip around the base of the insulated bag 800. This lip helps to create a raised-bottom feature of insulated bag 800 whereby the bottom flat panel including middle portions 810i and 810j does not sit directly on whatever surface insulated bag 800 is placed (e.g., the ground, a table, etc.). This helps to protect the contents within insulated bag 800 (e.g., food products) from being damaged, or from absorbing excess heat from the surface causing the contents to potentially spoil.

Portions (e.g., upper portions) of the first edge 268a and the second edge 266a of the first section 801 may be respectively attached to portions (e.g., upper portions) of the fifth edge 268c and the sixth edge 266c of the third section 820. In addition, portions (e.g., lower portions) of the first edge 268a and the second edge 266a may be respectively attached to portions of the third edge 268b and the fourth edge 266b of the second section 810, as well as portions of the seventh edge 268d and eighth edge 266d of the fourth section 830. Additionally, portions (e.g., lower portions) of the fifth edge 268c and the sixth edge 266c may be respectively attached to portions of the third edge 268b and fourth edge 266b of the second section 210, as well as portions of the ninth edge 268e and tenth edge 266e of the fifth section 840. Further, portions of the eleventh edge 268f and twelfth edge 266f may be respectively attached to portions of the thirteenth edge 268g and fourteenth edge 266g. The aforementioned edges may be heat-sealed to one another by activating a polymer coating on the first and/or second layer 102a, 102b.

Insulated bag 800 may otherwise be formed and expanded, or collapsed, in the same or similar a fashion as other insulated bags disclosed herein, such as insulated bag 200.

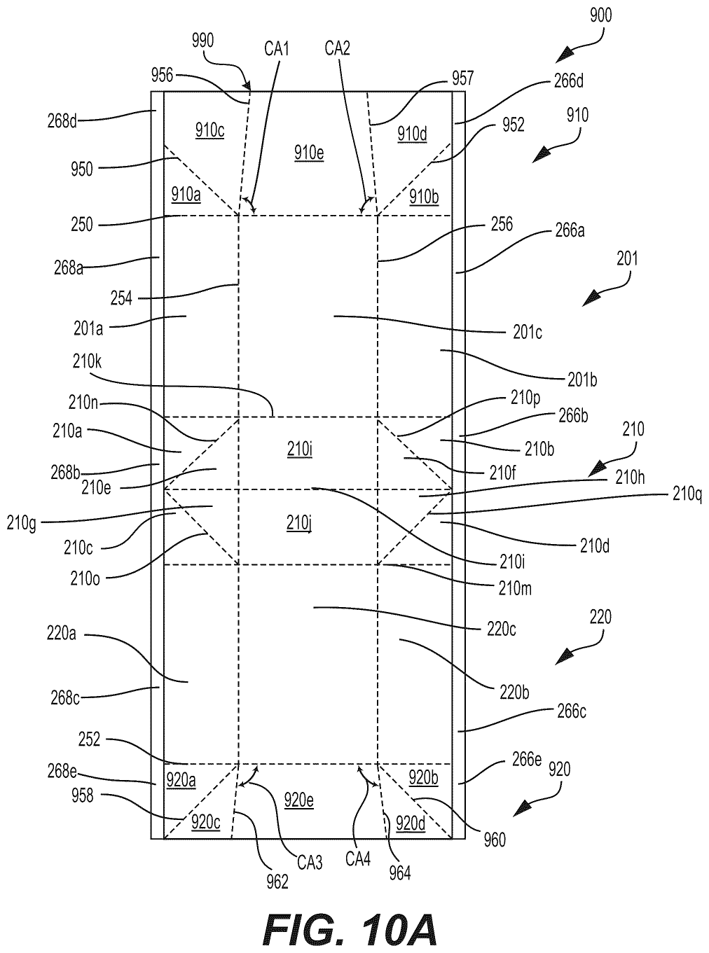

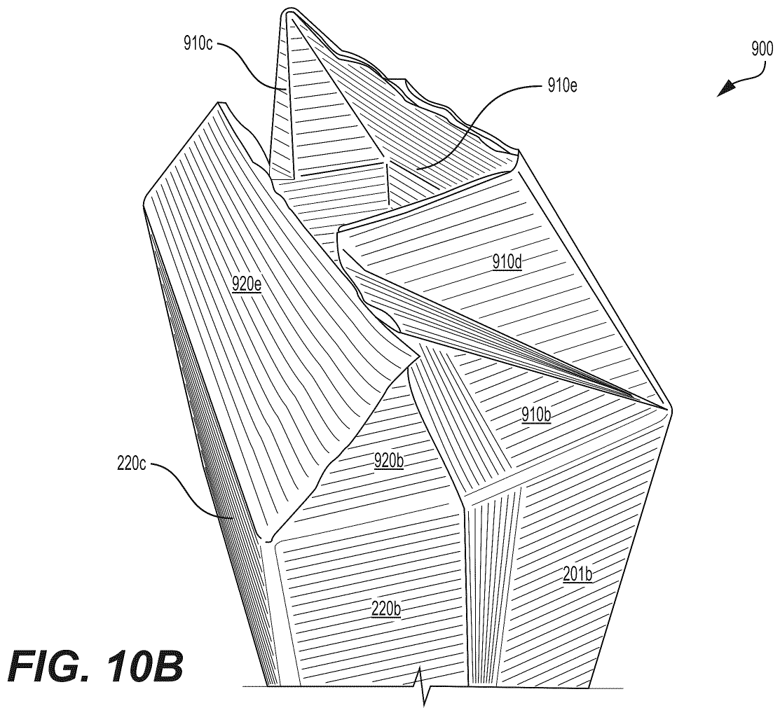

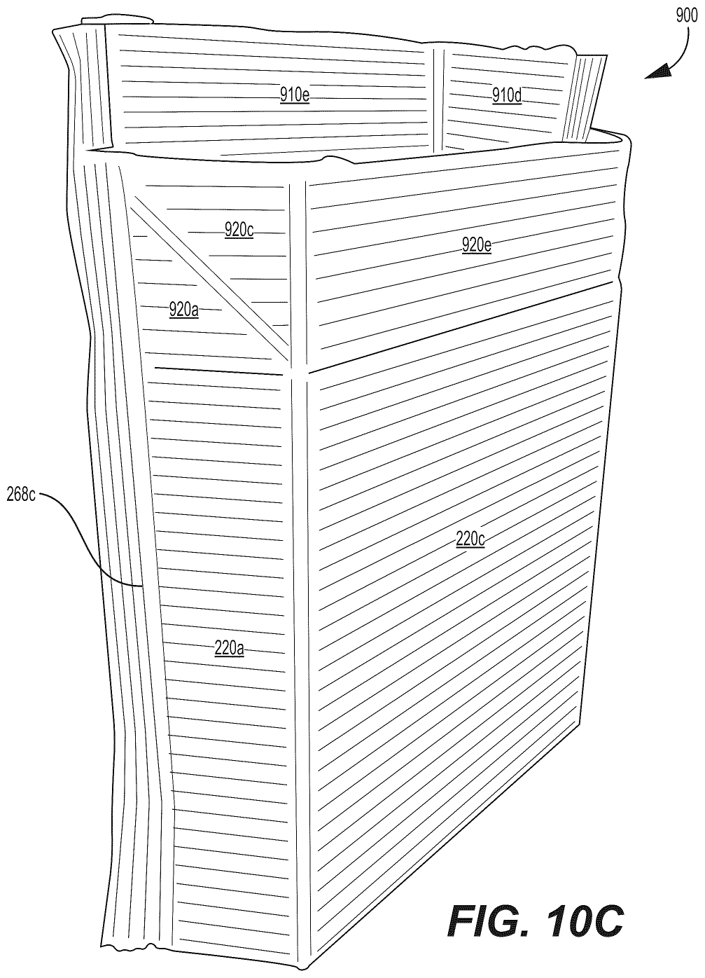

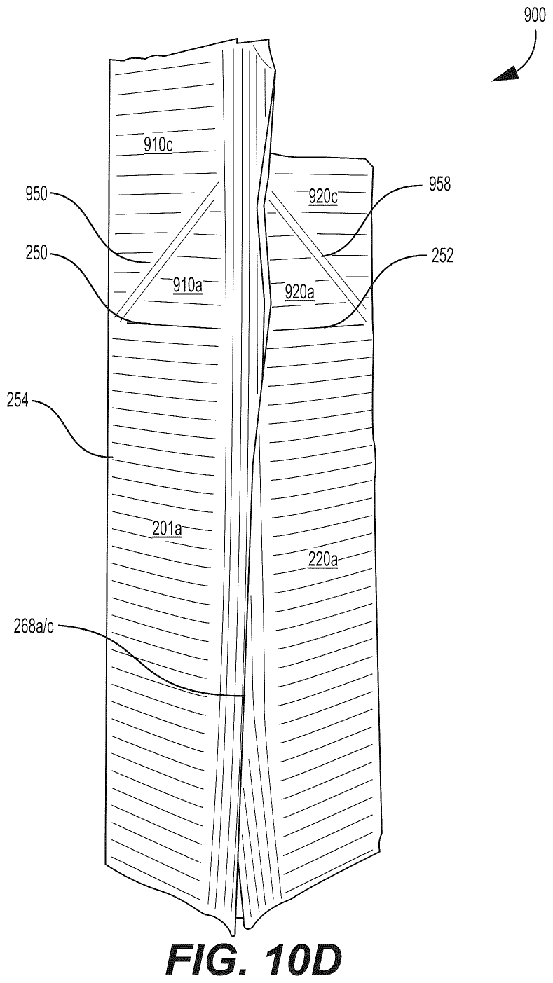

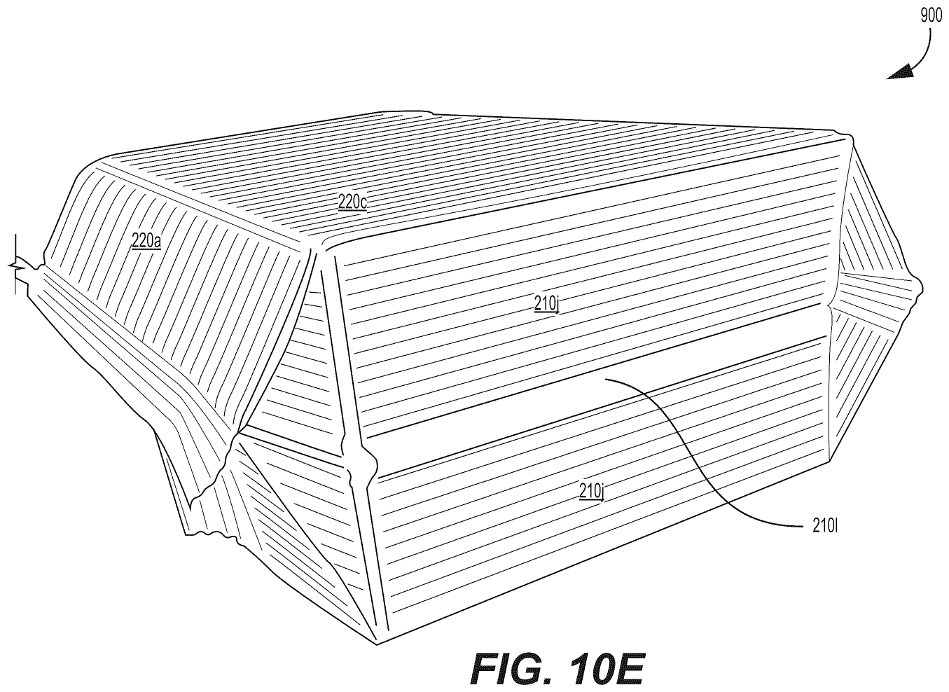

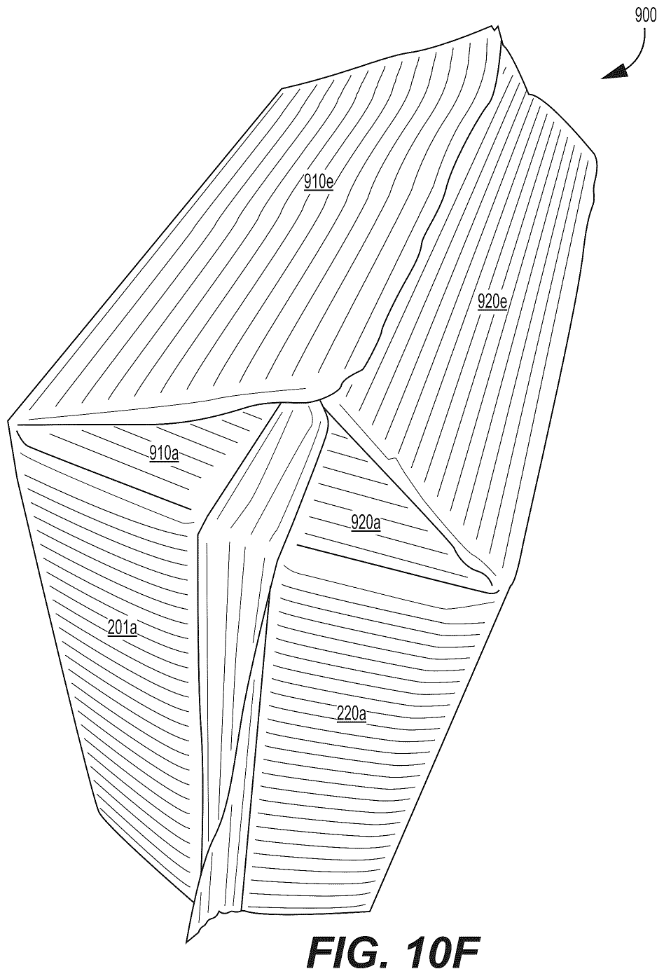

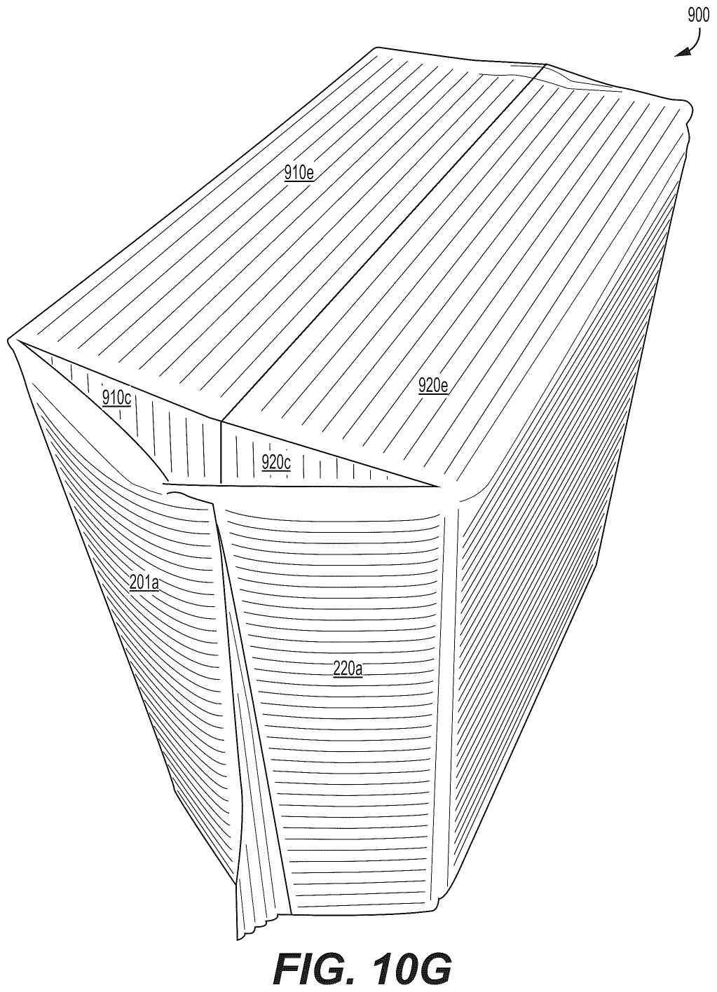

FIGS. 10A-10G show various perspectives and aspects of another insulated bag 900 that may include insulating substrate 100 and is configured to expand and collapse flat. As shown in FIG. 10A, the insulating substrate 100 may include one or more of the sections, portions, crease lines, and edges as discussed above with respect to FIG. 3A. In addition, insulating substrate 100 may include a fourth section 910 and a fifth section 920. Fourth section 910 may include outer angular portions 910a, 910b; inner angular portions 910c, 910d, a middle portion 910e, and edges 268d, 266d. Fourth section 910 may also include a crease line 950 that separates outer angular portion 910a from inner angular portion 910c at an oblique angle; and a crease line 952 that separates outer angular portion 910b from inner angular portion 910d at an oblique angle. Fourth section 910 may also include a crease line 956 that separates inner angular portion 910c from middle portion 910e at an oblique angle (e.g., an acute angle), and a crease line 957 that separates inner angular portion 910d from middle portion 910e at an oblique angle (e.g., an acute angle). Fifth section 920 may include outer angular portions 920a, 920b; inner angular portions 920c, 920d, a middle portion 920e, and edges 268e, 266e. Fifth section 920 may also include a crease line 958 that separates outer angular portion 920a from inner angular portion 920c at an oblique angle; and a crease line 960 that separates outer angular portion 920b from inner angular portion 920d at an oblique angle. Fifth section 920 may also include a crease line 962 that separates inner angular portion 920c from middle portion 920e at an oblique angle (e.g., an obtuse angle), and a crease line 964 that separates inner angular portion 920d from middle portion 920e at an oblique angle (e.g., an obtuse angle). Insulated bag 900 may include an insulating substrate 100 with an eighth crease pattern 990 corresponding to crease lines 210i, 210k, 210m, 210n, 210o, 210p, 210q, 250, 252, 254, 256, 950, 952, 956, 957, 958, 960, 962, 964. The one or more crease lines may be formed via heat, pressure, or both as described below.

Insulated bag 900 may be expanded and collapsed using the same or similar methods as with other insulated bags disclosed herein, such as insulated bag 200. However, as particularly shown in FIGS. 10B and 10F, insulated bag 900 may be closed in a different fashion given the different angles of the crease lines 956, 957, 962, and 946. That is, given that crease lines 956 and 957 form acute angles with respect to horizontal crease line 250, and crease lines 962 and 964 form obtuse angles with respect to horizontal crease line 252, when the insulated bag 900 is formed and ready to be closed, the middle portion 910e can be slid into and underneath middle portion 920e to create an overall flat top (FIG. 10G). Additionally, as particularly shown in FIGS. 10C and 10D, fourth section 910 may be longer in the X-direction than is fifth section 920, which makes it easier to tuck middle portion 910e underneath middle portion 920e when closing the insulated bag 900.

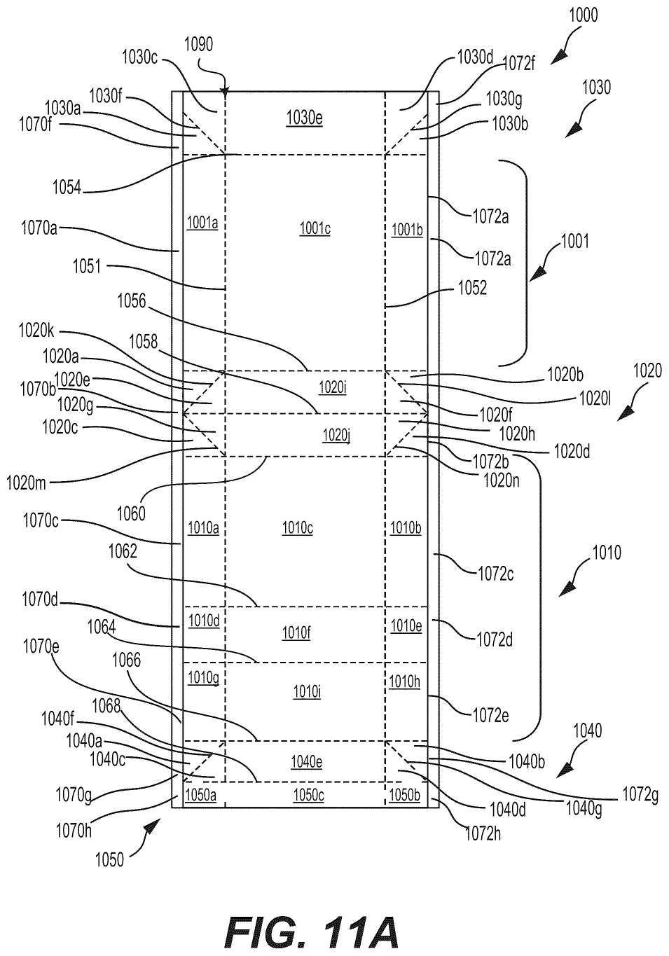

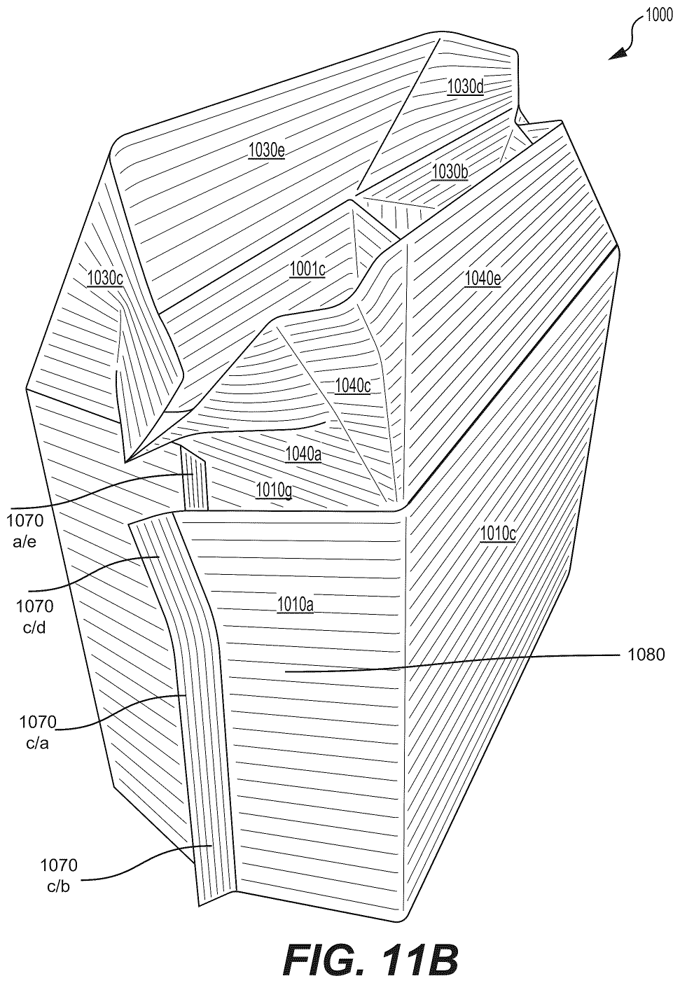

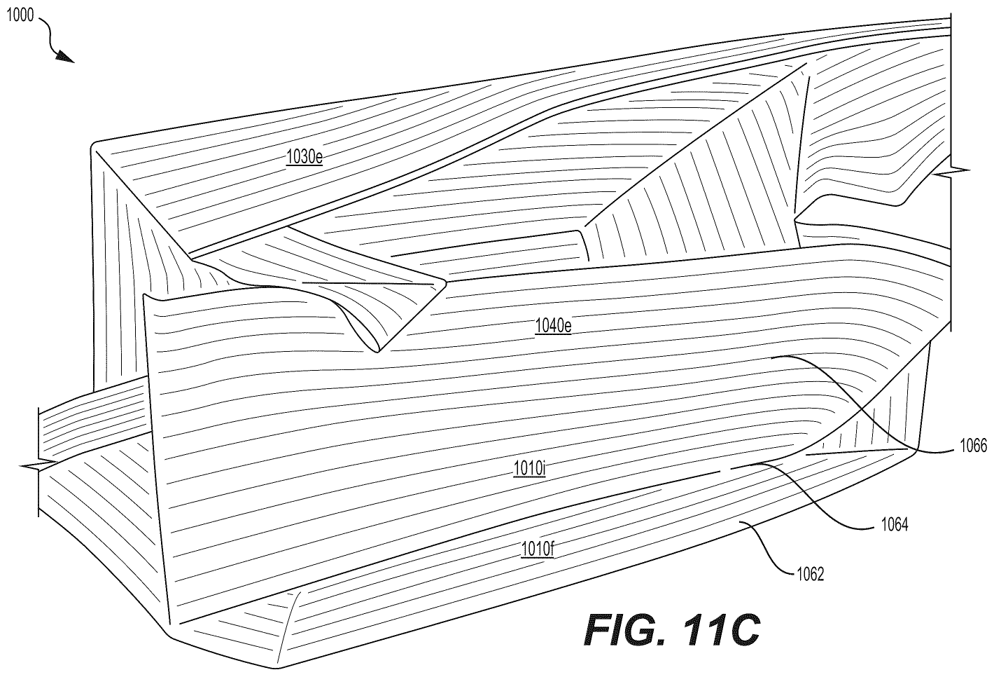

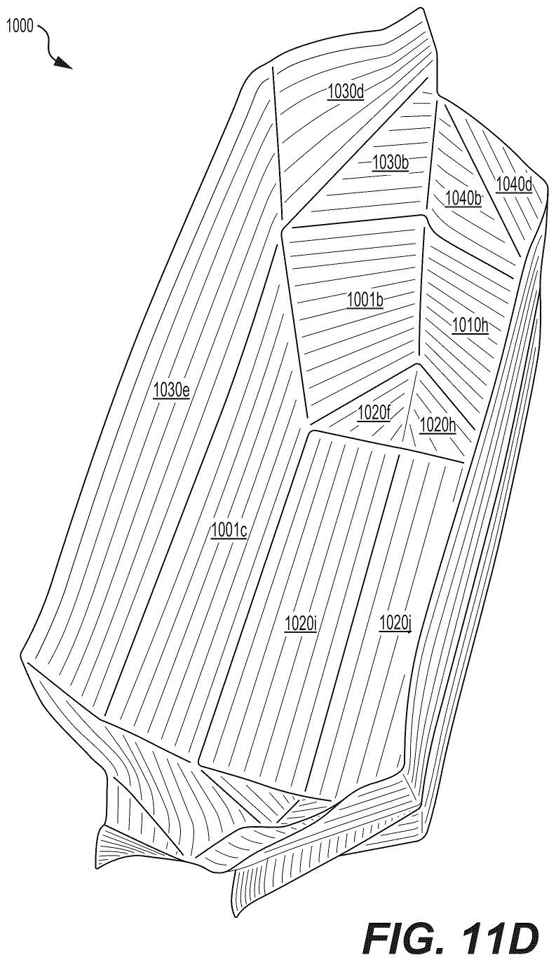

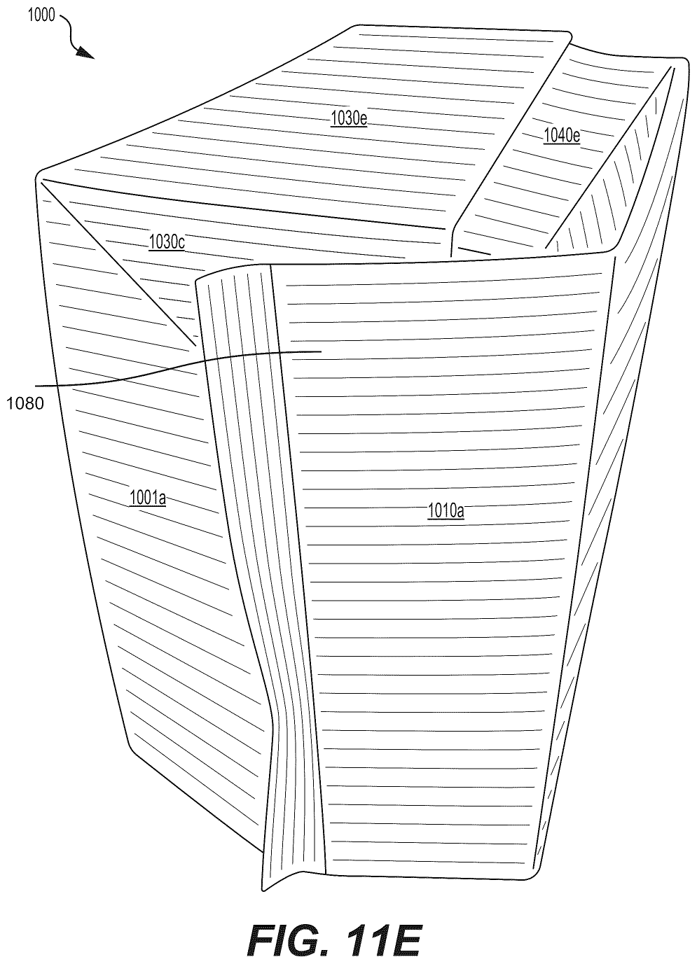

FIGS. 11A-11E show various perspectives and aspects of another insulated bag 1000 that may include insulating substrate 100 and is configured to expand and collapse flat. As shown in FIG. 11A, the insulating substrate 100 may include a first section 1001, a second section 1020, a third section 1010, a fourth section 1030, a fifth section 1040, and a sixth section 1050. The first section 1001 may include outer portions 1001a, 1001b, and middle portion 1001c. The second section 1020 may include outer angular portions 1020a, 1020b, 1020c, and 1020d; inner angular portions 1020e, 1020f, 1020g, and 1020h; and middle portions 1020i and 1020j. The third section 1010 may include three portions, where each portion may be of a different height (in the X-direction). As illustrated in FIG. 11A, a first portion may include outer portions 1010a, 1010b, and middle portion 1010c; a second portion may include outer portions 1010d, 1010e, and middle portion 1010f; and a third portion may include outer portions 1010g, 1010h, and middle portion 1010i. The fourth section 1030 may include outer angular portions 1030a, 1030b; inner angular portions 1030c, 1030d; and middle portion 1030e. The fifth section 1040 may include outer angular portions 1040a, 1040b; inner angular portions 1040c, 1040d; and middle portion 1040e. The sixth section 1050 may include outer portions 1050a, 1050b, and middle portion 1050c.

The insulating substrate 100 may include a crease line 1051 that vertically separates (i) the outer portion 1001a from the middle portion 1001c of the first section 1001, (ii) the inner angular portion 1020e from the middle portion 1020i of the second section 1020, (iii) the inner angular portion 1020g from the middle portion 1020j of the second section 1020, (iv) the outer portion 1010a from the middle portion 1010c, (v) the outer portion 1010d from the middle portion 1010f, (vi) the outer portion 1010g from the middle portion 1010i, (vii) the inner angular portion 1030c from the middle portion 1030e, (viii) the inner angular portion 1040c from the middle portion 1040e, and (ix) the outer portion 1050a from the middle portion 1050c. The insulating substrate 100 may include a crease line 1052 that vertically separates (i) the outer portion 1001b from the middle portion 1001c of the first section 1001, (ii) the inner angular portion 1020f from the middle portion 1020i of the second section 1020, (iii) the inner angular portion 1020h from the middle portion 1020j of the second section 1020, (iv) the outer portion 1010b from the middle portion 1010c, (v) the outer portion 1010e from the middle portion 1010f, (vi) the outer portion 1010h from the middle portion 1010i, (vii) the inner angular portion 1030d from the middle portion 1030e, (viii) the inner angular portion 1040d from the middle portion 1040e, and (ix) the outer portion 1050b from the middle portion 1050c.

The insulating substrate 100 may include a crease line 1054 that horizontally separates the first section 1001 from the fourth section 1030; a crease line 1056 that horizontally separates the first section 1001 from the second section 1020; a crease line 1060 that horizontally separates the second section 1020 from the third section 1010; a crease line 1066 that horizontally separates the third section 1010 from the fifth section 1040; and a crease line 1068 that horizontally separates the fifth section 1040 from the sixth section 1050.

The second section 1020 of the insulating substrate 100 may include a crease line 1058 that horizontally separates (i) the middle portion 1020i from the middle portion 1020j, (ii) the inner angular portion 1020e from the inner angular portion 1020g, and (iii) the inner angular portion 1020f from the inner angular portion 1020h. The second section 1020 may further include a crease line 1020k that separates the inner angular portion 1020e from the outer angular portion 1020a at an oblique angle; a crease line 1020m that separates the inner angular portion 1020g from the outer angular portion 1020c at an oblique angle; a crease line 1020l that separates the inner angular portion 1020f from the outer angular portion 1020b at an oblique angle; and a crease line 1020n that separates the inner angular portion 1020h from the outer angular portion 1020d at an oblique angle.

The fourth section 1030 may include a crease line 1030f that separates the inner angular portion 1030c from the outer angular portion 1030a at an oblique angle, and a crease line 1030g that separates the inner angular portion 1030d from the outer angular portion 1030b at an oblique angle.

The fifth section 1040 may include a crease line 1040f that separates the inner angular portion 1040c from the outer angular portion 1040a at an oblique angle, and a crease line 1040g that separates the inner angular portion 1040d from the outer angular portion 1040b at an oblique angle.

The first section 1001 may include a first edge 1070a and a second edge 1072a, the second section 1020 may include a third edge 1070b and a fourth edge 1072b, the third section 1010 may include a fifth edge 1070c, a sixth edge 1072c, a seventh edge 1070d, an eighth edge 1072d, a ninth edge 1070e, and a tenth edge 1072e. The fourth section 1030 may include an eleventh edge 1070f and a twelfth edge 1072f, the fifth section 1040 may include a thirteenth edge 1070g and a fourteenth edge 1072g, and the sixth section 1050 may include a fifteenth edge 1070h and a sixteenth edge 1072h.

Insulated bag 1000 may include an insulating substrate 100 with a ninth crease pattern 1090 corresponding to crease lines 1020k, 1020l, 1020m, 1020n, 1030f, 1030g, 1051, 1052, 1054, 1056, 1060, 1062, 1064, 1068, 1030f, 1030g, 1040f, 1040g, The one or more crease lines may be formed via heat, pressure, or both as described below.

As particularly shown in FIG. 11D, insulated bag 1000 can be formed by folding crease lines 1056 and 1060 such that middle portions 1020i and 1020j of the second section form the bottom-most panel of the expanded insulated bag 1000. A main difference between insulated bag 1000 and others disclosed herein is that insulated bag 1000 can be formed to have side flaps 1080 (FIGS. 11B and 11E) into which outer angular portions 1030c and 1030d can be tucked to close insulated bag 1000 (FIG. 11E). To achieve this formation, portions (e.g., upper portions) of the first edge 1070a and the second edge 1072a of the first section 1001 may be respectively attached to the ninth edge 1070e and the tenth edge 1072e; seventh edge 1070d and eighth edge 1072d may be respectively attached to portions (e.g., upper portions) of fifth edge 1070c and sixth edge 1072c; and portions (e.g., middle portions) of fifth edge 1070c and sixth edge 1072c may be respectively attached to portions (e.g., middle portions) of first edge 1070a and second edge 1072a. In addition, portions (e.g., lower portions) of the first edge 1070a and the second edge 1072a may be respectively attached to portions of the third edge 1070b and the fourth edge 1072b of the second section 210. Additionally, portions (e.g., lower portions) of the fifth edge 1070c and the sixth edge 1072c may be respectively attached to portions of the third edge 1070b and fourth edge 1072b of the second section 1020. Further, portions of the eleventh edge 1070f and twelfth edge 1072f may be respectively attached to portions of the thirteenth edge 1070g and fourteenth edge 1072g. The aforementioned edges may be heat-sealed to one another by activating a polymer coating on the first and/or second layer 102a, 102b.

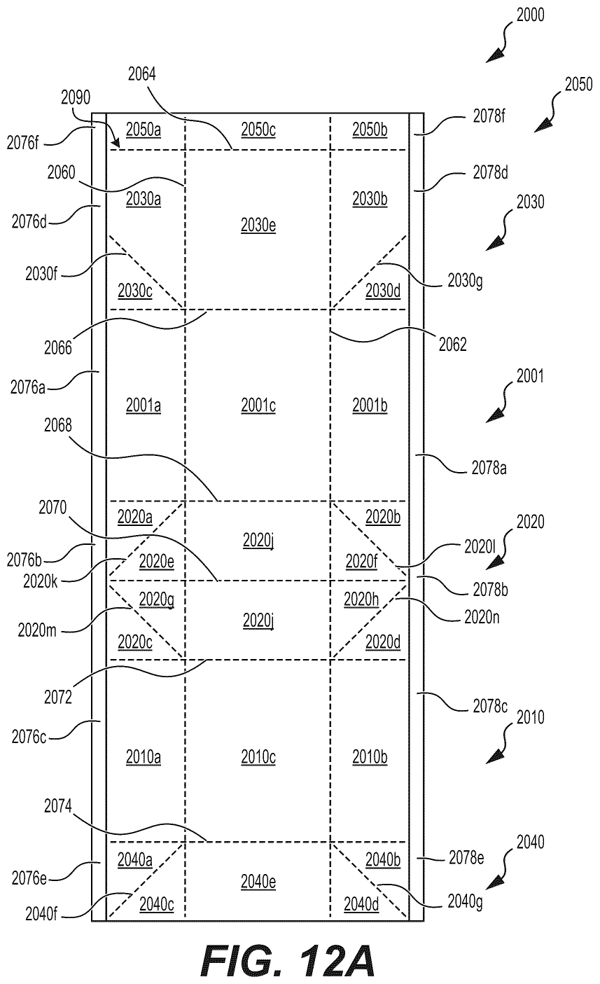

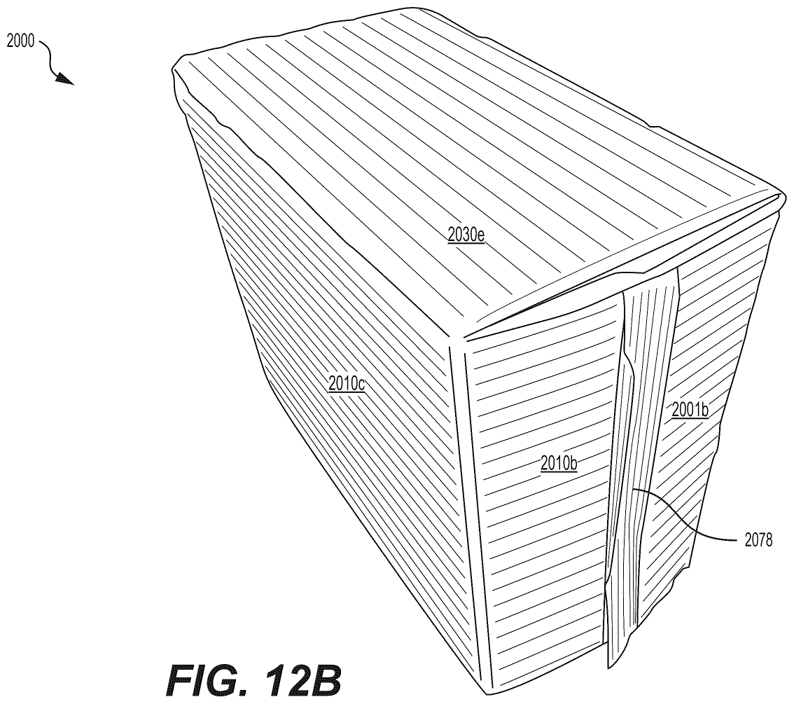

FIGS. 12A-12B show various perspectives and aspects of another insulated bag 2000 that may include insulating substrate 100 and is configured to expand and collapse flat. As shown in FIG. 12A, the insulating substrate 100 may include a first section 2001, a second section 2020, a third section 2010, a fourth section 2030, a fifth section 2040, and a sixth section 2050. The first section 2001 may include outer portions 2001a, 2001b, and middle portion 2001c. The second section 2020 may include outer angular portions 2020a, 2020b, 2020c, and 2020d; inner angular portions 2020e, 2020f, 2020g, and 2020h; and middle portions 2020i and 2020j. The third section 2010 may include outer portions 2010a, 2010b, and middle portion 2010c. The fourth section 2030 may include inner angular portions 2030a, 2030b; outer angular portions 2030c, 2030d; and middle portion 2030e. The fifth section 2040 may include outer angular portions 2040a, 2040b; inner angular portions 2040c, 2040d; and middle portion 2040e. The sixth section 2050 may include outer portions 2050a, 2050b, and middle portion 2050c.

The first section 2001 may include a first edge 2076a and a second edge 2078a, the second section 2020 may include a third edge 2076b and a fourth edge 2078b, the third section 2010 may include a fifth edge 2076c and a sixth edge 2078c, the fourth section 2030 may include a seventh edge 2076d and an eighth edge 2078d, the fifth section 2040 may include a ninth edge 2076e and a tenth edge 2078e, and the sixth section 2050 may include an eleventh edge 2076f and a twelfth edge 2078f.

The insulating substrate 100 may include a crease line 2060 that vertically separates (i) the outer portion 2001a from the middle portion 2001c of the first section 2001, (ii) the inner angular portion 2020e from the middle portion 2020i of the second section 2020, (iii) the inner angular portion 2020g from the middle portion 2020j of the second section 2020, (iv) the outer portion 2010a from the middle portion 2010c, (v) the inner angular portion 2030a from the middle portion 2030e, (vi) the inner angular portion 2040c from the middle portion 2040e, and (vii) the outer portion 2050a from the middle portion 2050c. The insulating substrate 100 may include a crease line 2062 that vertically separates (i) the outer portion 2001b from the middle portion 2001c of the first section 2001, (ii) the inner angular portion 2020f from the middle portion 2020i of the second section 2020, (iii) the inner angular portion 2020h from the middle portion 2020j of the second section 2020, (iv) the outer portion 2010b from the middle portion 2010c, (v) the inner angular portion 2030b from the middle portion 2030e, (vi) the inner angular portion 2040d from the middle portion 2040e, and (vii) the outer portion 2050b from the middle portion 2050c.

The insulating substrate 100 may include a crease line 2064 that horizontally separates the sixth section 2050 from the fourth section 2030; crease line 2066 that horizontally separates the first section 2001 from the fourth section 2030; a crease line 2068 that horizontally separates the first section 2001 from the second section 2020; a crease line 2072 that horizontally separates the second section 2020 from the third section 2010; and a crease line 2074 that horizontally separates the third section 2010 from the fifth section 2040.

The second section 2020 of the insulating substrate 100 may include a crease line 2070 that horizontally separates (i) the middle portion 2020i from the middle portion 2020j, (ii) the inner angular portion 2020e from the inner angular portion 2020g, and (iii) the inner angular portion 2020f from the inner angular portion 2020h. The second section 2020 may further include a crease line 2020k that separates the inner angular portion 2020e from the outer angular portion 2020a at an oblique angle; a crease line 2020m that separates the inner angular portion 2020g from the outer angular portion 2020c at an oblique angle; a crease line 2020l that separates the inner angular portion 2020f from the outer angular portion 2020b at an oblique angle; and a crease line 2020n that separates the inner angular portion 2020h from the outer angular portion 2020d at an oblique angle.

The fourth section 2030 may include a crease line 2030f that separates the outer angular portion 2030c from the inner angular portion 2030a at an oblique angle, and a crease line 2030g that separates the outer angular portion 2030d from the inner angular portion 2030b at an oblique angle. As shown in FIG. 12A, crease lines 2030f and 2030g may respectively extend only part of the way up along edges 2076d and 2078d such that outer angular portion 2030c and inner angular portion 2030a both share at least one side with edge 2076d, and outer angular portion 2030d and inner angular portion 2030b both share at least one side with edge 2078d. This crease line formation aids in creating a wider middle portion 2030e and inner angular portions 2030a, 2030b respectively compared to middle portion 2040e and inner angular portions 2040c, 2040d such that middle portion 2030e can be used as the entire top surface of the insulated bag 2000 once fully formed, as particularly shown in FIG. 12B and discussed further below.

The fifth section 2040 may include a crease line 2040f that separates the inner angular portion 2040c from the outer angular portion 2040a at an oblique angle, and a crease line 2040g that separates the inner angular portion 2040d from the outer angular portion 2040b at an oblique angle.

Insulated bag 2000 may include an insulating substrate 100 with a ninth crease pattern 2090 corresponding to crease lines 2020k, 2020l, 2020m, 2020n, 2030f, 2030g, 2040f, 2040g, 2060, 2062, 2064, 2066, 2068, 2070, 2072, 2074. The one or more crease lines may be formed via heat, pressure, or both as described below.

Insulated bag 2000 can be formed by folding crease lines 2068 and 2072 such that middle portions 2020i and 2020j of the second section 2020 form the bottom-most panel of the expanded insulated bag 2000. A main difference between insulated bag 2000 and other insulated bags disclosed herein is that insulating substrate 100 may have a winder middle portion 2030e that forms the entire top panel of insulated bag 2000, as particularly shown in FIG. 12B. Sixth section 2050 of insulating substrate 100 can be included such that it can be folded down and adhered to the outer surface of the fifth section 2040 to close the insulated bag 2000.

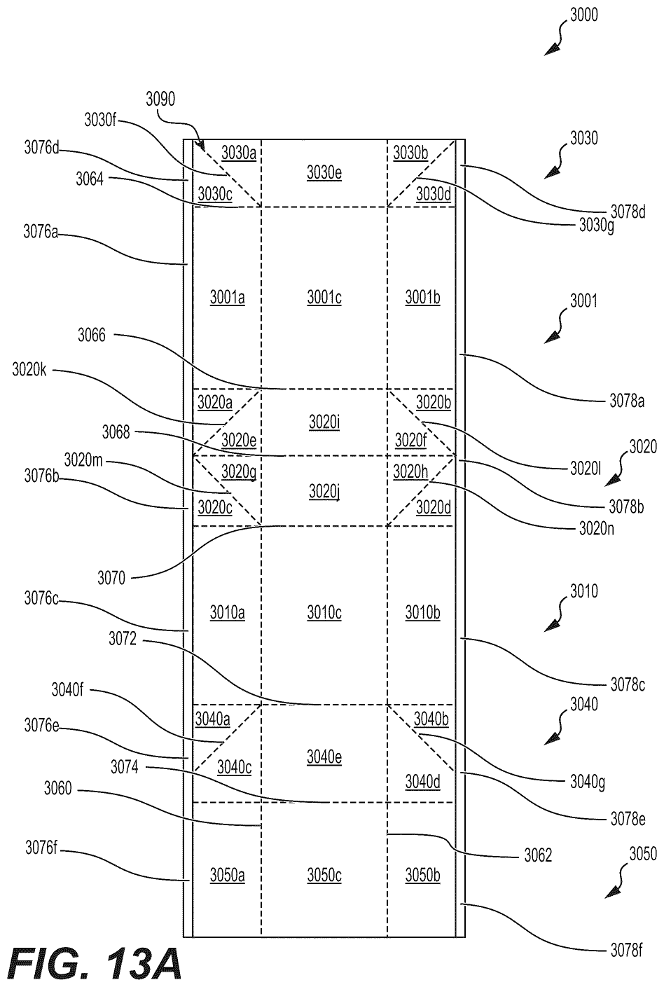

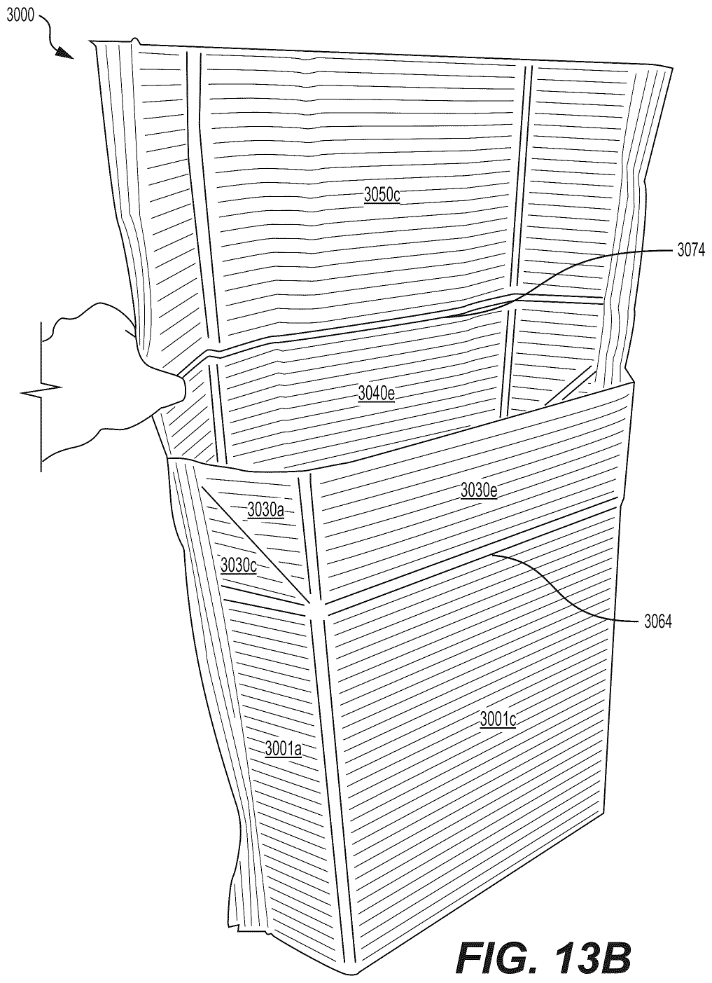

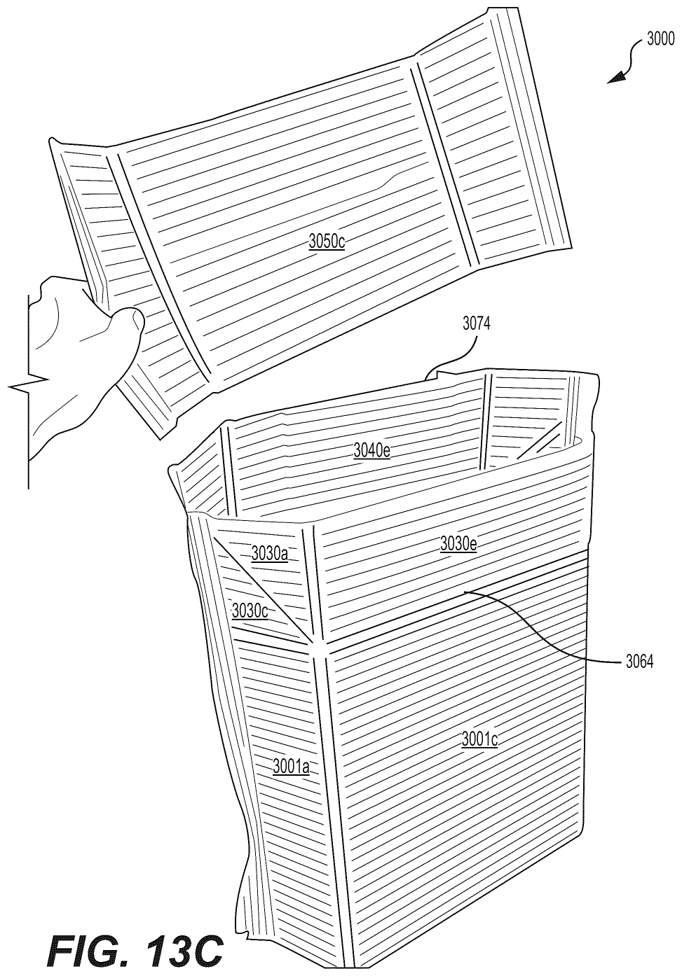

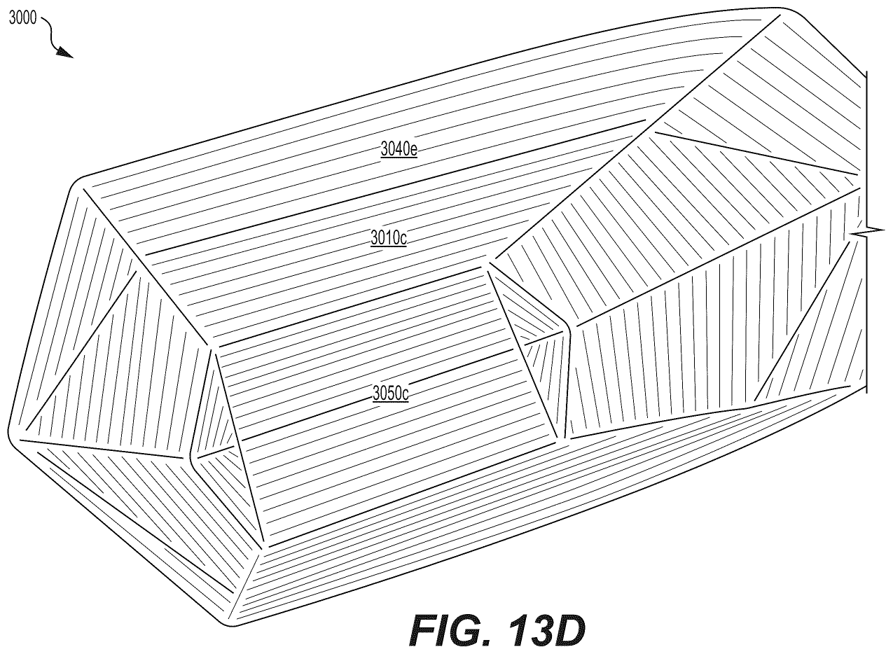

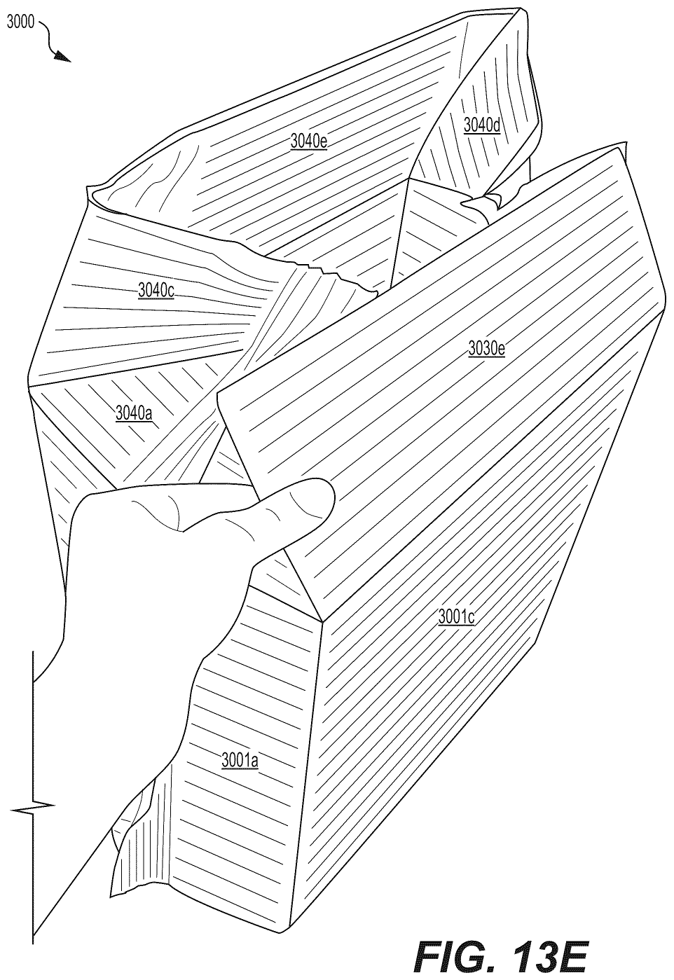

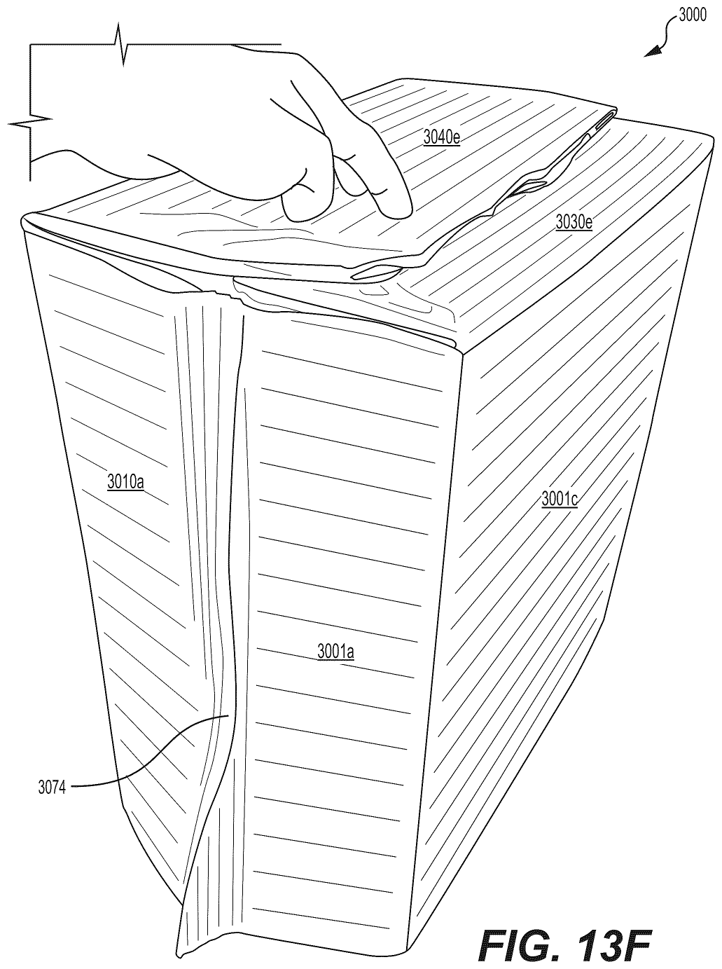

FIGS. 13A-13F show various perspectives and aspects of another insulated bag 3000 that may include insulating substrate 100 and is configured to expand and collapse flat. As shown in FIG. 13A, the insulating substrate 100 may include a first section 3001, a second section 3020, a third section 3010, a fourth section 3030, a fifth section 3040, and a sixth section 3050. The first section 3001 may include outer portions 3001a, 3001b, and middle portion 3001c. The second section 3020 may include outer angular portions 3020a, 3020b, 3020c, and 3020d; inner angular portions 3020e, 3020f, 3020g, and 3020h; and middle portions 3020i and 3020j. The third section 3010 may include outer portions 3010a, 3010b, and middle portion 3010c. The fourth section 3030 may include inner angular portions 3030a, 3030b; outer angular portions 3030c, 3030d; and middle portion 3030e. The fifth section 3040 may include outer angular portions 3040a, 3040b; inner angular portions 3040c, 3040d; and middle portion 3040e. The sixth section 3050 may include outer portions 3050a, 3050b, and middle portion 3050c.

The first section 3001 may include a first edge 3076a and a second edge 3078a, the second section 3020 may include a third edge 3076b and a fourth edge 3078b, the third section 3010 may include a fifth edge 3076c and a sixth edge 3078c, the fourth section 3030 may include a seventh edge 3076d and an eighth edge 3078d, the fifth section 3040 may include a ninth edge 3076e and a tenth edge 3078e, and the sixth section 3050 may include an eleventh edge 3076f and a twelfth edge 3078f.

The insulating substrate 100 may include a crease line 3060 that vertically separates (i) the outer portion 3001a from the middle portion 3001c of the first section 3001, (ii) the inner angular portion 3020e from the middle portion 3020i of the second section 3020, (iii) the inner angular portion 3020g from the middle portion 3020j of the second section 3020, (iv) the outer portion 3010a from the middle portion 3010c, (v) the inner angular portion 3030a from the middle portion 3030e, (vi) the inner angular portion 3040c from the middle portion 3040e, and (vii) the outer portion 3050a from the middle portion 3050c. The insulating substrate 100 may include a crease line 3062 that vertically separates (i) the outer portion 3001b from the middle portion 3001c of the first section 3001, (ii) the inner angular portion 3020f from the middle portion 3020i of the second section 3020, (iii) the inner angular portion 3020h from the middle portion 3020j of the second section 3020, (iv) the outer portion 3010b from the middle portion 3010c, (v) the inner angular portion 3030b from the middle portion 3030e, (vi) the inner angular portion 3040d from the middle portion 3040e, and (vii) the outer portion 3050b from the middle portion 3050c.

The insulating substrate 100 may include a crease line 3064 that horizontally separates the fourth section 3030 from the first section 3001; a crease line 3066 that horizontally separates the first section 3001 from the second section 3020; a crease line 3070 that horizontally separates the second section 3020 from the third section 3010; a crease line 3072 that horizontally separates the third section 3010 from the fifth section 3040; and a crease line 3074 that horizontally separates the fifth section 3040 from the sixth section 3050.

The second section 3020 of the insulating substrate 100 may include a crease line 3068 that horizontally separates (i) the middle portion 3020i from the middle portion 3020j, (ii) the inner angular portion 3020e from the inner angular portion 3020g, and (iii) the inner angular portion 3020f from the inner angular portion 3020h. The second section 3020 may further include a crease line 3020k that separates the inner angular portion 3020e from the outer angular portion 3020a at an oblique angle; a crease line 3020m that separates the inner angular portion 3020g from the outer angular portion 3020c at an oblique angle; a crease line 3020l that separates the inner angular portion 3020f from the outer angular portion 3020b at an oblique angle; and a crease line 3020n that separates the inner angular portion 3020h from the outer angular portion 3020d at an oblique angle.

The fourth section 3030 may include a crease line 3030f that separates the outer angular portion 3030c from the inner angular portion 3030a at an oblique angle, and a crease line 3030g that separates the outer angular portion 3030d from the inner angular portion 3030b at an oblique angle.

The fifth section 3040 may include a crease line 3040f that separates the inner angular portion 3040c from the outer angular portion 3040a at an oblique angle, and a crease line 3040g that separates the inner angular portion 3040d from the outer angular portion 3040b at an oblique angle. As shown in FIG. 13A, crease lines 3040f and 3040g may respectively extend only part of the way up along edges 3076e and 3078e such that outer angular portion 3040a and inner angular portion 3040c both share at least one side with edge 3076e, and outer angular portion 3040b and inner angular portion 3040d both share at least one side with edge 3078e. This crease line formation aids in creating a wider middle portion 3040e and inner angular portions 3040c, 3040d respectively compared to middle portion 3030e and inner angular portions 3030a, 3030b such that middle portion 3040e can be folded down and placed over middle portion 3030e when insulated bag 3000 is closed, as particularly shown in FIGS. 13E and 13F.

Insulated bag 3000 may include an insulating substrate 100 with a tenth crease pattern 3090 corresponding to crease lines 3030f, 3030g, 3020k, 3020l, 3020m, 3020n, 3040f, 3040g, 3060, 3062, 3064, 3066, 3068, 3070, 3072, 3074. The one or more crease lines may be formed via heat, pressure, or both as described below.

Insulated bag 3000 can be formed by folding crease lines 3066 and 30707 such that middle portions 3020i and 3020j of the second section 3020 form the bottom-most panel of the expanded insulated bag 3000. Portions (e.g., upper portions) of the first edge 3076a and the second edge 3078a of the first section 3001 may be respectively attached to portions (e.g., upper portions) the fifth edge 3076c and the sixth edge 3078c of the third section 3010. In addition, portions (e.g., lower portions) of the first edge 3076a and the second edge 3078a may be respectively attached to portions of the third edge 3076b and the fourth edge 3078b of the second section 3020. Additionally, portions (e.g., lower portions) of the fifth edge 3076c and the sixth edge 3078c may be respectively attached to portions of the third edge 3076b and fourth edge 3078b of the second section 3020. Further, portions of the seventh edge 3076d and eighth edge 3078d may be respectively attached to portions of the ninth edge 3076e and tenth edge 3078e. The aforementioned edges may be heat-sealed to one another by activating a polymer coating on the first and/or second layer 102a, 102b.

Middle portions 3001c, 3010c, 3030e, and 3040e may form the sides of the insulated bag 3000 prior to it being closed, as particularly shown in FIG. 13B. As shown in FIG. 13C, once the open bag is formed and standing in an upright position, the sixth section 3050 can be torn off of section 3040, e.g., via a perforated crease line 3074. As particularly shown in FIG. 13D, the sixth section 3050 can then be placed down inside the insulated bag 3000 to form a second bottom layer internal to the second section 3020 to create additional insulation. As shown in FIG. 13E, outer angular portions 3040a and 3040b, and inner angular portions 3040c and 3040d of the fifth section 3040 can then be folded inward such that middle portions 3030e and 3040e can be folded down flat (e.g., with middle portion 3040e on top of middle portion 3030e) to form the flat top of insulated bag 3000 (FIG. 13F).

It should be understood that any of the insulated products discussed herein may not include one or more of the disclosed portions, for example, those configured to form a top or cover for the insulated products. The present disclosure contemplates insulated products that may be formed to have an open top (e.g., in a bag formation). For example, insulated bag 800 (FIGS. 9A-9F) may not include sixth section 850 or seventh section 860 such that insulated bag 800 can be formed into an open bag, as particularly shown in FIG. 9B. It should be understood that any of the insulated products disclosed herein may be formed in a similar fashion.

It should also be understood that any of the insulated products discussed herein may be placed in another product, such as a container (e.g., a bag or box), to aid in providing additional coverage or insulation of the items (e.g., food items) contained therein.

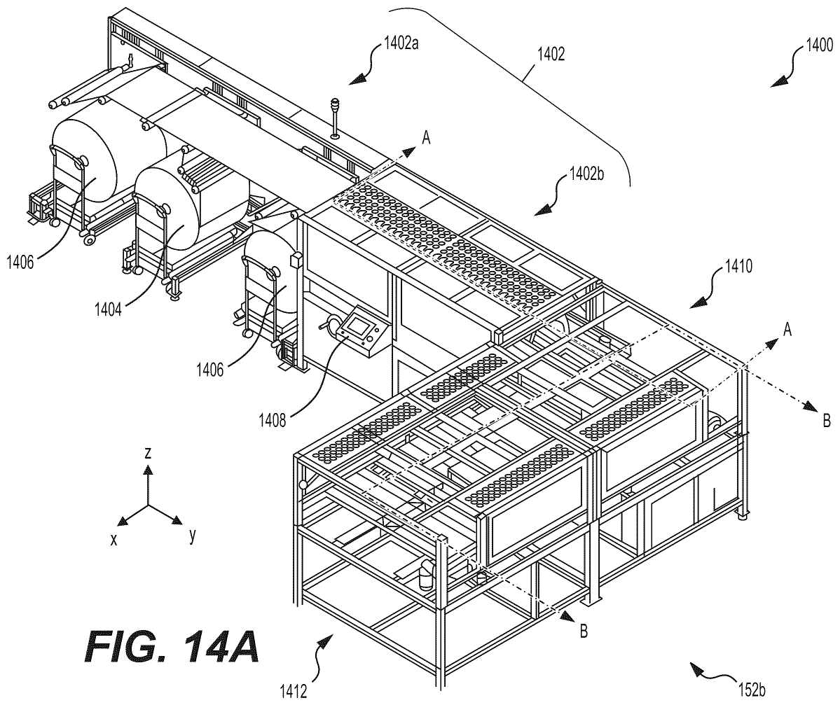

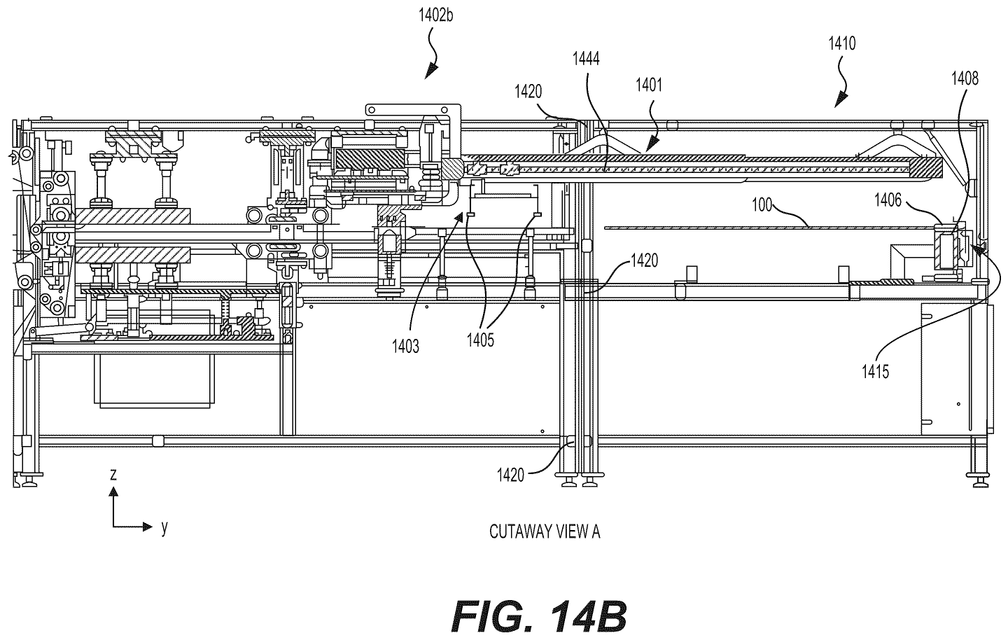

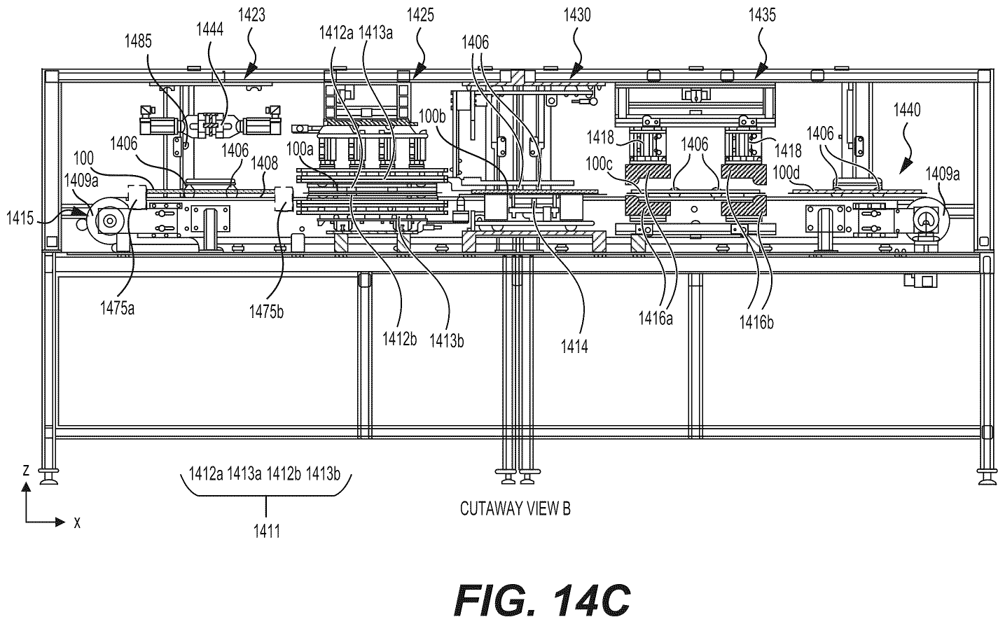

FIGS. 14A-14C show various views of a machine 1400 for making one or more various insulated bags described herein. As shown in FIG. 14A, Machine 1400 may include a back end machine 1402 with first section 1402a configured to house substrate materials (e.g., paper) such as a core substrate 1404 and one or more barrier layers 1406. These substrates may be housed on rollers. The back end machine 1402 may include a second section 1402b configured to pull the substrates from the first section 1402a and form them into insulation panels or insulating substrates 100 shown and described with respect to FIGS. 1 and 2.

As shown in FIGS. 14A and 14B, machine 1400 may include front end machine 1410 configured to generate and form one or more various insulated bags described herein. Front end machine 1410 may be a modular component that is attached (e.g., bolted via one or more attachment locations 1420) to an end of second section 1402b of back end machine 1402.

Front end machine 1410 may an initial assembly station 1423 (see FIGS. 14B and 14C) that includes a transport assembly 1401 including pick and place 1403 and track 1444. Pick and place 1403 may have one, two, or more vacuum assisted or operated heads 1405 and may move along track 1444 to transport the one or more insulating substrates 100 from the second section 1402b of back end machine 1400 to one or more clips 1406 in an open position of an indexing assembly 1415.

Front end machine 1410 may include a plurality of assembly stations including initial assembly station 1423, press assembly station 1425, folding assembly station 1430, and sealing station 1435 along with indexing assembly 1415 to transport one or more insulating substrates 100 to the plurality of assembly stations.

Indexing assembly 1415 may also include belt 1408 and drive wheels 1409a and 1409b (see FIG. 14C). One or more clips 1406 are attached to belt 1408 which in conjunction with rotating drive wheels 1409a and 1409b transport the one or more clips 1406 in a closed position to a plurality of assembly stations within the front end machine 1410. Clips 1406 may open to receive or release one or more insulating substrates 100. Once one or more insulating substrates 100 are placed by pick and place 1403 in the one or more clips 1406, one or more clips 1406 are configured to close and grip the one or more insulating substrates 100 so they can be transported to an adjacent assembly station such as press assembly station 1425. Indexing assembly 1415 may include a sensor 1485 configured to detect the one or more insulating substrates 100 positioning is near the one or more clips 1406 and cause one or more clips 1406 to open and receive the one or more insulating substrates 100. Indexing assembly 1415 may track the position one or more of the vacuum assisted or operated heads 1405 of pick and place 1403. Upon the vacuum assisted or operated heads 1405 of pick and place 1403 moving a predetermined distance, indexing assembly 1415 may open one or more clips 1406. In some embodiments, one or more clips 1406 remain open from releasing an insulated bag. Thus, one or more clips 1406 may open and close based on their position at a particular station (e.g., arrive at initial assembly station 1423 open, close a predetermined time before leaving initial assembly station 1423, remain closed until reach exiting assembly station 1440).

Initial assembly station 1423 may include one or more alignment rails 1475a, 1475b (see FIG. 14C) which are configured to align insulating substrates 100 being transported by transport assembly 1401 (see FIG. 14B) with one or more clips 1406 so that the one or more substrates are positioned as desired (e.g., centrally with respect to one or more clips 1406). Alignment rail 1475b may be located in indexing assembly's 1415 transportation path (e.g., along X-axis) of one or more insulating substrate 100 from initial assembly station 1423 to press assembly station 1425. As such, initial assembly station 1423 or indexing assembly 1415 may be configured to move alignment rail 1475b out of the transportation path (e.g., along Z-axis (above or below), X-axis, Y-axis or some combination or portion thereof) once one or more clips 1406 have closed over one or more insulating substrates 100.

Press assembly station 1425 may include a modular die press 1411 including a first modular portion 1412a and a second modular portion 1412b. The first modular portion 1412a and and/or the second modular portion 1412b may include a crease pattern (e.g., one of crease patterns 290, 390, 490, 590, 690 790, 890, 990, 1090, 2090, 3090) corresponding to the one or more crease lines described herein. Modular die press 1411 may also include and one or more heaters 1413a, 1413b configured to heat modular die press 1411. Press assembly 1425 may default to an open state to that it can receive one or more insulating substrates 100. In other words, press assembly station 1424 separates or moves first modular portion 1412a and second modular portion 1412b away from each other to create a space between first modular portion 1412a and second modular portion 1412b to receive one or more insulating substrates 100 or to allow for one or more insulating substrates 100 currently positioned between first modular portion 1412a and second modular portion 1412b to be transported to folding assembly station 1430. Once indexing assembly 1415 transports one or more insulating substrates 100 to press assembly station 1425, first modular portion 1412a and second modular portion 1412b (while or previously heated by one or more heaters 1413a and 1413b) move toward one another to create creases in insulating substrates 100a with a crease pattern to create an insulating substrates 100b with an inverse crease pattern (described as various exemplary crease patterns herein). Based on the heating via one or more heaters 1413a, 1413b, the first modular portion 1412a and/or the second modular portion 1412b may be configured to heat the one or more insulating substrates 100 at least according to contact associated with the creasing pattern. By heating the one or more insulating substrates 100 in a creasing pattern, a coating (e.g., polymer coating) disposed on at least one surface of layers (e.g., layers 102a, 102b) of the insulating substrate 100 may (i) melt and reform when cooled to maintain the creasing pattern or (ii) thermoset along the creasing pattern to maintain the creasing pattern. First modular portion 1412a and/or second modular portion 1412b may include a die pattern that is inverse to the one or more crease patterns described herein (e.g., crease patterns 290, 390, 490, 590, 690 790, 890, 990, 1090, 2090, 3090). In some embodiments, the crease patten of may include a portion that contacts and applies heat to one or more insulating substrates 100 without creating a crease line. This portion does not create a crease line. Instead, this portion strengthens helps maintain a shape or strengthen a corresponding portion (e.g., a handle or top portion) of the insulated bag. An operated may using quick change tooling swap out a first die pattern corresponding to crease pattern 290 with a second die pattern corresponding to crease pattern 390.

Folding assembly station 1430 may receive insulating substrate 100b with a crease pattern uses one or more actuated arms to fold insulating substrate 100b along one or more crease lines (e.g., not all) to create a folded insulating substrate 100c. Alternatively, or in addition, a user may fold insulating substrate 100b along one or more crease lines.

Sealing assembly station 1435 may receive one or more folded insulating substrate 100c via indexing assembly 1415. Sealing assembly station 1435 may include one or more longitudinal heated presses 1416a, 1416b configured to seal at least two edges of the folded insulating substrate 100c by heating (directly or indirectly) and pressing the polymer coating of the one or more insulating substrates 100 along at least one edge of the folded insulating substrate 100c. In some embodiments, longitudinal heated presses 1416a, 1416b bond first layer 102a to the same first layer 102a of the folded insulating substrate 100c due to a polymer coating found on the first layer that melts under heat and adheres to a facing portion of first layer 102a. First layer 102a may include one or more extension portions resulting from having a width that is greater than core layer 104 and possible second layer 102b. Theses extension portions of first layer 102a may bond to each other. In alternative embodiments, second layer 102b may have similar features and bond to itself in a similar manned.

Exiting assembly station 1440 may receive one or more insulated bags 100d via indexing assembly 1415. At the exiting assembly station 1440, indexing assembly 1415 may be further configured to open and release one or more clips 1406 so that a second transporting device (not shown) may remove the insulated bags form the one or more clips 1406. In some embodiments, machine 1400 may also include a second transporting device (e.g., a pick and place) configured to transport the bag away from the exit assembly station 1440. In other embodiments, second transporting device (e.g., a pick and place) may be a part of a separate machine. In still other embodiments, an operator may remove bags from one or more clips 1406.

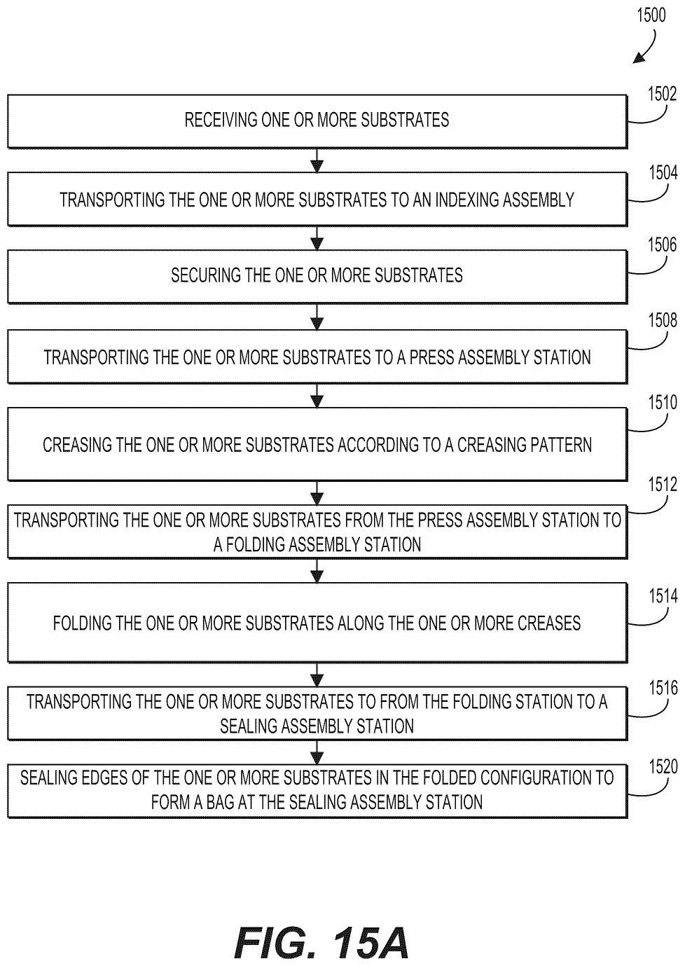

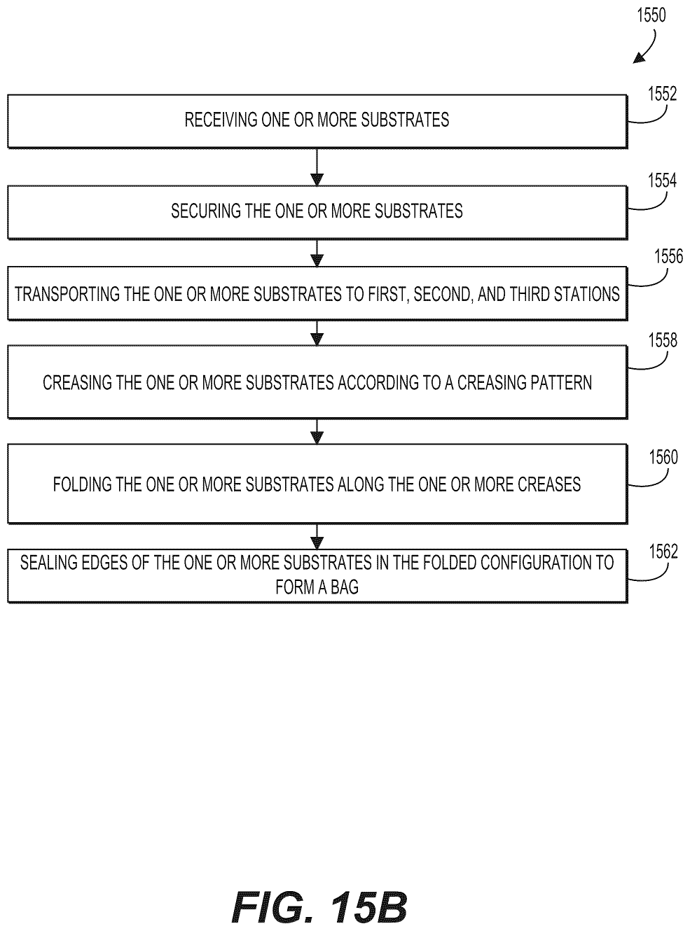

FIG. 15A is a flowchart of a method 1500 for forming one or more insulated bags according to various exemplary embodiments described herein.

In block 1502, method 1500 may include receiving one or more insulating substrates 100. Method 1500 may form these insulating substates 100 into an insulated bag or pouch without any an external adhesive.

In block 1504, method 1500 may include transporting the one or more insulating substrates 100 to an indexing assembly 1415. For example, the method may include transporting, via one or more pick and place actuators 1405, the one or more insulating substrates 100 to the indexing assembly 1415.

In block 1506, method 1500 may include securing the one or more substrates. For example, the method may include opening one or more clips 1406 of the indexing assembly to receive the one or more substrates in the one or more clips 1406. In addition, the method may include closing one or more clips 1406 on an edge of the one or more substrates thereby securing the one or more insulating substrates 100 therein. Method 1500 may also include detecting a position of the one or more insulating substrates 100 is near the one or more clips 1406. In response to detecting the one or more insulating substrates 100 is near the one or more clips 1406, configure the one or more clips 1406 to open to receive the one or more substrates. In other embodiments, method 1500 may include detecting/determining the position that the one or more pick and place actuators 1405 move toward or approach the one or more clips 1406. In response to determining the position of the one or more pick and place actuators 1405 is moving toward or approaching the one or more clips 1406, opening the one or more clips 1406 to receive the one or more insulating substrates 100.

Method 1500 may also include aligning the one or more substrates 100 in the one or more clips using at least one alignment rail 1475a, 1475b.

In block 1508, method 1500 may include transporting the one or more insulating substrates 100 to a press assembly station 1425. The indexing assembly 1415 may transport the one or more insulating substrates 100 using the one or more clips 1406 attached to a movable belt 1408 to the press assembly station 1425. The indexing assembly 1415 may stop the moveable belt 1408 for a predetermined amount of time and at a predetermined location so that the one or more insulating substrates 100 are aligned (e.g., centrally) within the press assembly location station 1425.

Transporting the one or more insulating substrates 100 to the press assembly station 1425 may include moving the at least one alignment rail 1475a, 1475b away from a transportation path being along the X-axis. As such, initial assembly station 1423 or indexing assembly 1415 may be configured to move alignment rail 1475b out of the transportation path (e.g., along Z-axis (above or below), X-axis, Y-axis or some combination or portion thereof) once one or more clips 1406 have closed over one or more insulating substrates 100.

In block 1510, method 1500 may include creasing the one or more insulating substrates 100 according to a crease pattern to form one or more creases in the one or more insulating substrates 100 at the press assembly station 1425. The method 1500 may include receiving the one or more insulating substrates 100 within press assembly station 1425 between first modular portion 1412a of die press 1411 and a second modular portion 1412b of die press 1411. The method 1500 may also include moving first modular portion 1412a of die press 1411 closer to second modular portion 1412b of die press 1411 with the one or more insulating substrates 100 disposed therebetween such that that crease pattern may be applied to the one or more insulating substrates 100. In some cases, method 1500 may include moving second modular portion 1412b closer to first modular portion 1412a with one or more insulating substrates 100 disposed therebetween such that the crease pattern may be applied to one or more insulating substrates 100. In some cases, method 1500 may include moving both first modular portion 1412a and second modular portion 1412b closer together such that the crease pattern may be applied to one or more insulating substrates 100. Creasing may also include heating first modular portion 1412a and/or the second modular portion 1412b via one or more heaters 1413a, 1413b, which in turn heats the one or more insulating substrates 100 at least along the creasing pattern. By heating the one or more insulating substrates 100 in a creasing pattern, a coating disposed on at least one surface of layers (e.g., layers 102a/102b) of the insulating substrate 100 may help maintain the creasing pattern.

An operated may using quick change tooling swap out a first die pattern corresponding to crease pattern 290 with a second die pattern corresponding to crease pattern 390.

In block 1512, method 1500 may include transporting the one or more substrates from the press assembly station 1425 to a folding assembly station 130. The indexing assembly 1415 may transport the one or more insulating substrates 100 using the one or more clips 1406 attached to a movable belt 1408 to the folding assembly station 1430. The indexing assembly 1415 may stop the moveable belt 1408 for a predetermined amount of time and at a predetermined location so that the one or more insulating substrates 100 are aligned (e.g., centrally) within the folding assembly station 1430.

In block 1514, method 1500 may include folding the one or more insulating substrates 100 along the one or more creases such that the one or more substrates 100 are placed in a folded configuration at the folding assembly station 1430. In some embodiments, an operator may fold the one or more insulating substrates 100 along one or more crease lines. In other embodiments, the folding assembly station 1430 may include a robotic arm that folds the one or more insulating substrates 100.

In block 1516, method 1500 may include transporting the one or more substrates from the folding assembly station 1430 to a sealing assembly station 1435. The indexing assembly 1415 may transport the one or more insulating substrates 100 using the one or more clips 1406 attached to a movable belt 1408 to the sealing assembly station 1435. The indexing assembly 1415 may stop the moveable belt 1408 for a predetermined amount of time and at a predetermined location so that the one or more insulating substrates 100 are aligned (e.g., centrally) within the sealing assembly station 1435.

In block 1518, method 1500 may include sealing edges of the one or more insulting substrates 100 in the folded configuration to form a bag (e.g., insulated bag 200) at the sealing assembly station 1435. Sealing assembly station 1435 may receive a folded insulating substrate 100c via indexing assembly 1415. Sealing assembly station 1435 may include one or more longitudinal heated presses configured to seal at least two edges of the folded insulating substrate 100c by heating and pressing (directly or indirectly) the polymer coating of the one or more substrates along at least one edge of folded insulated substrate 100c.

FIG. 15B is a flowchart of a method 1550 for forming one or more insulated bags according to various exemplary embodiments described herein.

In block 1552, method 1550 may include receiving one or more insulating substrates 100. For example, indexing assembly 1415 may receive one or more insulating substrates 100 within one or more mouths of one or more open clips 1406.

In block 1554, method 1550 may include securing the one or more insulating substrates 100 similar to as described with respect to block 1506.

In block 1556, method 1550 may include transporting the one or more insulating substrates 100 to a first station (e.g., press assembly station 1425), a second station (e.g., folding assembly station 1430), and a third station (e.g., sealing station 1435). For example, indexing assembly 1415 may transport one or more insulating substates 100 from initial assembly station 1423 to press assembly station 1425, from press assembly station 1425 to folding assembly station 1430, and from folding assembly station 1430 to sealing assembly station 1435 while stopping the one or more substates at each station for a predetermined amount of time.

In block 1558, method 1550 may include creasing the one or more insulating substrates 100 according to a crease pattern (e.g., one of crease patterns 290, 390, 490, 590, 690 790, 890, 990, 1090, 2090, 3090) to form one or more creases in the one or more insulating substrates 100 at the first station (e.g., press assembly station 1425).

In block 1560, method 1550 may include folding the one or more insulating substrates 100 along the one or more creases such that the one or more insulating substrates 100 are placed in a folded configuration at the second station (e.g., folding assembly station 1430). For example, folding assembly station 1430 or an operator at folding assembly station may fold one or more insulating substrates 100 at some or all of the one or more crease lines described herein.

In block 1562, method 1550 may include sealing edges of the one or more insulating substrates 100 in the folded configuration to form a bag at the third station (e.g., sealing assembly station 1435). Sealing assembly station 1435 may receive a folded insulating substrate 100c via indexing assembly 1415. Sealing assembly station 1435 may include one or more longitudinal heated presses configured to seal at least two edges of the folded insulating substrate 100c by heating and pressing (directly or indirectly) the polymer coating of the one or more substrates along at least one edge of folded insulated substrate 100c.

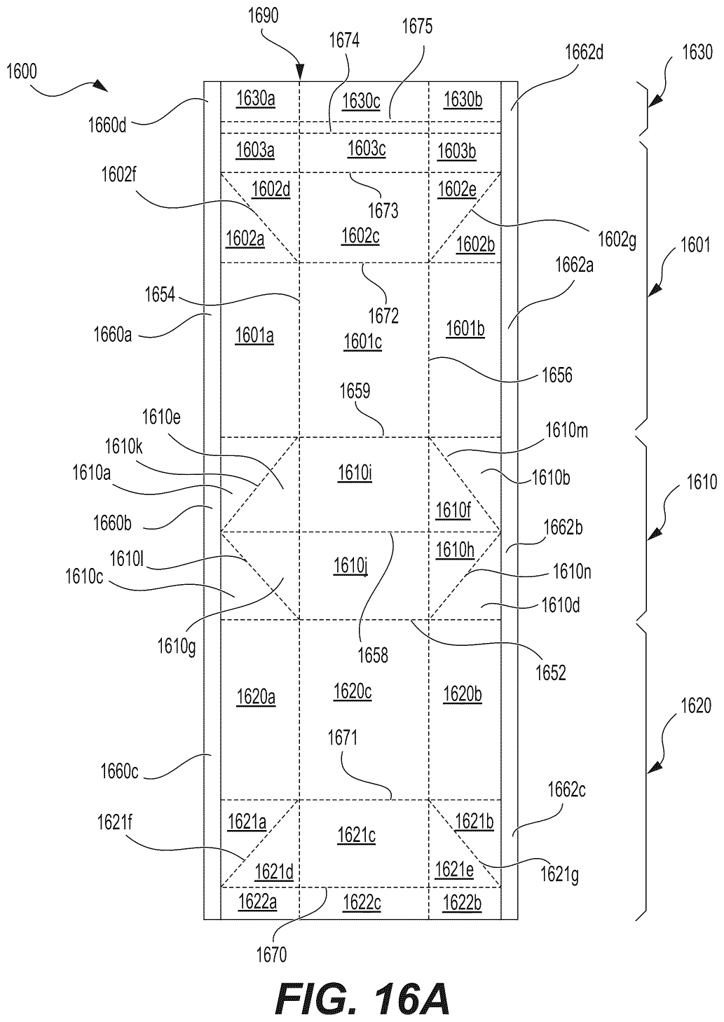

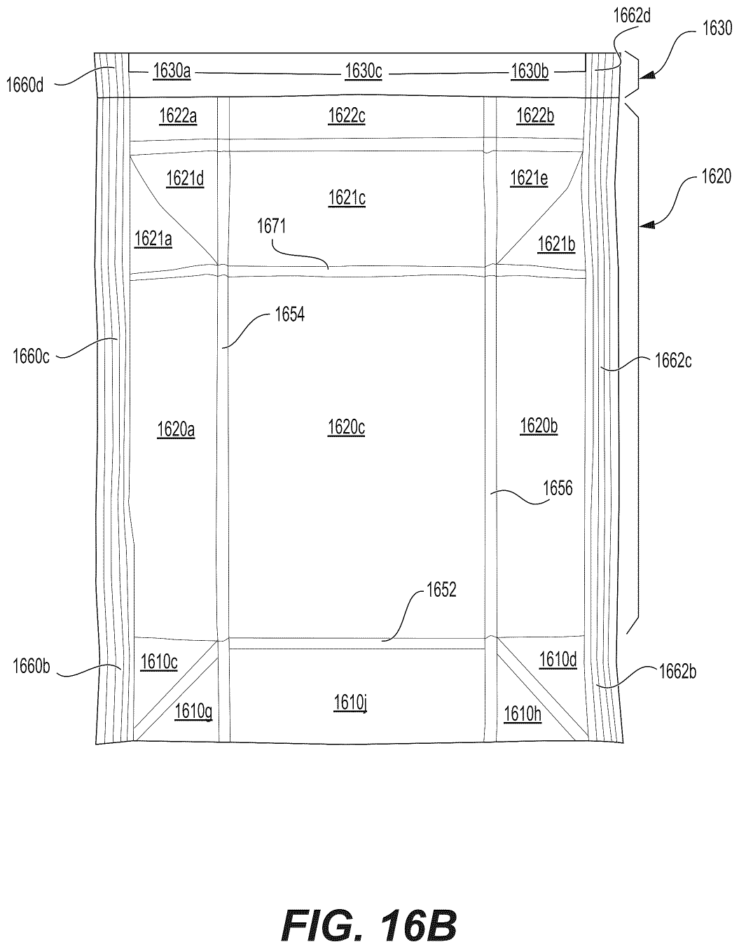

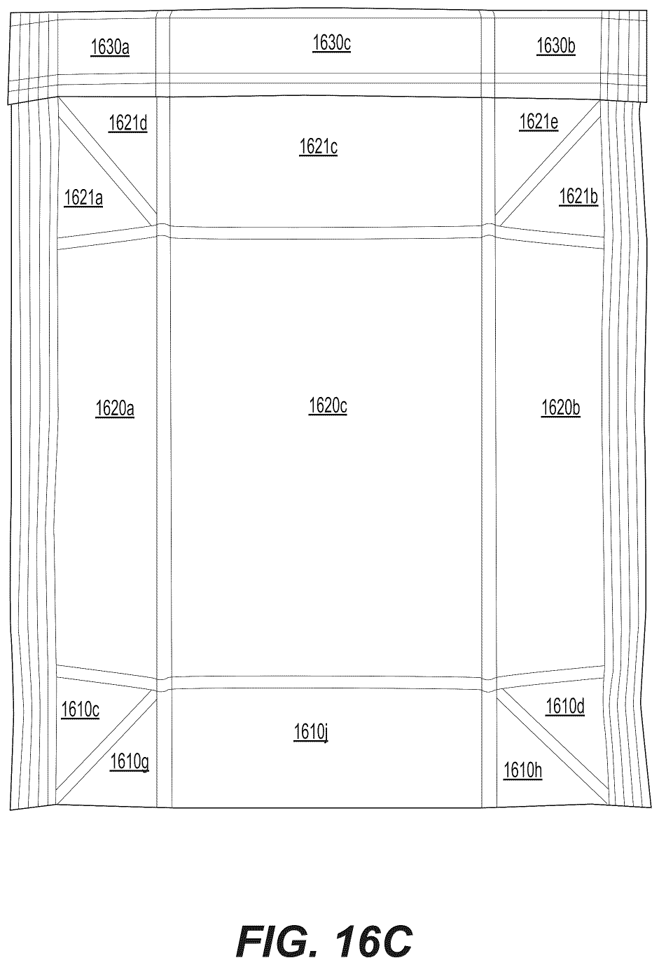

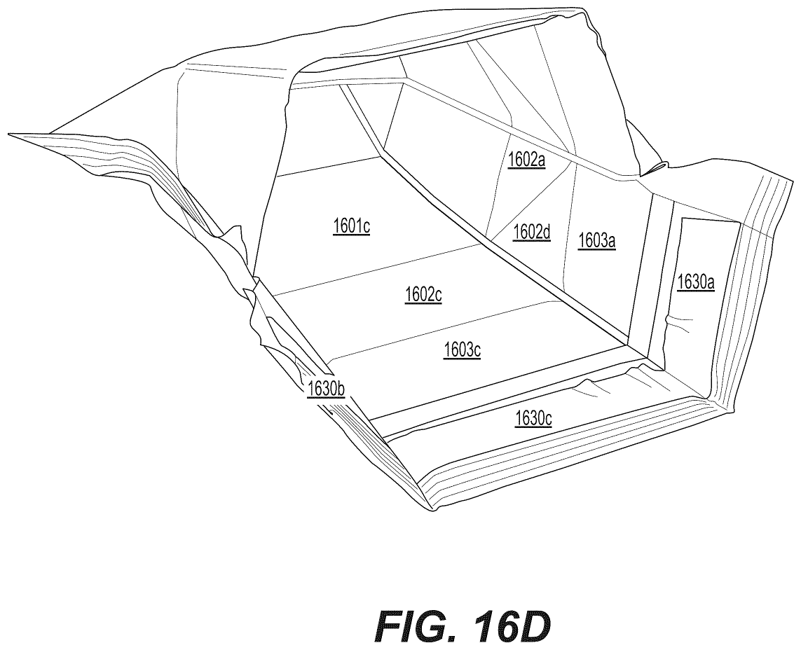

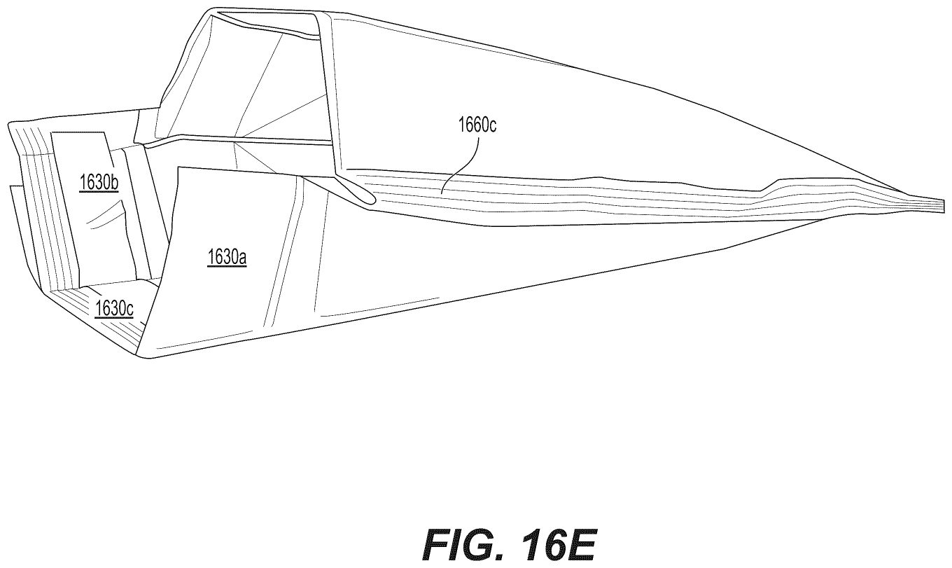

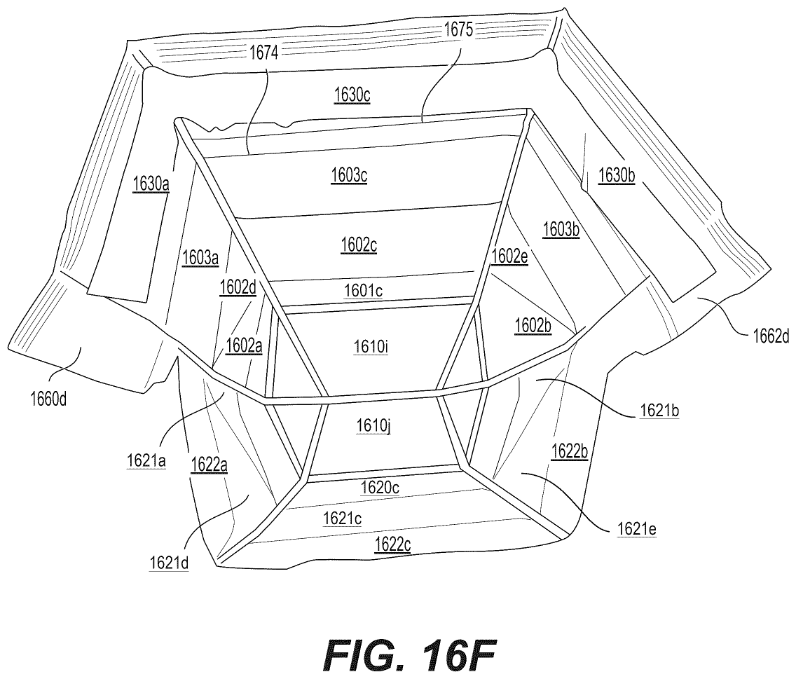

FIGS. 16A-16F show various perspectives and aspects of another insulated pouch 1600 that may include insulating substrate 100 and is configured to expand and collapse flat. In such embodiment, insulating substrate 100 may include a first section 1601, a second section 1610, a third section 1620, and a fourth section 1630. First section 1601 may include a first outer portion 1601a, a second outer portion 1601b, and a first middle portion 1601c. First section 1601 may further include a third outer portion 1603a, a fourth outer portion 1603b, and a second middle portion 1603c. First section 1601 may further include a first outer angular portion 1602a, a second outer angular portion 1602b, a first inner angular portion 1602d, a second inner angular portion 1602e, and a third middle portion 1602c.

Second section 1610 may include a third outer angular portion 1610a, a fourth outer angular portion 1610c, a fifth outer angular portion 1610b, and a sixth outer angular portion 1610d. Secon section 1610 may further include a third inner angular portion 1610e, a fourth inner angular portion 1610g, a fifth inner angular portion 1610f, and a sixth inner angular portion 1610h. Second section 1610 may further include a fourth middle portion 1610i and a fifth middle portion 1610j.

Third section 1620 may include a fifth outer portion 1620a, a sixth outer portion 1620b, a seventh outer portion 1622a, an eighth outer portion 1622b, a sixth middle portion 1620c, a seventh middle portion 1621c, and an eighth middle portion 1622c. Third section 1620 may further include a seventh outer angular portion 1621a, an eighth outer angular portion 1621b, a seventh inner angular portion 1621d, and an eighth inner angular portion 1621e.

Fourth section 1630 may include a ninth outer portion 1630a, a tenth outer portion 1630b, and a ninth middle portion 1630c.

The first section 1601 may include first edge 1660a and second edge 1662a; the second section 1610 may include third edge 1660b and fourth edge 1662b; the third section 1620 may include fifth edge 1660c and sixth edge 1662c; and fourth section 1630 may include seventh edge 1660d and eighth edge 1662d. The edges of each respective section may be sealed to each other and/or edges of other respective sections once the insulated pouch 1600 is configured in its assembled position, as disclosed herein.

Similar to other insulated products discussed herein, insulated pouch 1600 may include a variety of crease lines between and among the above-described portions and sections. For example, insulated pouch 1600 may include one or more (e.g., two) crease lines 1674 and 1675 that horizontally separate the first section 1601 from the fourth section 1630, a crease line 1659 that horizontally separates the first section 1601 from the second section 1610, and a crease line 1652 that horizontally separates the second section 1610 from the third section 1620. Insulated pouch 1600 may include a crease line 1658 in second section 1610 that separates (i) the second middle portion 1610i from the third middle portion 1610j, (ii) the inner angular portion 1610e from the inner angular portion 1610g, and (iii) the inner angular portion 1610f from the inner angular portion 1610h. Insulated pouch 1600 may include a crease line 1654 that vertically separates (i) middle portion 1601c from outer portion 1601a, (ii) middle portion 1610i from inner angular portion 1610e, (iii) middle portion 1610j from inner angular portion 1610g, (iv) middle portion 1620c from outer portion 1620a, (v) middle portion 1630c from outer portion 1630a, (vi) middle portion 1621c from inner angular portion 1621d, (vii) middle portion 1622c from outer portion 1622a, and (viii) middle portion 1603c from outer portion 1603a. Insulated pouch 1600 may include a crease line 1656 that vertically separates (i) middle portion 1601c from outer portion 1601b, (ii) middle portion 1610i from inner angular portion 1610f, (iii) middle portion 1610j from inner angular portion 1610h, (iv) middle portion 1620c from outer portion 1620b, (v) middle portion 1630c from outer portion 1630b, (vi) middle portion 1621c from inner angular portion 1621e, (vii) middle portion 1622c from outer portion 1622b, and (viii) middle portion 1603c from outer portion 1603b. Within first section 1601, insulated pouch 1600 may include a crease line 1602f that separates outer angular portion 1602a from inner angular portion 1602d at an oblique angle, a crease line 1602g that separates inner angular portion 1602e from outer angular portion 1602b at an oblique angle, and one or more horizonal crease lines 1673, 1672 that respectively separate one or more portions of the first section 1601. Within second section 1610, the insulated pouch 1600 may include a crease line 1610k that separates the inner angular portion 1610e from the outer angular portion 1610a at an oblique angle, a crease line 1610l that separates the outer angular portion 1610c from the inner angular portion 1610g at an oblique angle, a crease line 1610m that separates the outer angular portion 1610b from the inner angular portion 1610f at an oblique angle, and a crease line 1610n that separates the outer angular portion 1610d from the inner angular portion 1610h at an oblique angle. Within third section 1620, insulated pouch 1600 may include a crease line 1621f that separates outer angular portion 1621a from inner angular portion 1621d at an oblique angle, a crease line 1621g that separates outer angular portion 1621b from inner angular portion 1621e at an oblique angle, and one or more horizonal crease lines 1671, 1670 that respectively separate one or more portions of the third section 1620. As such, pouch 1600 may include an insulating substrate 100 with a crease pattern 1690 corresponding to crease lines 1654, 1656, 1675, 1674, 1673, 1672, 1659, 1658, 1652, 1671, 1670, 1602f, 1602g, 1610k, 1610l, 1610m, 1610n, 1621f, and 1621g that may be formed via heat, pressure, or both as described below. The crease lines may form in one or more of the first layer 102a, the second layer 102b, and/or the core 104. In some embodiments, the substrate 104 may include gaps of core 104 such that creases are formed the gaps where the first layer 102a and the second layer 102b overlap without the core 104.

As discussed above with respect to FIGS. 7A-7F, in some embodiments, insulating substrate 100 may be folded along crease lines 1659 and 1652 such that middle portions 1610i and 1610j form the bottom of the insulated pouch 1600, e.g., to create a flat bottom, as particularly shown in FIG. 16F. In such embodiments, when the crease line 1658 is folded upward, insulated pouch 1600 may be collapsed as middle portions 1610i and 1610j collapse to meet one another. In some embodiments, as particularly shown in FIGS. 16B and 16C, when in a collapsed form, the middle portions 1610i and 1610j may respectively flatten along the front and back sides of the insulated pouch 1600. In this way, the crease lines in the second section 1610 are configured such that the insulated pouch 1600 can have either a flat bottom (FIG. 16F) or an angled/pointed bottom (FIG. 16E) depending on the type of item being held (e.g., shipped) in the insulated pouch 1600. In some embodiments, the crease lines may be configured such that when the insulated pouch 1600 is in its expanded form, such as in FIG. 16F, one or more of the angular portions 1610a, 1610e, 1610c, 1610g, 1610b, 1610f, 1610d, and 1610h expand outward and/or inward.

The first edge 1660a and the second edge 1662a of the first section 1601 may be respectively attached to the fifth edge 1660c and the sixth edge 1662c of the third section 1620. In addition, portions (e.g., lower portions) of the first edge 1660a and the second edge 1662a may be respectively attached to portions of the third edge 1660b and the fourth edge 1662b of the second section 1610. Additionally, portions (e.g., lower portions) of the fifth edge 1660c and the sixth edge 1662c may be respectively attached to portions of the third edge 1660b and the fourth edge 1662b of the second section 1610. The aforementioned edges may be heat-sealed to one another by activating a polymer coating on the first and/or second layer 102a, 102b, as discussed above with other disclosed insulated pouches.

As particularly shown in FIGS. 16A and 16B, the edges 1660d and 1662d of fourth section 1630 may extend beyond other sections or portions of insulated pouch 1600 and be left unattached to other edges when the insulated pouch 1600 is in a collapsed and open form (FIG. 16B), while those edges 1660d and 1662d may then be folded downward to respectively overlap with edges 1660c and 1662c of the third section 1620 when the fourth section 1630 is folded down to attach to a portion of the third section (e.g., portions 1622a, 1622b, 1622c). As discussed above with respect to other insulated pouches and products, in some embodiments, the fourth section 1630 may have an adhesive strip or some other type of closure mechanism disposed along its inner surface such that fourth section 1630 can be folded down and adhered to a portion of the third section (FIG. 16C).

In some embodiments, as particularly shown in FIGS. 16B and 16C, the crease lines of insulated pouch 1600 may be sealed (e.g., heat sealed) such that they extend through the full width of the insulating substrate 100. In such embodiments, the crease lines are configured to create fully sealed and/or air-tight pockets within each of the sections. As particularly shown in FIG. 16A, the first section 1601 can have up to eleven total sealed pockets. For example, the middle portion 1601c may be a fully sealed pocket if all of the surrounding crease lines, i.e., lines 1672, 1659, 1654, and 1656, are sealed through the width of the substrate 100. Middle portion 1601c then becomes an air-tight, insulated pocket. In a similar fashion, second section 1610 may have up to ten sealed pockets; third section 1620 may have up to eleven sealed pockets; and fourth section 1630 may have up to three sealed pockets. An added benefit of providing full seals in place of simpler crease or fold lines is that the resulting air-tight (or partially air-tight), insulated pockets help to create added cushioning and improve the overall thermal performance of the insulated pouch 1600.

### Examples

The following data provides examples of how one or more of the insulated products disclosed herein may provide for thermal performance improvement in comparison to a known insulated product, e.g., a metalized grocery bag. Data was taken over approximately a 27-hour period, and across a temperature range of approximately-20 degrees Celsius to 40 degrees Celsius. Data was collected over these periods and ranges to determine how various insulated products as disclosed herein would perform with respect to maintaining thermal insulation of chicken below a 5-degree Celsius maximum over a period of time.

The first insulated product tested was a single wall grocery bag including an insulating substrate (e.g., insulating substrate 100) having an approximately 0.25″ thickness and an internal core layer (e.g., core 104), similar to the disclosed insulated bag 200, 300, 400, 900, or 2000. The tested grocery bag maintained the temperature of the contained chicken to less than the 5-degree Celsius maximum for 20.00 hours, showing an approximately 16% improvement over the metalized grocery bag.

The second insulated product tested was a double wall grocery bag including an insulating substrate (e.g., one or two insulating substrate 100) having an approximately 0.50″ thickness and an internal core layer (e.g., core 104), similar to the disclosed insulated bag 200, 300, 400, 900, or 2000. The tested grocery bag maintained the temperature of the contained chicken to less than the 5-degree Celsius maximum for 23.58 hours, showing an approximately 37% improvement over the metalized grocery bag.

The third insulated product tested was a single wall grocery bag with a tear-off bottom pad including an insulating substrate (e.g., insulating substrate 100) having an approximately 0.25″ thickness and an internal core layer (e.g., core 104), similar to the disclosed insulated bag 3000. The tested grocery bag maintained the temperature of the contained chicken to less than the 5-degree Celsius maximum for 23.17 hours, showing an approximately 34% improvement over the metalized grocery bag.

The fourth insulated product tested was a single wall grocery bag including an insulating substrate (e.g., insulating substrate 100) having an approximately 0.375″ thickness and an internal core layer (e.g., core 104), similar to the disclosed insulated bag 200, 300, 400, 900, or 2000. The tested grocery bag maintained the temperature of the contained chicken to less than the 5-degree Celsius maximum for 21.50 hours, showing an approximately 25% improvement over the metalized grocery bag.

In some examples, disclosed systems or methods may involve one or more of the following clauses:
Clause 1: An insulated bag, comprising: an insulating substrate comprising: a first section; a second section; a third section; a fourth section comprising a first outer angular portion, a second outer angular portion, a first inner angular portion, a second inner angular portion, and a first middle portion; and a fifth section comprising a third outer angular portion, a fourth outer angular portion, a third inner angular portion, a fourth inner angular portion, and a second middle portion, wherein: a first crease line horizontally separates the first section from the fourth section, a second crease line horizontally separates the third section from the fifth section, a third crease line vertically separates (i) the first inner angular portion from the first middle portion, and (ii) the third inner angular portion from the second middle portion, a fourth crease line vertically separates (i) the first middle portion from the second inner angular portion, and (ii) the second middle portion from the fourth inner angular portion, a fifth crease line separates the first outer angular portion from the first inner angular portion at a first oblique angle, a sixth crease line separates the second outer angular portion from the second inner angular portion at a second oblique angle, a seventh crease line separates the third inner angular portion from the third outer angular portion at a third oblique angle, and an eighth crease line separates the fourth inner angular portion from the fourth outer angular portion at a fourth oblique angle.
Clause 2: The insulated bag of clause 1, wherein a first edge and a second edge of the fourth section are respectively attached to a third edge and a fourth edge of the fifth section.
Clause 3: The insulated bag of clause 1, further comprising: a sixth section comprising a first outer portion, a second outer portion, and a third middle portion; and a seventh section comprising a third outer portion, a fourth outer portion, and a fourth middle portion.
Clause 4: The insulated bag of clause 3, wherein: the third crease line further vertically separates (i) the first outer portion from the third middle portion, and (ii) the third outer portion from the fourth middle portion, and the fourth crease line further vertically separates (i) the third middle portion from the second outer portion, and (ii) the fourth middle portion from the fourth outer portion.
Clause 5: The insulated bag of clause 4, wherein a first edge and a second edge of the sixth section are respectively attached to a third edge and a fourth edge of the seventh section.
Clause 6: The insulated bag of clause 5, wherein the third and fourth middle portions form a handle of the insulated bag.
Clause 7: The insulated bag of clause 1, wherein: the fourth section further comprises a fifth outer angular portion and a sixth outer angular portion, the fifth section further comprises a seventh outer angular portion and an eighth outer angular portion, and the second middle portion of the fifth section comprises a ninth outer angular portion, a tenth outer angular portion, and a middle angular portion.
Clause 8: The insulated bag of clause 7, wherein: a ninth crease line separates the fifth outer angular portion from the first inner angular portion, a tenth crease line separates the sixth outer angular portion from the second inner angular portion, an eleventh crease line separates the seventh outer angular portion from the third inner angular portion, a twelfth crease lines separates the eighth outer angular portion from the fourth inner angular portion, a thirteenth crease line separates the ninth outer angular portion from the middle angular portion, and a fourteenth crease line separates the middle angular portion from the tenth outer angular portion.
Clause 9: The insulated bag of clause 8, wherein the fourth section forms a handle of the insulated bag.
Clause 10: The insulated bag of clause 9, wherein the first middle portion of the fourth section forms the handle of the insulated bag.
Clause 11: The insulated bag of clause 1, wherein: the first section comprises a first outer portion, a third middle portion, and a second outer portion, the second section comprises a fifth outer angular portion, a sixth outer angular portion, a seventh outer angular portion, an eighth outer angular portion, a fifth inner angular portion, a sixth inner angular portion, a seventh inner angular portion, an eighth inner angular portion, a fourth middle portion, and a fifth middle portion, the third section comprises a third outer portion, a sixth middle portion, and a fourth outer portion, a ninth crease line horizontally separates the first section from the second section, a tenth crease line horizontally separates the second section from the third section, and an eleventh crease line horizontally separates (i) the fourth middle portion of the second section from the fifth middle portion of the second section, (ii) the fifth inner angular portion from the seventh inner angular portion, and (iii) the sixth inner angular portion from the eighth inner angular portion.
Clause 12: The insulated bag of clause 11, wherein: the third crease line further vertically separates (i) the first outer portion from the third middle portion, (ii) the fifth inner angular portion from the fourth middle portion, (iii) the seventh inner angular portion from the fifth middle portion, and (iv) the third outer portion from the sixth middle portion, and the fourth crease line further vertically separates (i) the third middle portion from the second outer portion, (ii) the fourth middle portion from the sixth inner angular portion, (iii) the fifth middle portion from the eighth inner angular portion, and (iv) the sixth middle portion from the fourth outer portion.
Clause 13: The insulated bag of clause 12, wherein: a twelfth crease line separates the fifth outer angular portion from the fifth inner angular portion at a fifth oblique angle, a thirteenth crease line separates the sixth outer angular portion from the sixth inner angular portion at a sixth oblique angle, a fourteenth crease line separates the seventh outer angular portion from the seventh inner angular portion at a seventh oblique angle, a fifteenth crease line separates the eighth outer angular portion from the eighth inner angular portion at an eighth oblique angle, first portions of a first edge and a second edge of the first section are respectively attached to first portions of a fifth edge and a sixth edge of the third section, second portions of the first edge and the second edge are respectively attached to first portions of a third edge and a fourth edge of the second section, and second portions of the fifth edge and the sixth edge are respectively attached to second portions of the third edge and fourth edge of the second section.
Clause 14: An insulated bag, comprising: an insulating substrate comprising: a first section; a second section; a third section; and a fourth section comprising a first outer portion, a second outer portion, a first outer angular portion, a second outer angular portion, a first inner angular portion, a second inner angular portion, and a first middle portion; and a fifth section comprising a third outer portion, a fourth outer portion, a third outer angular portion, a fourth outer angular portion, a third inner angular portion, a fourth inner angular portion, and a second middle portion, wherein: a first crease line horizontally separates the first section from the fourth section, a second crease line horizontally separates the third section from the fifth section, a third crease line vertically separates (i) the first inner angular portion from the first middle portion, and (ii) the third inner angular portion from the second middle portion, a fourth crease line vertically separates (i) the first middle portion from the second inner angular portion, and (ii) the second middle portion from the fourth inner angular portion, a fifth crease line separates the first outer angular portion from the first inner angular portion at a first oblique angle, a sixth crease line separates the second outer angular portion from the second inner angular portion at a second oblique angle, a seventh crease line separates the third inner angular portion from the third outer angular portion at a third oblique angle, and an eighth crease line separates the fourth inner angular portion from the fourth outer angular portion at a fourth oblique angle.
Clause 15: The insulated bag of clause 14, wherein: the third crease line further vertically separates (i) the first outer portion from the first middle portion, and (ii) the third outer portion from the second middle portion, the fourth crease line further vertically separates (i) the third outer portion from the second middle portion, and (ii) the fourth outer portion from the second middle portion, a ninth crease line horizontally separates a first portion of the fourth section from a second portion of the fourth section, and a tenth crease line horizontally separates a first portion of the fifth section from a second portion of the fifth section.
Clause 16: The insulated bag of clause 15, wherein: the first portion of the fourth section and the first portion of the fifth section form a handle of the insulated bag.
Clause 17: The insulated bag of clause 14, wherein: the second middle portion comprises a fifth outer angular portion, a sixth outer angular portion, and an angular middle portion.
Clause 18: The insulated bag of clause 17, wherein: a ninth crease line separates the fifth outer angular portion from the angular middle portion, and a tenth crease line separates the angular middle portion from the sixth outer angular portion.
Clause 19: An insulated pouch, comprising: an insulating substrate comprising: a first section; and a second section; a third section; and a fourth section, wherein: a first crease line horizontally separates the first section from the second section, a second crease line vertically separates the first and second sections from the third section, and a third crease line vertically separates the first and second sections from the fourth section.
Clause 20: An insulated pouch, comprising: an insulating substrate comprising: a first section; a second section; a third section; and a fourth section comprising a first outer portion, a second outer portion, and a first middle portion, wherein: a first crease line horizontally separates the first section from the fourth section, a second crease line vertically separates the first outer portion from the first middle portion, and a third crease line vertically separates the first middle portion from the second outer portion.
Clause 21: The insulated pouch of clause 20, wherein: a first edge and a second edge of the first section are respectively attached to a third edge and a fourth edge of the third section, and a fifth edge and a sixth edge of the fourth section are respectively attached to a seventh edge and an eighth edge of the third section.
Clause 22: The insulated bag of clause 1, wherein the second section comprises three portions each comprising: a fifth outer angular portion, a sixth outer angular portion, a seventh outer angular portion, an eighth outer angular portion, a fifth inner angular portion, a sixth inner angular portion, a seventh inner angular portion, an eighth inner angular portion, a fourth middle portion, and a fifth middle portion; and a ninth crease line that horizontally separates (i) the fourth middle portion from the fifth middle portion, (ii) the fifth inner angular portion from the seventh inner angular portion, and (iii) the sixth inner angular portion from the eighth inner angular portion, wherein: a tenth crease line horizontally separates the first section from the second section, an eleventh crease line horizontally separates the second section from the third section, a twelfth crease line horizontally separates a first portion of the three portions from a second portion of the three portions, and a thirteenth crease line horizontally separates the second portion from a third portion of the three portions.
Clause 23: The insulated bag of clause 22, wherein the three portions are of equivalent size.
Clause 24: An insulated bag, comprising: an insulating substrate comprising: a first section; a second section; a third section; a fourth section comprising a first middle portion, a first outer portion, and a second outer portion; and a fifth section comprising a second middle portion, a third outer portion, and a fourth outer portion, wherein: a first crease line horizontally separates the first section from the fourth section, a second crease line horizontally separates the fourth section from the second section, a third crease line horizontally separates the second section from the fifth section, a fourth crease line horizontally separates the fifth section from the third section, a fifth crease line vertically separates (i) the first middle portion from the first outer portion, and (ii) the second middle portion from the third outer portion, and a sixth crease line vertically separates (1) the first middle portion from the second outer portion, and (ii) the second middle portion from the fourth outer portion.
Clause 25: The insulated bag of clause 24, wherein: the first and third sections comprise a first height; the fourth and fifth sections comprise a second height; and the first height is larger than the second height.
Clause 26: The insulated bag of clause 24, further comprising: a sixth section; and a seventh section, wherein: a seventh crease line horizontally separates the first section from the sixth section, and an eighth crease line horizontally separates the third section from the seventh section.
Clause 27: An insulated bag, comprising: an insulating substrate comprising: a first section; a second section; a third section; a fourth section comprising a first outer angular portion, a second outer angular portion, a first inner angular portion, a second inner angular portion, and a first middle portion; and a fifth section comprising a third outer angular portion, a fourth outer angular portion, a third inner angular portion, a fourth inner angular portion, and a second middle portion, wherein: a first crease line horizontally separates the first section from the fourth section, a second crease line horizontally separates the third section from the fifth section, a third crease line separates the first inner angular portion from the first middle portion at a first oblique angle, a fourth crease line separates the second inner angular portion from the first middle portion at a second oblique angle, a fifth crease line separates the third inner angular portion from the second middle portion at a third oblique angle, and a sixth crease line separates the fourth inner angular portion from the second middle portion at a fourth oblique angle.
Clause 28: The insulated bag of clause 27, wherein: the first and second oblique angles comprise a first acute angle, and the third and fourth oblique angles comprise a first obtuse angle.
Clause 29: The insulated bag of clause 1, further comprising: a sixth section; wherein: a ninth crease line horizontally separates the fifth section from the sixth section, the third section comprises three portions, a tenth crease line horizontally separates the second section from a first portion of the three portions, an eleventh crease line horizontally separates the first portion from a second portion of the three portions, and a twelfth crease line horizontally separates the second portion from a third portion of the three portions.
Clause 30: The insulated bag of clause 29, wherein the first, second, and third portions of the three portions each comprise a different height.
Clause 31: The insulated bag of clause 1, further comprising: a sixth section, wherein: a ninth crease line horizontally separates the first section from the sixth section, the first outer angular portion, second outer angular portion, third outer angular portion, fourth outer angular portion, third inner angular portion, and fourth inner angular portion are of a first size, the first inner angular portion and the second inner angular portion are of a second size, the third inner angular portion and the fourth inner angular portion are of a third size, and the second size is greater than the third size.
Clause 32: The insulated bag of clause 1, further comprising: a sixth section comprising a first outer portion, a second outer portion, and a third middle portion, wherein: a ninth crease line horizontally separates the fifth section from the sixth section, the third crease line further vertically separates the first outer portion from the third middle portion, and the fourth crease line further vertically separates the second outer portion from the third middle portion.
Clause 33: The insulated bag of clause 1, further comprising: an insulation panel comprising a first layer, a core paper layer formed into a wave pattern and attached to the first layer.
Clause 34: The insulated bag of clause 33, further comprising a second layer, wherein: the core paper layer is disposed between the first and second layers; and the first and second layers are directly sealed to one another thereby concealing the core paper layer.
Clause 35: The insulated bag of clause 34, wherein: the first layer is of a first width; the second layer is of a second width; the first width is wider than the second width thereby resulting in the first layer having one or more extensions; and the one or more extensions of the first layer are directly sealed to the second layer thereby concealing the core paper layer.
Clause 36: The insulated bag of clause 1, wherein the insulating substrate does not comprise an external adhesive.
Clause 37: An apparatus, comprising: a transport assembly comprising a pick and place configured to transport one or more substrates to an indexing assembly, the pick and place comprises one or more a vacuum operated suction cups; and the indexing assembly comprising (i) a belt and (ii) one or more clips that are attached to the belt and configured to automatically open and close to receive and hold the one or more substrates, the belt is configured to transport the one or more clips with the one or more substrates to a plurality of assembly stations, wherein the plurality of assembly stations comprises: a press assembly station, of the plurality of assembly stations, comprising (i) a modular die press comprising a crease pattern and (ii) a heater configured to heat the die press, the press assembly station is configured to form a plurality of creases in the one or more substrates; a folding assembly station, of the plurality of assembly stations, configured to fold the one or more substrates at one or more locations along one or more creases of the plurality of crease; and a sealing assembly station, of the plurality of assembly stations, configured to seal one or more sides of the one or more substrates to form a bag.
Clause 38: The apparatus of clause 37, wherein the plurality of assembly stations further comprises: an exit assembly station, of the plurality of assembly stations, configured to position the bag for release, and wherein the indexing assembly further configured to open the one or more clips and release the bag at the exit assembly station.
Clause 39: The apparatus of clause 37, wherein the modular die press comprises quick change tooling configured to enable an operator or the apparatus to change the crease pattern.
Clause 40: The apparatus of clause 37, wherein the indexing assembly further comprises a sensor configured to detect the position of the one or more substrates is near the one or more clips and cause the one or more clips to open and receive the one or more substrates.
Clause 41: The apparatus of clause 37, wherein the one or more clips are configured to open when the pick and place moves toward or approaches the one or more clips.
Clause 42: The apparatus of clause 37, wherein the indexing assembly further comprises at least two alignment rails configured to align the one or more substrates within the one or more clips, the at least two alignment rails comprising a first alignment rail configured to move vertically such that the one or more substates can be transported over the first alignment rail from an initial position to the press assembly station.
Clause 43: The apparatus of clause 37, wherein the transport assembly comprises a sensor configured to detect the presence of the one or more substrates and upon detection causes the pick and place to attach, via vacuum, to the one or more substrates and transport the one or more substrates to the indexing assembly.
Clause 44: The apparatus of clause 37, wherein the one or more substrates comprise paper.
Clause 45: The apparatus of clause 44, wherein the paper comprises a polymer coating without an external adhesive.
Clause 46: The apparatus of clause 45, wherein the sealing assembly station comprises two longitudinal heated presses configured to seal at least two edges of the one or more substrates in a folded state by heating and pressing the polymer coating of the one or more substrates.
Clause 47: The apparatus of clause 46, wherein the sealing assembly station if configured to heat and harden one or more additional portions of the one or more substrates in a folded state.
Clause 48: An apparatus, comprising: a transport assembly comprising a transport mechanism configured to transport one or more substrates to an indexing assembly; the indexing assembly configured to transport the one or more substrates to a plurality of assembly stations; the plurality of assembly stations comprises: a press assembly station, of the plurality of assembly stations, comprising (i) a modular die press comprising a crease pattern and (ii) a heater configured to heat the die press, the press assembly station is configured to form a plurality of creases in the one or more substrates; a folding assembly station, of the plurality of assembly stations, configured to fold the one or more substrates at one or more locations along one or more creases; and a sealing assembly station, of the plurality of assembly stations, configured to seal at least one side of the one or more substrates to form a bag.
Clause 49: The apparatus of clause 48, wherein the transport mechanism comprises a pick and place configured to transport the one or more substrates to the indexing assembly, the pick and place comprises one or more vacuum operated suction cups.
Clause 50: The apparatus of clause 49, wherein the pick and place comprises two or more vacuum operations suction cups.
Clause 51: The apparatus of clause 48, wherein the indexing assembly comprises (i) a belt and (ii) one or more clips that are attached to the belt, and wherein the one or more clips are configured to automatically open and close to receive and hold the one or more substrates, and wherein the belt is configured to transport the one or more clips with the one or more substrates to the plurality of assembly stations.
Clause 52: The apparatus of clause 48, further comprising: a second transporting mechanism configured to transport the bag away from the sealing assembly station, and wherein the indexing assembly further configured to open and release the bag.
Clause 53: The apparatus of clause 48, wherein the modular die press comprises quick change tooling configured to enable an operator or the apparatus to change the crease pattern.

The apparatus of clause 51, wherein the indexing assembly further comprises a sensor configured to detect the position of the one or more substrates is near the one or more clips and cause the one or more clips to open and receive the one or more substrates.
Clause 55: The apparatus of clause 51, wherein the one or more clips are configured to open when a pick and place moves toward or approaches the one or more clips.
Clause 56: The apparatus of clause 51, wherein the indexing assembly further comprises at least two alignment rails configured to align the one or more substrates within the one or more clips, the at least two alignment rails comprising a first alignment rail configured to move vertically such that the one or more substates can be transported over the first alignment rail from an initial position to the press assembly station.
Clause 57: The apparatus of clause 48, wherein the transport assembly comprises a sensor configured to detect the presence of the one or more substrates and upon detection causes a pick and place to attach, via vacuum, to the one or more substrates and transport the one or more substrates to the indexing assembly.
Clause 58: An apparatus, comprising: a transport assembly comprising a transport mechanism configured to transport one or more substrates to an indexing assembly; the indexing assembly configured to transport the one or more substrates to a plurality of assembly stations; the plurality of assembly stations comprises: a press assembly station, of the plurality of assembly stations, comprising modular die press comprising a crease pattern the press assembly station is configured to form a plurality of creases in the one or more substrates; a folding assembly station, of the plurality of assembly stations, configured to fold the one or more substrates at one or more locations along one or more creases; and a sealing assembly station, of the plurality of assembly stations, configured to seal at least one side of the one or more substrates to form a bag.
Clause 59: The apparatus of clause 58, wherein the transport mechanism comprises a pick and place configured to transport the one or more substrates to the indexing assembly, the pick and place comprises one or more vacuum operated suction cups.
Clause 60: The apparatus of clause 58, wherein the indexing assembly comprises (i) a belt and (ii) one or more clips that are attached to the belt, and wherein the one or more clips are configured to automatically open and close to receive and hold the one or more substrates, and wherein the belt is configured to transport the one or more clips with the one or more substrates to the plurality of assembly stations.
Clause 61: The apparatus of clause 60, further comprising: a second transporting mechanism configured to transport the bag away from the one or more clips, and wherein the indexing assembly further configured to open the one or more clips and release the bag.
Clause 62: The apparatus of clause 58, wherein the press assembly station further comprises a heater configured to heat the modular die press, which thereby heats the one or more substrates along the crease pattern.
Clause 63: The apparatus of clause 60, wherein the indexing assembly further comprises a sensor configured to detect the position of the one or more substrates is near the one or more clips and cause the one or more clips to open and receive the one or more substrates.
Clause 64: The apparatus of clause 60, wherein the one or more clips are configured to open when a pick and place moves toward or approaches the one or more clips.
Clause 65: A method of forming a bag, comprising: receiving one or more substrates; transporting, via one or more pick and place actuators, the one or more substrates to an indexing assembly; securing the one or more substrates in one or more clips of the indexing assembly; transporting the one or more substrates to a press assembly station using the one or more clips attached to a movable belt; creasing the one or more substrates according to a creasing pattern to form one or more creases in the one or more substrates at the press assembly station; transporting the one or more substrates from the press assembly station to a folding assembly station using the one or more clips attached to the movable belt; folding the one or more substrates along at least one crease from the one or more creases such that the one or more substrates are placed in a folded configuration at the folding assembly station; and transporting the one or more substrates to from the folding assembly station to a sealing assembly station using the one or more clips attached to the movable belt; and sealing edges of the one or more substrates in the folded configuration to form a bag at the sealing assembly station.
Clause 66: The method of clause 65, further comprising: changing the creasing pattern using quick change tooling.
Clause 67: The method of clause 65, further comprising: detecting the position of the one or more substrates is near the one or more clips; and responsive to detecting the position of the one or more substrates is near the one or more clips, opening the one or more clips to receive the one or more substrates.
Clause 68: The method of clause 65, further comprising: detecting the position that the one or more pick and place actuators move toward or approach the one or more clips; and responsive to detecting that the one or more pick and place actuators move toward or approach the one or more clips, opening the one or more clips to receive the one or more substrates.
Clause 69: The method of clause 65, further comprising aligning the one or more substrates in the one or more clips using at least one alignment rail.
Clause 70: The method of clause 69, wherein transporting the one or more substrates to the press assembly station further comprising moving the at least one alignment rail away from a transportation path.
Clause 71: The method of clause 65, further comprising forming the bag without applying an external adhesive to the one or more substrates.
Clause 72: A method of forming a bag, comprising: receiving one or more substrates; transporting the one or more substrates to an indexing assembly; securing the one or more substrates; transporting the one or more substrates to a press assembly station; creasing the one or more substrates according to a creasing pattern to form one or more creases in the one or more substrates at the press assembly station; transporting the one or more substrates to from the press assembly station to a folding assembly station; folding the one or more substrates along the one or more creases such that the one or more substrates are placed in a folded configuration at the folding assembly station; and transporting the one or more substrates to from the folding assembly station to a sealing assembly station; and sealing edges of the one or more substrates in the folded configuration to form a bag at the sealing assembly station.
Clause 73: The method of clause 72, further comprising: securing the one or more substrates in one or more clips of the indexing assembly; detecting the position of the one or more substrates is near the one or more clips; and responsive to detecting the position of the one or more substrates is near the one or more clips, opening the one or more clips to receive the one or more substrates.
Clause 74: A method of forming a bag, comprising: receiving one or more substrates; securing the one or more substrates; transporting the one or more substrates to a first station, a second station, and a third station; creasing the one or more substrate according to a creasing pattern to form one or more creases in the one or more substrates at the first station; folding the one or more substrates along the one or more creases such that the one or more substrates are placed in a folded configuration at the second station; and sealing edges of the one or more substrates in the folded configuration to form a bag at the third station.
Clause 75: The method of clause 74, further comprising forming the bag without applying an external adhesive to the one or more substrates.
Clause 76: The insulating bag of clause 1, wherein the insulating substrate further comprises one or more metalized layers.
Clause 77: The insulating bag of clause 14, wherein the insulating substrate further comprises one or more metalized layers.
Clause 78: The insulating pouch of clause 19, wherein the insulating substrate further comprises one or more metalized layers.
Clause 79: The insulating pouch of clause 20, wherein the insulating substrate further comprises one or more metalized layers.
Clause 80: The insulating bag of clause 24, wherein the insulating substrate further comprises one or more metalized layers.
Clause 81: The insulating bag of clause 27, wherein the insulating substrate further comprises one or more metalized layers.
Clause 82: An insulated pouch, comprising: an insulating substrate comprising: a first section comprising a first outer angular portion, a second outer angular portion, a first inner angular portion, and a second inner angular portion; a second section comprising a third outer angular portion, a fourth outer angular portion, a fifth outer angular portion, a sixth outer angular portion, a third inner angular portion, a fourth inner angular portion, a fifth inner angular portion, and a sixth inner angular portion; a third section comprising a seventh outer angular portion, an eighth outer angular portion, a seventh inner angular portion, and an eighth inner angular portion; a fourth section; and a plurality of crease lines respectively separating each portion of the first, second, third, and fourth sections, wherein: the plurality of crease lines are configured such that each portion of the first, second, third, and fourth sections comprises a sealed pocket.
Clause 83: The insulated pouch of clause 8, wherein the plurality of crease lines comprise: a first crease line horizontally separating the first section from the second section, a second crease line horizontally separating the second section from the third section, one or more third crease lines horizontally separating the first section from the fourth section, a fourth crease line vertically separating the first and second sections from the third section, a fifth crease line separating the first outer angular portion and the first inner angular portion at a first oblique angle, a sixth crease line separating the second inner angular portion and the second outer angular portion, a seventh crease line separating the third outer angular portion and the third inner angular portion, an eighth crease line separating the fourth outer angular portion and the fourth inner angular portion, a ninth crease line separating the fifth outer angular portion and the fifth inner angular portion, a tenth crease line separating the sixth outer angular portion and the sixth inner angular portion, an eleventh crease line separating the seventh outer angular portion and the seventh inner angular portion, and a twelfth crease line separating the eighth outer angular portion and the eighth inner angular portion.
Clause 84: The insulated pouch of clause 8, wherein: the first section comprises eleven sealed pockets, the second section comprises ten sealed pockets, the third section comprises eleven sealed pockets, and the fourth section comprises three sealed pockets.
Clause 85: The insulated pouch of clause 8, wherein the plurality of crease lines comprise a set of double crease lines horizontally separating the first section from the fourth section.
Clause 86: The insulated pouch of clause 8, wherein: the insulated pouch is configured to transition between an open position and a closed position, and wherein the fourth section is configured such that when the insulated pouch transitions from the open position to the closed position, the fourth section folds over and attaches to at least a portion of the third section.

The various insulation products described herein may be recyclable or curbside recyclable in many communities.

The design and functionality described in this application is intended to be exemplary in nature and is not intended to limit the instant disclosure in any way. Those having ordinary skill in the art will appreciate that the teachings of the disclosure may be implemented in a variety of suitable forms, including those forms disclosed herein and additional forms known to those having ordinary skill in the art. This disclosure is intended to cover various modifications and equivalent arrangements included within the scope of the appended claims. Although specific terms are employed herein, they are used in a generic and descriptive sense only and not for purposes of limitation.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

Dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical range and sub-range is explicitly recited. For example, a range of approximately 1 to 99.99 should be interpreted to include not only the explicitly recited limits of approximately 1 and approximately 99.99, but also individual amounts such as 2, 3, 4, 5.01, 5.02, 26, 67.1, 99.98, etc., and sub ranges such as 5 to 80 and 30.21 to 83.24, etc. Similarly, it should be understood that when numerical ranges are provided, such ranges are to be construed as providing literal support for claim limitations that only recite the lower value of the range as well as claim limitations that only recite the upper value of the range. For example, a disclosed numerical range of 5 to 15 provides literal support for a claim reciting “greater than 5” (with no upper bounds) and a claim reciting “less than 15” (with no lower bounds).

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An insulated bag, comprising:
an insulating substrate comprising:
a first section;
a second section;
a third section;
a fourth section comprising a first outer angular portion, a second outer angular portion, a first inner angular portion, a second inner angular portion, and a first middle portion; and
a fifth section comprising a third outer angular portion, a fourth outer angular portion, a third inner angular portion, a fourth inner angular portion, and a second middle portion,
wherein:
a first crease line horizontally separates the first section from the fourth section,
a second crease line horizontally separates the third section from the fifth section,
a third crease line vertically separates (i) the first inner angular portion from the first middle portion, and (ii) the third inner angular portion from the second middle portion,
a fourth crease line vertically separates (i) the first middle portion from the second inner angular portion, and (ii) the second middle portion from the fourth inner angular portion,
a fifth crease line separates the first outer angular portion from the first inner angular portion at a first oblique angle,
a sixth crease line separates the second outer angular portion from the second inner angular portion at a second oblique angle,
a seventh crease line separates the third inner angular portion from the third outer angular portion at a third oblique angle, and
an eighth crease line separates the fourth inner angular portion from the fourth outer angular portion at a fourth oblique angle.

2. The insulated bag of claim 1, wherein a first edge and a second edge of the fourth section are respectively attached to a third edge and a fourth edge of the fifth section.

3. The insulated bag of claim 1, further comprising:
a sixth section comprising a first outer portion, a second outer portion, and a third middle portion; and
a seventh section comprising a third outer portion, a fourth outer portion, and a fourth middle portion.

4. The insulated bag of claim 3, wherein:
the third crease line further vertically separates (i) the first outer portion from the third middle portion, and (ii) the third outer portion from the fourth middle portion, and
the fourth crease line further vertically separates (i) the third middle portion from the second outer portion, and (ii) the fourth middle portion from the fourth outer portion.

5. The insulated bag of claim 4, wherein the third and fourth middle portions form a handle of the insulated bag.

6. The insulated bag of claim 1, wherein:
the fourth section further comprises a fifth outer angular portion and a sixth outer angular portion,
the fifth section further comprises a seventh outer angular portion and an eighth outer angular portion, and
the second middle portion of the fifth section comprises a ninth outer angular portion, a tenth outer angular portion, and a middle angular portion.

7. The insulated bag of claim 6, wherein:
a ninth crease line separates the fifth outer angular portion from the first inner angular portion,
a tenth crease line separates the sixth outer angular portion from the second inner angular portion,
an eleventh crease line separates the seventh outer angular portion from the third inner angular portion,
a twelfth crease lines separates the eighth outer angular portion from the fourth inner angular portion,
a thirteenth crease line separates the ninth outer angular portion from the middle angular portion, and
a fourteenth crease line separates the middle angular portion from the tenth outer angular portion.

8. An insulated pouch, comprising:
an insulating substrate comprising:
a first section comprising a first outer angular portion, a second outer angular portion, a first inner angular portion, and a second inner angular portion;
a second section comprising a third outer angular portion, a fourth outer angular portion, a fifth outer angular portion, a sixth outer angular portion, a third inner angular portion, a fourth inner angular portion, a fifth inner angular portion, and a sixth inner angular portion;
a third section comprising a seventh outer angular portion, an eighth outer angular portion, a seventh inner angular portion, and an eighth inner angular portion;
a fourth section; and
a plurality of crease lines respectively separating each portion of the first, second, third, and fourth sections,
wherein:
the plurality of crease lines are configured such that each portion of the first, second, third, and fourth sections comprises a sealed pocket.

9. The insulated pouch of claim 8, wherein the plurality of crease lines comprise:
a first crease line horizontally separating the first section from the second section,
a second crease line horizontally separating the second section from the third section,
one or more third crease lines horizontally separating the first section from the fourth section,
a fourth crease line vertically separating the first and second sections from the third section, a fifth crease line separating the first outer angular portion and the first inner angular portion at a first oblique angle,
a sixth crease line separating the second inner angular portion and the second outer angular portion,
a seventh crease line separating the third outer angular portion and the third inner angular portion,
an eighth crease line separating the fourth outer angular portion and the fourth inner angular portion,
a ninth crease line separating the fifth outer angular portion and the fifth inner angular portion,
a tenth crease line separating the sixth outer angular portion and the sixth inner angular portion,
an eleventh crease line separating the seventh outer angular portion and the seventh inner angular portion, and
a twelfth crease line separating the eighth outer angular portion and the eighth inner angular portion.

10. The insulated pouch of claim 8, wherein:
the first section comprises eleven sealed pockets,
the second section comprises ten sealed pockets,
the third section comprises eleven sealed pockets, and
the fourth section comprises three sealed pockets.

11. The insulated pouch of claim 8, wherein the plurality of crease lines comprise a set of double crease lines horizontally separating the first section from the fourth section.

12. The insulated pouch of claim 8, wherein:
the insulated pouch is configured to transition between an open position and a closed position, and
wherein the fourth section is configured such that when the insulated pouch transitions from the open position to the closed position, the fourth section folds over and attaches to at least a portion of the third section.

13. The insulated bag of claim 1, wherein the second section comprises three portions each comprising:
a fifth outer angular portion, a sixth outer angular portion, a seventh outer angular portion, an eighth outer angular portion, a fifth inner angular portion, a sixth inner angular portion, a seventh inner angular portion, an eighth inner angular portion, a fourth middle portion, and a fifth middle portion; and
a ninth crease line that horizontally separates (i) the fourth middle portion from the fifth middle portion, (ii) the fifth inner angular portion from the seventh inner angular portion, and (iii) the sixth inner angular portion from the eighth inner angular portion,
wherein:
a tenth crease line horizontally separates the first section from the second section,
an eleventh crease line horizontally separates the second section from the third section,
a twelfth crease line horizontally separates a first portion of the three portions from a second portion of the three portions, and
a thirteenth crease line horizontally separates the second portion from a third portion of the three portions.

14. An insulated bag, comprising:
an insulating substrate comprising:
a first section;
a second section;
a third section;
a fourth section comprising a first middle portion, a first outer portion, and a second outer portion; and
a fifth section comprising a second middle portion, a third outer portion, and a fourth outer portion,
wherein:
a first crease line horizontally separates the first section from the fourth section,
a second crease line horizontally separates the fourth section from the second section,
a third crease line horizontally separates the second section from the fifth section,
a fourth crease line horizontally separates the fifth section from the third section,
a fifth crease line vertically separates (i) the first middle portion from the first outer portion, and (ii) the second middle portion from the third outer portion, and
a sixth crease line vertically separates (1) the first middle portion from the second outer portion, and (ii) the second middle portion from the fourth outer portion.

15. An insulated bag, comprising:
an insulating substrate comprising:
a first section;
a second section;
a third section;
a fourth section comprising a first outer angular portion, a second outer angular portion, a first inner angular portion, a second inner angular portion, and a first middle portion; and
a fifth section comprising a third outer angular portion, a fourth outer angular portion, a third inner angular portion, a fourth inner angular portion, and a second middle portion,
wherein:
a first crease line horizontally separates the first section from the fourth section,
a second crease line horizontally separates the third section from the fifth section,
a third crease line separates the first inner angular portion from the first middle portion at a first oblique angle,
a fourth crease line separates the second inner angular portion from the first middle portion at a second oblique angle,
a fifth crease line separates the third inner angular portion from the second middle portion at a third oblique angle, and
a sixth crease line separates the fourth inner angular portion from the second middle portion at a fourth oblique angle.

16. The insulated bag of claim 15, wherein:
the first and second oblique angles comprise a first acute angle, and
the third and fourth oblique angles comprise a first obtuse angle.

17. The insulated bag of claim 1, further comprising:
a sixth section;
wherein:
a ninth crease line horizontally separates the fifth section from the sixth section,
the third section comprises three portions,
a tenth crease line horizontally separates the second section from a first portion of the three portions,
an eleventh crease line horizontally separates the first portion from a second portion of the three portions, and
a twelfth crease line horizontally separates the second portion from a third portion of the three portions.

18. The insulated bag of claim 1, further comprising:
a sixth section,
wherein:
a ninth crease line horizontally separates the first section from the sixth section,
the first outer angular portion, second outer angular portion, third outer angular portion, fourth outer angular portion, third inner angular portion, and fourth inner angular portion are of a first size,
the first inner angular portion and the second inner angular portion are of a second size,
the third inner angular portion and the fourth inner angular portion are of a third size, and
the second size is greater than the third size.

19. The insulated bag of claim 1, further comprising:
a sixth section comprising a first outer portion, a second outer portion, and a third middle portion,
wherein:
a ninth crease line horizontally separates the fifth section from the sixth section,
the third crease line further vertically separates the first outer portion from the third middle portion, and
the fourth crease line further vertically separates the second outer portion from the third middle portion.

20. The insulating bag of claim 1, wherein the insulating substrate further comprises one or more metalized layers.
